(19) United States
(12) Patent Application Publication
(10) Pub. No.: US 2026/0064236 A1
(43) Pub. Date: Mar. 5, 2026

(54) USER INTERFACES AND TECHNIQUES FOR MANAGING CONTENT

(71) Applicant: Apple Inc., Cupertino, CA (US)

(72) Inventor: Agatha Y. YU, Oakland, CA (US)

(21) Appl. No.: 19/382,107

(22) Filed: Nov. 6, 2025

Related U.S. Application Data
(63) Continuation of application No. PCT/US2024/048474, filed on Sep. 25, 2024.
(60) Provisional application No. 63/541,831, filed on Sep. 30, 2023.
(60) Provisional application No. 63/541,838, filed on Sep. 30, 2023.

(51) Int. Cl. G06F 3/0481; G06F 3/16; G06T 11/00

(52) U.S. Cl. CPC G06F 3/0481; G06F 3/167; G06T 11/00

(57) ABSTRACT

The present disclosure generally relates to managing content.

### CROSS-REFERENCE TO RELATED APPLICATIONS

This application is a continuation application of International Patent Application Serial No. PCT/US2024/048474, entitled “USER INTERFACES AND TECHNIQUES FOR MANAGING CONTENT,” filed Sep. 25, 2024, which claims priority to U.S. Provisional Patent Application Ser. No. 63/541,831, filed Sep. 30, 2023, and to U.S. Provisional Patent Application Ser. No. 63/541,838, filed Sep. 30, 2023. The content of these applications are hereby incorporated by reference in their entirety.

### BACKGROUND

Users often use computer systems to manage content. Such content includes digital art, photography, and videos. Electronic devices also often output navigation content. Such navigation content can include one or more suggested routes to a destination.

### SUMMARY

Existing techniques for managing content using electronic devices are generally cumbersome and inefficient. For example, some existing techniques use a complex and time-consuming user interface, which may include multiple key presses or keystrokes. Some existing techniques require more time than necessary, wasting user time and device energy. This latter consideration is particularly important in battery-operated devices.

Accordingly, the present technique provides electronic devices with faster, more efficient methods and interfaces for managing content. Such methods and interfaces optionally complement or replace other methods for managing content. Such methods and interfaces reduce the cognitive burden on a user and produce a more efficient human-machine interface. For battery-operated computing devices, such methods and interfaces conserve power and increase the time between battery charges. Such methods and interfaces may complement or replace other methods for managing content.

In some embodiments, a method that is performed at a computer system that is in communication with one or more input devices, a movement component, and one or more cameras is described. In some embodiments, the method comprises: while capturing one or more images via the one or more cameras, detecting, via the one or more input devices, a request corresponding to content in the field-of-view of the one or more cameras; and in response to detecting the request corresponding to the content in the field-of-view of the one or more cameras: in accordance with a determination that a portion of the content is outside of the field-of-view of the one or more cameras and that the content has a first set of one or more characteristics, moving, via the movement component, a first amount to capture one or more portions of the content that was previously not captured in the one or more images; and in accordance with a determination that the portion of the content is outside of the field-of-view of the one or more cameras and that the content has a second set of one or more characteristics, different from the first set of one or more characteristics, moving, via the movement component, a second amount, different from the first amount, to capture the one or more portions of the content that was previously not captured in the one or more images.

In some embodiments, a non-transitory computer-readable storage medium storing one or more programs configured to be executed by one or more processors of a computer system that is in communication with one or more input devices, a movement component, and one or more cameras is described. In some embodiments, the one or more programs includes instructions for: while capturing one or more images via the one or more cameras, detecting, via the one or more input devices, a request corresponding to content in the field-of-view of the one or more cameras; and in response to detecting the request corresponding to the content in the field-of-view of the one or more cameras: in accordance with a determination that a portion of the content is outside of the field-of-view of the one or more cameras and that the content has a first set of one or more characteristics, moving, via the movement component, a first amount to capture one or more portions of the content that was previously not captured in the one or more images; and in accordance with a determination that the portion of the content is outside of the field-of-view of the one or more cameras and that the content has a second set of one or more characteristics, different from the first set of one or more characteristics, moving, via the movement component, a second amount, different from the first amount, to capture the one or more portions of the content that was previously not captured in the one or more images.

In some embodiments, a transitory computer-readable storage medium storing one or more programs configured to be executed by one or more processors of a computer system that is in communication with one or more input devices, a movement component, and one or more cameras is described. In some embodiments, the one or more programs includes instructions for: while capturing one or more images via the one or more cameras, detecting, via the one or more input devices, a request corresponding to content in the field-of-view of the one or more cameras; and in response to detecting the request corresponding to the content in the field-of-view of the one or more cameras: in accordance with a determination that a portion of the content is outside of the field-of-view of the one or more cameras and that the content has a first set of one or more characteristics, moving, via the movement component, a first amount to capture one or more portions of the content that was previously not captured in the one or more images; and in accordance with a determination that the portion of the content is outside of the field-of-view of the one or more cameras and that the content has a second set of one or more characteristics, different from the first set of one or more characteristics, moving, via the movement component, a second amount, different from the first amount, to capture the one or more portions of the content that was previously not captured in the one or more images.

In some embodiments, a computer system that is in communication with one or more input devices, a movement component, and one or more cameras is described. In some embodiments, the computer system comprises one or more processors and memory storing one or more programs configured to be executed by the one or more processors. In some embodiments, the one or more programs includes instructions for: while capturing one or more images via the one or more cameras, detecting, via the one or more input devices, a request corresponding to content in the field-of-view of the one or more cameras; and in response to detecting the request corresponding to the content in the field-of-view of the one or more cameras: in accordance with a determination that a portion of the content is outside of the field-of-view of the one or more cameras and that the content has a first set of one or more characteristics, moving, via the movement component, a first amount to capture one or more portions of the content that was previously not captured in the one or more images; and in accordance with a determination that the portion of the content is outside of the field-of-view of the one or more cameras and that the content has a second set of one or more characteristics, different from the first set of one or more characteristics, moving, via the movement component, a second amount, different from the first amount, to capture the one or more portions of the content that was previously not captured in the one or more images.

In some embodiments, a computer system that is in communication with one or more input devices, a movement component, and one or more cameras is described. In some embodiments, the computer system comprises means for performing each of the following steps: while capturing one or more images via the one or more cameras, detecting, via the one or more input devices, a request corresponding to content in the field-of-view of the one or more cameras; and in response to detecting the request corresponding to the content in the field-of-view of the one or more cameras: in accordance with a determination that a portion of the content is outside of the field-of-view of the one or more cameras and that the content has a first set of one or more characteristics, moving, via the movement component, a first amount to capture one or more portions of the content that was previously not captured in the one or more images; and in accordance with a determination that the portion of the content is outside of the field-of-view of the one or more cameras and that the content has a second set of one or more characteristics, different from the first set of one or more characteristics, moving, via the movement component, a second amount, different from the first amount, to capture the one or more portions of the content that was previously not captured in the one or more images.

In some embodiments, a computer program product is described. In some embodiments, the computer program product comprises one or more programs configured to be executed by one or more processors of a computer system that is in communication with one or more input devices, a movement component, and one or more cameras. In some embodiments, the one or more programs include instructions for: while capturing one or more images via the one or more cameras, detecting, via the one or more input devices, a request corresponding to content in the field-of-view of the one or more cameras; and in response to detecting the request corresponding to the content in the field-of-view of the one or more cameras: in accordance with a determination that a portion of the content is outside of the field-of-view of the one or more cameras and that the content has a first set of one or more characteristics, moving, via the movement component, a first amount to capture one or more portions of the content that was previously not captured in the one or more images; and in accordance with a determination that the portion of the content is outside of the field-of-view of the one or more cameras and that the content has a second set of one or more characteristics, different from the first set of one or more characteristics, moving, via the movement component, a second amount, different from the first amount, to capture the one or more portions of the content that was previously not captured in the one or more images.

In some embodiments, a method that is performed at a computer system that is in communication with one or more output devices, a display component, and one or more cameras is described. In some embodiments, the method comprises: while outputting a representation of a field-of-view of one or more cameras, detecting a request concerning content in the field-of-view of the one or more cameras; and in response to detecting the request concerning content in the field-of-view of the one or more cameras: in accordance with a determination that a first portion of content is a portion of interest based on the context of the request outputting an indication that the first portion of content is the portion of interest; and in accordance with a determination that a second portion of content is the portion of interest based on the context of the request, outputting an indication that the second portion of content is the portion of interest.

In some embodiments, a non-transitory computer-readable storage medium storing one or more programs configured to be executed by one or more processors of a computer system that is in communication with one or more output devices, a display component, and one or more cameras is described. In some embodiments, the one or more programs includes instructions for: while outputting a representation of a field-of-view of one or more cameras, detecting a request concerning content in the field-of-view of the one or more cameras; and in response to detecting the request concerning content in the field-of-view of the one or more cameras: in accordance with a determination that a first portion of content is a portion of interest based on the context of the request outputting an indication that the first portion of content is the portion of interest; and in accordance with a determination that a second portion of content is the portion of interest based on the context of the request, outputting an indication that the second portion of content is the portion of interest.

In some embodiments, a transitory computer-readable storage medium storing one or more programs configured to be executed by one or more processors of a computer system that is in communication with one or more output devices, a display component, and one or more cameras is described. In some embodiments, the one or more programs includes instructions for: while outputting a representation of a field-of-view of one or more cameras, detecting a request concerning content in the field-of-view of the one or more cameras; and in response to detecting the request concerning content in the field-of-view of the one or more cameras: in accordance with a determination that a first portion of content is a portion of interest based on the context of the request outputting an indication that the first portion of content is the portion of interest; and in accordance with a determination that a second portion of content is the portion of interest based on the context of the request, outputting an indication that the second portion of content is the portion of interest.

In some embodiments, a computer system that is in communication with one or more output devices, a display component, and one or more cameras is described. In some embodiments, the computer system comprises one or more processors and memory storing one or more programs configured to be executed by the one or more processors. In some embodiments, the one or more programs includes instructions for: while outputting a representation of a field-of-view of one or more cameras, detecting a request concerning content in the field-of-view of the one or more cameras; and in response to detecting the request concerning content in the field-of-view of the one or more cameras: in accordance with a determination that a first portion of content is a portion of interest based on the context of the request outputting an indication that the first portion of content is the portion of interest; and in accordance with a determination that a second portion of content is the portion of interest based on the context of the request, outputting an indication that the second portion of content is the portion of interest.

In some embodiments, a computer system that is in communication with one or more output devices, a display component, and one or more cameras is described. In some embodiments, the computer system comprises means for performing each of the following steps: while outputting a representation of a field-of-view of one or more cameras, detecting a request concerning content in the field-of-view of the one or more cameras; and in response to detecting the request concerning content in the field-of-view of the one or more cameras: in accordance with a determination that a first portion of content is a portion of interest based on the context of the request outputting an indication that the first portion of content is the portion of interest; and in accordance with a determination that a second portion of content is the portion of interest based on the context of the request, outputting an indication that the second portion of content is the portion of interest.

In some embodiments, a computer program product is described. In some embodiments, the computer program product comprises one or more programs configured to be executed by one or more processors of a computer system that is in communication with one or more output devices, a display component, and one or more cameras. In some embodiments, the one or more programs include instructions for: while outputting a representation of a field-of-view of one or more cameras, detecting a request concerning content in the field-of-view of the one or more cameras; and in response to detecting the request concerning content in the field-of-view of the one or more cameras: in accordance with a determination that a first portion of content is a portion of interest based on the context of the request outputting an indication that the first portion of content is the portion of interest; and in accordance with a determination that a second portion of content is the portion of interest based on the context of the request, outputting an indication that the second portion of content is the portion of interest.

In some embodiments, a method that is performed at a computer system that is in communication with one or more output devices including a display component, and one or more cameras is described. In some embodiments, the method comprises: while displaying, via the display component, a representation of a field-of-view of one or more cameras, detecting a request corresponding to content in the field-of-view of the one or more cameras; in response to detecting the request corresponding to the content in the field-of-view of the one or more cameras, displaying, via the display component, a user interface object closer to a first portion of the content than a second portion of the content; while displaying the user interface object closer to the first portion of the content than the second portion of the content, detecting an air gesture that corresponds to an input directed to the second portion of the content; and in response to detecting the air gesture that corresponds to the input directed to the second portion of the content: displaying, via the display component, the user interface object closer to the second portion of the content than the first portion of the content; and outputting, via the one or more output devices, a first set of one or more indications that the second portion of the content is currently a portion of interest.

In some embodiments, a non-transitory computer-readable storage medium storing one or more programs configured to be executed by one or more processors of a computer system that is in communication with one or more output devices including a display component, and one or more cameras is described. In some embodiments, the one or more programs includes instructions for: while displaying, via the display component, a representation of a field-of-view of one or more cameras, detecting a request corresponding to content in the field-of-view of the one or more cameras; in response to detecting the request corresponding to the content in the field-of-view of the one or more cameras, displaying, via the display component, a user interface object closer to a first portion of the content than a second portion of the content; while displaying the user interface object closer to the first portion of the content than the second portion of the content, detecting an air gesture that corresponds to an input directed to the second portion of the content; and in response to detecting the air gesture that corresponds to the input directed to the second portion of the content: displaying, via the display component, the user interface object closer to the second portion of the content than the first portion of the content; and outputting, via the one or more output devices, a first set of one or more indications that the second portion of the content is currently a portion of interest.

In some embodiments, a transitory computer-readable storage medium storing one or more programs configured to be executed by one or more processors of a computer system that is in communication with one or more output devices including a display component, and one or more cameras is described. In some embodiments, the one or more programs includes instructions for: while displaying, via the display component, a representation of a field-of-view of one or more cameras, detecting a request corresponding to content in the field-of-view of the one or more cameras; in response to detecting the request corresponding to the content in the field-of-view of the one or more cameras, displaying, via the display component, a user interface object closer to a first portion of the content than a second portion of the content; while displaying the user interface object closer to the first portion of the content than the second portion of the content, detecting an air gesture that corresponds to an input directed to the second portion of the content; and in response to detecting the air gesture that corresponds to the input directed to the second portion of the content: displaying, via the display component, the user interface object closer to the second portion of the content than the first portion of the content; and outputting, via the one or more output devices, a first set of one or more indications that the second portion of the content is currently a portion of interest.

In some embodiments, a computer system that is in communication with one or more output devices including a display component, and one or more cameras is described. In some embodiments, the computer system comprises one or more processors and memory storing one or more programs configured to be executed by the one or more processors. In some embodiments, the one or more programs includes instructions for: while displaying, via the display component, a representation of a field-of-view of one or more cameras, detecting a request corresponding to content in the field-of-view of the one or more cameras; in response to detecting the request corresponding to the content in the field-of-view of the one or more cameras, displaying, via the display component, a user interface object closer to a first portion of the content than a second portion of the content; while displaying the user interface object closer to the first portion of the content than the second portion of the content, detecting an air gesture that corresponds to an input directed to the second portion of the content; and in response to detecting the air gesture that corresponds to the input directed to the second portion of the content: displaying, via the display component, the user interface object closer to the second portion of the content than the first portion of the content; and outputting, via the one or more output devices, a first set of one or more indications that the second portion of the content is currently a portion of interest.

In some embodiments, a computer system that is in communication with one or more output devices including a display component, and one or more cameras is described. In some embodiments, the computer system comprises means for performing each of the following steps: while displaying, via the display component, a representation of a field-of-view of one or more cameras, detecting a request corresponding to content in the field-of-view of the one or more cameras; in response to detecting the request corresponding to the content in the field-of-view of the one or more cameras, displaying, via the display component, a user interface object closer to a first portion of the content than a second portion of the content; while displaying the user interface object closer to the first portion of the content than the second portion of the content, detecting an air gesture that corresponds to an input directed to the second portion of the content; and in response to detecting the air gesture that corresponds to the input directed to the second portion of the content: displaying, via the display component, the user interface object closer to the second portion of the content than the first portion of the content; and outputting, via the one or more output devices, a first set of one or more indications that the second portion of the content is currently a portion of interest.

In some embodiments, a computer program product is described. In some embodiments, the computer program product comprises one or more programs configured to be executed by one or more processors of a computer system that is in communication with one or more output devices including a display component, and one or more cameras. In some embodiments, the one or more programs include instructions for: while displaying, via the display component, a representation of a field-of-view of one or more cameras, detecting a request corresponding to content in the field-of-view of the one or more cameras; in response to detecting the request corresponding to the content in the field-of-view of the one or more cameras, displaying, via the display component, a user interface object closer to a first portion of the content than a second portion of the content; while displaying the user interface object closer to the first portion of the content than the second portion of the content, detecting an air gesture that corresponds to an input directed to the second portion of the content; and in response to detecting the air gesture that corresponds to the input directed to the second portion of the content: displaying, via the display component, the user interface object closer to the second portion of the content than the first portion of the content; and outputting, via the one or more output devices, a first set of one or more indications that the second portion of the content is currently a portion of interest.

In some embodiments, a method that is performed at a computer system that is in communication with one or more output devices including a display component and one or more cameras is described. In some embodiments, the method comprises: while displaying, via the display component, a representation of a field-of-view of the one or more cameras, detecting a request corresponding to content in the field-of-view of the one or more cameras, wherein the representation of the field-of-view of the one or more cameras includes the content; and in response to detecting the request corresponding to content in the field-of-view of the one or more cameras: in accordance with a determination that the content includes a first set of one or more characteristics, outputting, via the one or more output devices, a suggestion to add a first object to the content; and in accordance with a determination that the content includes a second set of one or more characteristics, different from the first set of one or more characteristics, outputting, via the one or more output devices, a suggestion to add a second object, different from the first object, to the content.

In some embodiments, a non-transitory computer-readable storage medium storing one or more programs configured to be executed by one or more processors of a computer system that is in communication with one or more output devices including a display component and one or more cameras is described. In some embodiments, the one or more programs includes instructions for: while displaying, via the display component, a representation of a field-of-view of the one or more cameras, detecting a request corresponding to content in the field-of-view of the one or more cameras, wherein the representation of the field-of-view of the one or more cameras includes the content; and in response to detecting the request corresponding to content in the field-of-view of the one or more cameras: in accordance with a determination that the content includes a first set of one or more characteristics, outputting, via the one or more output devices, a suggestion to add a first object to the content; and in accordance with a determination that the content includes a second set of one or more characteristics, different from the first set of one or more characteristics, outputting, via the one or more output devices, a suggestion to add a second object, different from the first object, to the content.

In some embodiments, a transitory computer-readable storage medium storing one or more programs configured to be executed by one or more processors of a computer system that is in communication with one or more output devices including a display component and one or more cameras is described. In some embodiments, the one or more programs includes instructions for: while displaying, via the display component, a representation of a field-of-view of the one or more cameras, detecting a request corresponding to content in the field-of-view of the one or more cameras, wherein the representation of the field-of-view of the one or more cameras includes the content; and in response to detecting the request corresponding to content in the field-of-view of the one or more cameras: in accordance with a determination that the content includes a first set of one or more characteristics, outputting, via the one or more output devices, a suggestion to add a first object to the content; and in accordance with a determination that the content includes a second set of one or more characteristics, different from the first set of one or more characteristics, outputting, via the one or more output devices, a suggestion to add a second object, different from the first object, to the content.

In some embodiments, a computer system that is in communication with one or more output devices including a display component and one or more cameras is described. In some embodiments, the computer system comprises one or more processors and memory storing one or more programs configured to be executed by the one or more processors. In some embodiments, the one or more programs includes instructions for: while displaying, via the display component, a representation of a field-of-view of the one or more cameras, detecting a request corresponding to content in the field-of-view of the one or more cameras, wherein the representation of the field-of-view of the one or more cameras includes the content; and in response to detecting the request corresponding to content in the field-of-view of the one or more cameras: in accordance with a determination that the content includes a first set of one or more characteristics, outputting, via the one or more output devices, a suggestion to add a first object to the content; and in accordance with a determination that the content includes a second set of one or more characteristics, different from the first set of one or more characteristics, outputting, via the one or more output devices, a suggestion to add a second object, different from the first object, to the content.

In some embodiments, a computer system that is in communication with one or more output devices including a display component and one or more cameras is described. In some embodiments, the computer system comprises means for performing each of the following steps: while displaying, via the display component, a representation of a field-of-view of the one or more cameras, detecting a request corresponding to content in the field-of-view of the one or more cameras, wherein the representation of the field-of-view of the one or more cameras includes the content; and in response to detecting the request corresponding to content in the field-of-view of the one or more cameras: in accordance with a determination that the content includes a first set of one or more characteristics, outputting, via the one or more output devices, a suggestion to add a first object to the content; and in accordance with a determination that the content includes a second set of one or more characteristics, different from the first set of one or more characteristics, outputting, via the one or more output devices, a suggestion to add a second object, different from the first object, to the content.

In some embodiments, a computer program product is described. In some embodiments, the computer program product comprises one or more programs configured to be executed by one or more processors of a computer system that is in communication with one or more output devices including a display component and one or more cameras. In some embodiments, the one or more programs include instructions for: while displaying, via the display component, a representation of a field-of-view of the one or more cameras, detecting a request corresponding to content in the field-of-view of the one or more cameras, wherein the representation of the field-of-view of the one or more cameras includes the content; and in response to detecting the request corresponding to content in the field-of-view of the one or more cameras: in accordance with a determination that the content includes a first set of one or more characteristics, outputting, via the one or more output devices, a suggestion to add a first object to the content; and in accordance with a determination that the content includes a second set of one or more characteristics, different from the first set of one or more characteristics, outputting, via the one or more output devices, a suggestion to add a second object, different from the first object, to the content.

In some embodiments, a method that is performed at a computer system that is in communication with one or more output devices including a display component and one or more cameras is described. In some embodiments, the method comprises: while displaying, via the display component, a representation of a field-of-view of the one or more cameras, detecting a request corresponding to content in the field-of-view of the one or more cameras; and in response to detecting the request corresponding to content in the field-of-view of the one or more cameras: in accordance with a determination that the request indicates that a first person is associated with the content, outputting, via the one or more output devices, an indication of a first set of one or more objects to incorporate in the content; and in accordance with a determination that the request indicates that a second person is associated with the content, outputting, via the one or more output devices, an indication of a second set of one of more objects, different from the first set of one or more objects, to incorporate in the content.

In some embodiments, a non-transitory computer-readable storage medium storing one or more programs configured to be executed by one or more processors of a computer system that is in communication with one or more output devices including a display component and one or more cameras is described. In some embodiments, the one or more programs includes instructions for: while displaying, via the display component, a representation of a field-of-view of the one or more cameras, detecting a request corresponding to content in the field-of-view of the one or more cameras; and in response to detecting the request corresponding to content in the field-of-view of the one or more cameras: in accordance with a determination that the request indicates that a first person is associated with the content, outputting, via the one or more output devices, an indication of a first set of one or more objects to incorporate in the content; and in accordance with a determination that the request indicates that a second person is associated with the content, outputting, via the one or more output devices, an indication of a second set of one of more objects, different from the first set of one or more objects, to incorporate in the content.

In some embodiments, a transitory computer-readable storage medium storing one or more programs configured to be executed by one or more processors of a computer system that is in communication with one or more output devices including a display component and one or more cameras is described. In some embodiments, the one or more programs includes instructions for: while displaying, via the display component, a representation of a field-of-view of the one or more cameras, detecting a request corresponding to content in the field-of-view of the one or more cameras; and in response to detecting the request corresponding to content in the field-of-view of the one or more cameras: in accordance with a determination that the request indicates that a first person is associated with the content, outputting, via the one or more output devices, an indication of a first set of one or more objects to incorporate in the content; and in accordance with a determination that the request indicates that a second person is associated with the content, outputting, via the one or more output devices, an indication of a second set of one of more objects, different from the first set of one or more objects, to incorporate in the content.

In some embodiments, a computer system that is in communication with one or more output devices including a display component and one or more cameras is described. In some embodiments, the computer system comprises one or more processors and memory storing one or more programs configured to be executed by the one or more processors. In some embodiments, the one or more programs includes instructions for: while displaying, via the display component, a representation of a field-of-view of the one or more cameras, detecting a request corresponding to content in the field-of-view of the one or more cameras; and in response to detecting the request corresponding to content in the field-of-view of the one or more cameras: in accordance with a determination that the request indicates that a first person is associated with the content, outputting, via the one or more output devices, an indication of a first set of one or more objects to incorporate in the content; and in accordance with a determination that the request indicates that a second person is associated with the content, outputting, via the one or more output devices, an indication of a second set of one of more objects, different from the first set of one or more objects, to incorporate in the content.

In some embodiments, a computer system that is in communication with one or more output devices including a display component and one or more cameras is described. In some embodiments, the computer system comprises means for performing each of the following steps: while displaying, via the display component, a representation of a field-of-view of the one or more cameras, detecting a request corresponding to content in the field-of-view of the one or more cameras; and in response to detecting the request corresponding to content in the field-of-view of the one or more cameras: in accordance with a determination that the request indicates that a first person is associated with the content, outputting, via the one or more output devices, an indication of a first set of one or more objects to incorporate in the content; and in accordance with a determination that the request indicates that a second person is associated with the content, outputting, via the one or more output devices, an indication of a second set of one of more objects, different from the first set of one or more objects, to incorporate in the content.

In some embodiments, a computer program product is described. In some embodiments, the computer program product comprises one or more programs configured to be executed by one or more processors of a computer system that is in communication with one or more output devices including a display component and one or more cameras. In some embodiments, the one or more programs include instructions for: while displaying, via the display component, a representation of a field-of-view of the one or more cameras, detecting a request corresponding to content in the field-of-view of the one or more cameras; and in response to detecting the request corresponding to content in the field-of-view of the one or more cameras: in accordance with a determination that the request indicates that a first person is associated with the content, outputting, via the one or more output devices, an indication of a first set of one or more objects to incorporate in the content; and in accordance with a determination that the request indicates that a second person is associated with the content, outputting, via the one or more output devices, an indication of a second set of one of more objects, different from the first set of one or more objects, to incorporate in the content.

In some embodiments, a method that is performed at a computer system that is in communication with one or more cameras and a movement component is described. In some embodiments, the method comprises: while at a first position, detecting a request corresponding to the content, wherein a first portion of the content is in the field-of-view of the one or more cameras and a second portion of the content is not in the field-of-view of the one or more cameras; in response to detecting the request corresponding to the content: establishing a first internal dialogue based on a context related to the request and the first portion of the content; and moving, via a movement component, from the first position to a second position, such that the second portion of the content is in the field-of-view of the one or more cameras; and after establishing the first internal dialogue and after moving from the first position to the second portion, such that the second portion of the content is in the field-of-view of the one or more cameras: determining, based on capturing the second portion of content via the one or more camera, a change in context related to the request; and establishing a second internal dialogue based on the context related to the request, the first portion of the content, and the second portion of the content.

In some embodiments, a non-transitory computer-readable storage medium storing one or more programs configured to be executed by one or more processors of a computer system that is in communication with one or more cameras and a movement component is described. In some embodiments, the one or more programs includes instructions for: while at a first position, detecting a request corresponding to the content, wherein a first portion of the content is in the field-of-view of the one or more cameras and a second portion of the content is not in the field-of-view of the one or more cameras; in response to detecting the request corresponding to the content: establishing a first internal dialogue based on a context related to the request and the first portion of the content; and moving, via a movement component, from the first position to a second position, such that the second portion of the content is in the field-of-view of the one or more cameras; and after establishing the first internal dialogue and after moving from the first position to the second portion, such that the second portion of the content is in the field-of-view of the one or more cameras: determining, based on capturing the second portion of content via the one or more camera, a change in context related to the request; and establishing a second internal dialogue based on the context related to the request, the first portion of the content, and the second portion of the content.

In some embodiments, a transitory computer-readable storage medium storing one or more programs configured to be executed by one or more processors of a computer system that is in communication with one or more cameras and a movement component is described. In some embodiments, the one or more programs includes instructions for: while at a first position, detecting a request corresponding to the content, wherein a first portion of the content is in the field-of-view of the one or more cameras and a second portion of the content is not in the field-of-view of the one or more cameras; in response to detecting the request corresponding to the content: establishing a first internal dialogue based on a context related to the request and the first portion of the content; and moving, via a movement component, from the first position to a second position, such that the second portion of the content is in the field-of-view of the one or more cameras; and after establishing the first internal dialogue and after moving from the first position to the second portion, such that the second portion of the content is in the field-of-view of the one or more cameras: determining, based on capturing the second portion of content via the one or more camera, a change in context related to the request; and establishing a second internal dialogue based on the context related to the request, the first portion of the content, and the second portion of the content.

In some embodiments, a computer system that is in communication with one or more cameras and a movement component is described. In some embodiments, the computer system comprises one or more processors and memory storing one or more programs configured to be executed by the one or more processors. In some embodiments, the one or more programs includes instructions for: while at a first position, detecting a request corresponding to the content, wherein a first portion of the content is in the field-of-view of the one or more cameras and a second portion of the content is not in the field-of-view of the one or more cameras; in response to detecting the request corresponding to the content: establishing a first internal dialogue based on a context related to the request and the first portion of the content; and moving, via a movement component, from the first position to a second position, such that the second portion of the content is in the field-of-view of the one or more cameras; and after establishing the first internal dialogue and after moving from the first position to the second portion, such that the second portion of the content is in the field-of-view of the one or more cameras: determining, based on capturing the second portion of content via the one or more camera, a change in context related to the request; and establishing a second internal dialogue based on the context related to the request, the first portion of the content, and the second portion of the content.

In some embodiments, a computer system that is in communication with one or more cameras and a movement component is described. In some embodiments, the computer system comprises means for performing each of the following steps: while at a first position, detecting a request corresponding to the content, wherein a first portion of the content is in the field-of-view of the one or more cameras and a second portion of the content is not in the field-of-view of the one or more cameras; in response to detecting the request corresponding to the content: establishing a first internal dialogue based on a context related to the request and the first portion of the content; and moving, via a movement component, from the first position to a second position, such that the second portion of the content is in the field-of-view of the one or more cameras; and after establishing the first internal dialogue and after moving from the first position to the second portion, such that the second portion of the content is in the field-of-view of the one or more cameras: determining, based on capturing the second portion of content via the one or more camera, a change in context related to the request; and establishing a second internal dialogue based on the context related to the request, the first portion of the content, and the second portion of the content.

In some embodiments, a computer program product is described. In some embodiments, the computer program product comprises one or more programs configured to be executed by one or more processors of a computer system that is in communication with one or more cameras and a movement component. In some embodiments, the one or more programs include instructions for: while at a first position, detecting a request corresponding to the content, wherein a first portion of the content is in the field-of-view of the one or more cameras and a second portion of the content is not in the field-of-view of the one or more cameras; in response to detecting the request corresponding to the content: establishing a first internal dialogue based on a context related to the request and the first portion of the content; and moving, via a movement component, from the first position to a second position, such that the second portion of the content is in the field-of-view of the one or more cameras; and after establishing the first internal dialogue and after moving from the first position to the second portion, such that the second portion of the content is in the field-of-view of the one or more cameras: determining, based on capturing the second portion of content via the one or more camera, a change in context related to the request; and establishing a second internal dialogue based on the context related to the request, the first portion of the content, and the second portion of the content.

In some embodiments, a method that is performed at a computer system that is in communication with one or more input devices and one or more output devices is described. In some embodiments, the method comprises: detecting, via the one or more input devices, input corresponding to a request to navigate to a first destination; and in response to detecting the input corresponding to the request to navigate to the first destination: in accordance with a determination that the first destination corresponds to contextual information, outputting, via the one or more output devices, a first response that includes a first suggested route to the first destination with a first intermediate destination, wherein the input corresponding to the request to navigate to the first destination does not include an indication of the first intermediate destination; and in accordance with a determination that the first destination does not correspond to the contextual information, outputting, via the one or more output devices, a second response that includes a second suggested route to the first destination without the first intermediate destination.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, input corresponding to a request to navigate to a first destination; and in response to detecting the input corresponding to the request to navigate to the first destination: in accordance with a determination that the first destination corresponds to contextual information, outputting, via the one or more output devices, a first response that includes a first suggested route to the first destination with a first intermediate destination, wherein the input corresponding to the request to navigate to the first destination does not include an indication of the first intermediate destination; and in accordance with a determination that the first destination does not correspond to the contextual information, outputting, via the one or more output devices, a second response that includes a second suggested route to the first destination without the first intermediate destination.

In some embodiments, a transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, input corresponding to a request to navigate to a first destination; and in response to detecting the input corresponding to the request to navigate to the first destination: in accordance with a determination that the first destination corresponds to contextual information, outputting, via the one or more output devices, a first response that includes a first suggested route to the first destination with a first intermediate destination, wherein the input corresponding to the request to navigate to the first destination does not include an indication of the first intermediate destination; and in accordance with a determination that the first destination does not correspond to the contextual information, outputting, via the one or more output devices, a second response that includes a second suggested route to the first destination without the first intermediate destination.

In some embodiments, a computer system that is in communication with one or more input devices and one or more output devices is described. In some embodiments, the computer system that is in communication with one or more input devices and one or more output devices comprises one or more processors and memory storing one or more programs configured to be executed by the one or more processors. In some embodiments, the one or more programs includes instructions for: detecting, via the one or more input devices, input corresponding to a request to navigate to a first destination; and in response to detecting the input corresponding to the request to navigate to the first destination: in accordance with a determination that the first destination corresponds to contextual information, outputting, via the one or more output devices, a first response that includes a first suggested route to the first destination with a first intermediate destination, wherein the input corresponding to the request to navigate to the first destination does not include an indication of the first intermediate destination; and in accordance with a determination that the first destination does not correspond to the contextual information, outputting, via the one or more output devices, a second response that includes a second suggested route to the first destination without the first intermediate destination.

In some embodiments, a computer system that is in communication with one or more input devices and one or more output devices is described. In some embodiments, the computer system that is in communication with one or more input devices and one or more output devices comprises means for performing each of the following steps: detecting, via the one or more input devices, input corresponding to a request to navigate to a first destination; and in response to detecting the input corresponding to the request to navigate to the first destination: in accordance with a determination that the first destination corresponds to contextual information, outputting, via the one or more output devices, a first response that includes a first suggested route to the first destination with a first intermediate destination, wherein the input corresponding to the request to navigate to the first destination does not include an indication of the first intermediate destination; and in accordance with a determination that the first destination does not correspond to the contextual information, outputting, via the one or more output devices, a second response that includes a second suggested route to the first destination without the first intermediate destination.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: detecting, via the one or more input devices, input corresponding to a request to navigate to a first destination; and in response to detecting the input corresponding to the request to navigate to the first destination: in accordance with a determination that the first destination corresponds to contextual information, outputting, via the one or more output devices, a first response that includes a first suggested route to the first destination with a first intermediate destination, wherein the input corresponding to the request to navigate to the first destination does not include an indication of the first intermediate destination; and in accordance with a determination that the first destination does not correspond to the contextual information, outputting, via the one or more output devices, a second response that includes a second suggested route to the first destination without the first intermediate destination.

In some embodiments, a method that is performed at a computer system that is in communication with one or more input devices and a display generation component is described. In some embodiments, the method comprises: detecting, via the one or more input devices, input directed to an agent and corresponding to a request to navigate to a destination; and in response to detecting the input corresponding to the request to navigate to the destination, displaying, via the display generation component, a response that includes concurrently displaying: a first suggested route, to the destination, corresponding to a first application; and a second suggested route, to the destination, corresponding to a second application different from the first application.

In some embodiments, a non-transitory computer-readable storage medium storing one or more programs configured to be executed by one or more processors of a computer system that is in communication with one or more input devices and a display generation component is described. In some embodiments, the one or more programs includes instructions for: detecting, via the one or more input devices, input directed to an agent and corresponding to a request to navigate to a destination; and in response to detecting the input corresponding to the request to navigate to the destination, displaying, via the display generation component, a response that includes concurrently displaying: a first suggested route, to the destination, corresponding to a first application; and a second suggested route, to the destination, corresponding to a second application different from the first application.

In some embodiments, a transitory computer-readable storage medium storing one or more programs configured to be executed by one or more processors of a computer system that is in communication with one or more input devices and a display generation component is described. In some embodiments, the one or more programs includes instructions for: detecting, via the one or more input devices, input directed to an agent and corresponding to a request to navigate to a destination; and in response to detecting the input corresponding to the request to navigate to the destination, displaying, via the display generation component, a response that includes concurrently displaying: a first suggested route, to the destination, corresponding to a first application; and a second suggested route, to the destination, corresponding to a second application different from the first application.

In some embodiments, a computer system that is in communication with one or more input devices and a display generation component is described. In some embodiments, the computer system that is in communication with one or more input devices and a display generation component comprises one or more processors and memory storing one or more programs configured to be executed by the one or more processors. In some embodiments, the one or more programs includes instructions for: detecting, via the one or more input devices, input directed to an agent and corresponding to a request to navigate to a destination; and in response to detecting the input corresponding to the request to navigate to the destination, displaying, via the display generation component, a response that includes concurrently displaying: a first suggested route, to the destination, corresponding to a first application; and a second suggested route, to the destination, corresponding to a second application different from the first application.

In some embodiments, a computer system that is in communication with one or more input devices and a display generation component is described. In some embodiments, the computer system that is in communication with one or more input devices and a display generation component comprises means for performing each of the following steps: detecting, via the one or more input devices, input directed to an agent and corresponding to a request to navigate to a destination; and in response to detecting the input corresponding to the request to navigate to the destination, displaying, via the display generation component, a response that includes concurrently displaying: a first suggested route, to the destination, corresponding to a first application; and a second suggested route, to the destination, corresponding to a second application different from the first application.

In some embodiments, a computer program product is described. In some embodiments, the computer program product comprises one or more programs configured to be executed by one or more processors of a computer system that is in communication with one or more input devices and a display generation component. In some embodiments, the one or more programs include instructions for: detecting, via the one or more input devices, input directed to an agent and corresponding to a request to navigate to a destination; and in response to detecting the input corresponding to the request to navigate to the destination, displaying, via the display generation component, a response that includes concurrently displaying: a first suggested route, to the destination, corresponding to a first application; and a second suggested route, to the destination, corresponding to a second application different from the first application.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a computer system in accordance with some embodiments.

FIGS. 2A-2C are diagrams illustrating exemplary components and user interfaces of device 200 in accordance with some embodiments.

FIG. 3 is a block diagram illustrating exemplary components of a device in accordance with some embodiments.

FIG. 4 is a functional diagram of an exemplary actuator device in accordance with some embodiments.

FIG. 5 is a functional diagram of an exemplary agent system in accordance with some embodiments.

FIGS. 6A-6F illustrate exemplary user interfaces for moving to capture content in accordance with some embodiments.

FIG. 7 is a flow diagram illustrating methods for moving to capture content in accordance with some embodiments.

FIGS. 8A-8E illustrate exemplary user interfaces for changing an object to display a portion of interest in accordance with some embodiments.

FIG. 9 is a flow diagram illustrating methods for displaying a portion of interest based on context in accordance with some embodiments.

FIG. 10 is a flow diagram illustrating methods for displaying an object closer to content in accordance with some embodiments.

FIG. 11 is a flow diagram illustrating methods for outputting a suggestion to add an object in accordance with some embodiments.

FIG. 12 is a flow diagram illustrating methods for outputting an object to incorporate in content in accordance with some embodiments.

FIG. 13 is a flow diagram illustrating methods for establishing a dialogue in accordance with some embodiments.

FIGS. 14A-14E illustrate exemplary user interfaces for outputting navigation content in accordance with some embodiments.

FIG. 15 is a flow diagram illustrating methods for outputting a route to a destination with an intermediate destination in accordance with some embodiments.

FIG. 16 is a flow diagram illustrating methods for displaying a suggested route in accordance with some embodiments.

### DETAILED DESCRIPTION

The description to follow sets forth exemplary methods, components, parameters, and the like. While specific examples are set out below, it should be recognized that such examples should not be understood as limiting the scope of the present disclosure to the explicit descriptions of the examples set forth herein but instead should be understood as providing illustrative examples.

Each of the identified modules and applications herein corresponds to a set of executable instructions for performing one or more functions described above and the methods described in this application (e.g., the computer-implemented methods and other information processing methods described herein). These modules (e.g., sets of instructions) optionally need not be implemented as separate software programs (such as computer programs (e.g., including instructions)), procedures, or modules, and thus various subsets of these modules are, optionally, combined or otherwise rearranged in various embodiments. For example, a video player module is, optionally, combined with a music player module into a single module. In some embodiments, memory optionally stores a subset of the modules and data structures identified above. Furthermore, memory optionally stores additional modules and data structures not described above.

One or more steps of the methods described herein can rely on (be contingent on) one or more conditions being satisfied. In some embodiments, a method is performed by iterating a process multiple times. In some embodiments, contingent steps can be satisfied on different iterations of the same process and still be within the scope of the methods described herein. For example, for a given method that includes two steps that are contingent on different conditions, one of ordinary skill in the art would understand that the given method is considered performed even when a process is repeated multiple times until the contingent steps are satisfied. In some embodiments, multiple iterations of a process are not required to in order to practice claims as presented herein. For example, electronic device, system, or computer readable medium claims can be performed without iteratively repeating a process. In some embodiments, the electronic device, system, or computer readable medium claims include instructions for performing one or more steps that are contingent upon one or more conditions being satisfied. Because such instructions are stored in one or more processors and/or at one or more memory locations, the electronic device, system, or computer readable medium claims can include logic that determines whether the one or more conditions have been satisfied without needing to repeat steps of a process.

Although elements are described below using numerical descriptors, such as “a first” and/or “a second,” these elements do not correspond to order or distinct representations and should not be limited to the stated numerical term. In some embodiments, these terms simply used as prefix to distinguish a reference to one element from a reference to another element. For example, a “first” device and a “second” device can be two separate references to the same device. In contrast, for example, a “first” device and a “second” device can be a reference to two different devices (e.g., not the same device and/or not the same type of device). For example, a first computer system and a second computer system do not correspond to a first and a second in time, and merely are used to distinguish between two computer systems. As such, the first computer system can be termed a second computer system, and the second computer system can be termed a first computer system without departing from the scope of the various described embodiments.

For description of various elements and examples, the use of certain terminology is used to provide productive descriptions of the subject matter below and should not be read as limiting. As used to describe various examples herein, the singular forms of “a,” “an,” and “the” should not be interpreted as precluding or excluding the plural forms as well, unless the context clearly indicates otherwise. As well, “and/or” is used to encompasses any and all possible combinations of one or more associated listed items. For example, “x and/or y” should be interpreted as including “x,” or “y,” as well as “x and y” as possible permutations. Further, the use of the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

When describing choices and/or logical possibilities, the term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

The processes described below enhance the operability of the devices and make the user-device and/or user-device interfaces more efficient (e.g., by helping the user and/or user to provide proper inputs and reducing user mistakes when operating/interacting with the device) through various techniques, including by providing improved feedback (e.g., visual, haptic, audible, and/or tactile feedback) to the user, reducing the number of inputs needed to perform an operation, providing additional control options without cluttering the user interface with additional displayed controls, performing an operation when a set of conditions has been met without requiring further input (e.g., input by a user), and/or additional techniques, such as increasing the security and/or privacy of the computer system and reducing burn-in of one or more portions of a user interface of a display. These techniques also reduce power usage and improve battery life of the device by enabling the user to use the device more quickly and efficiently.

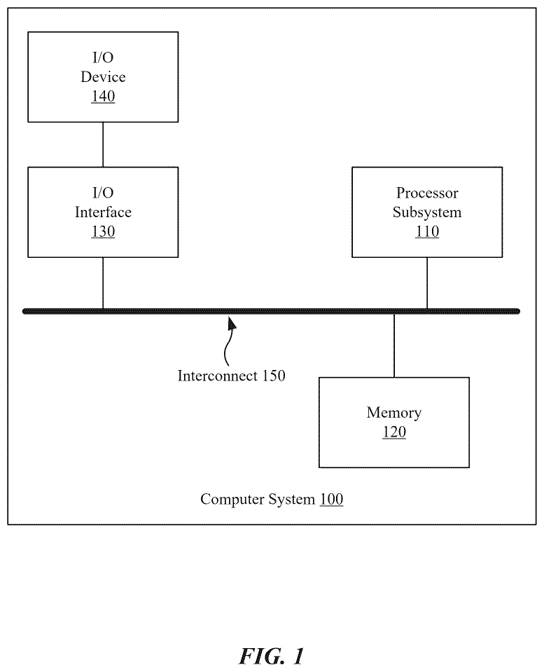

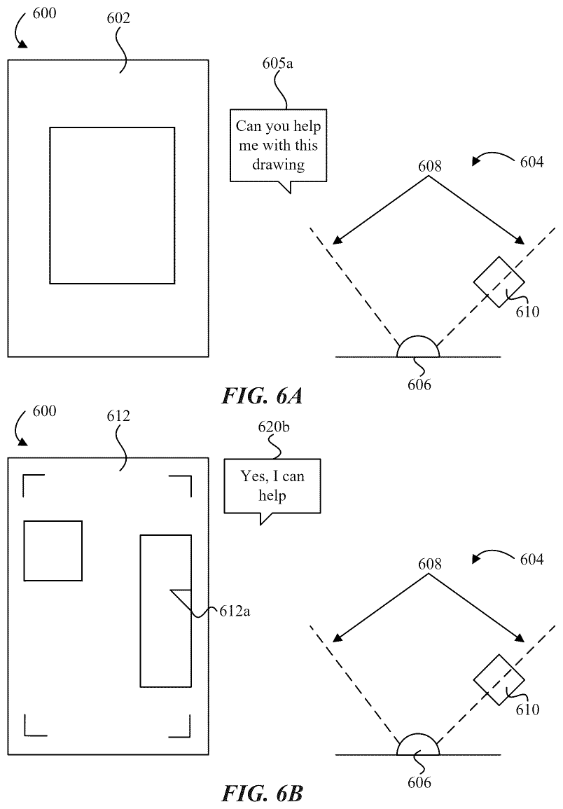

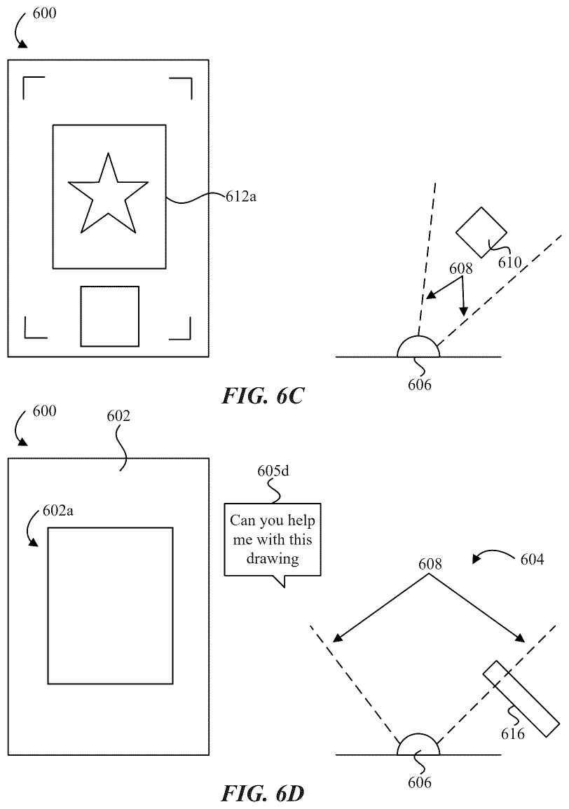

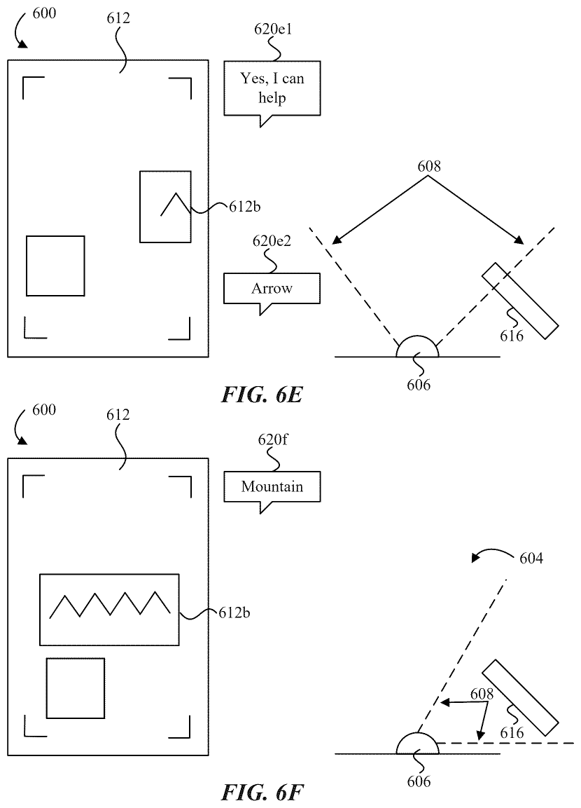

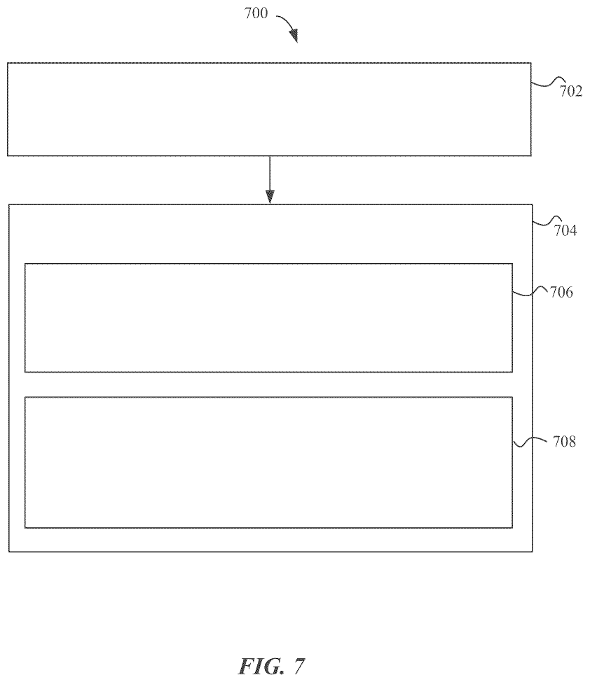

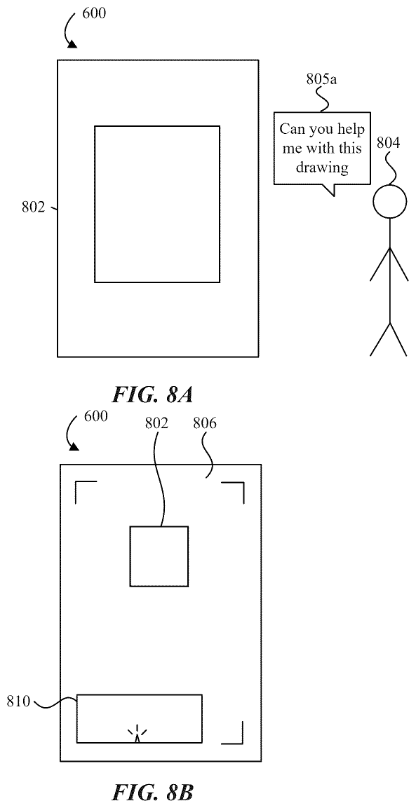

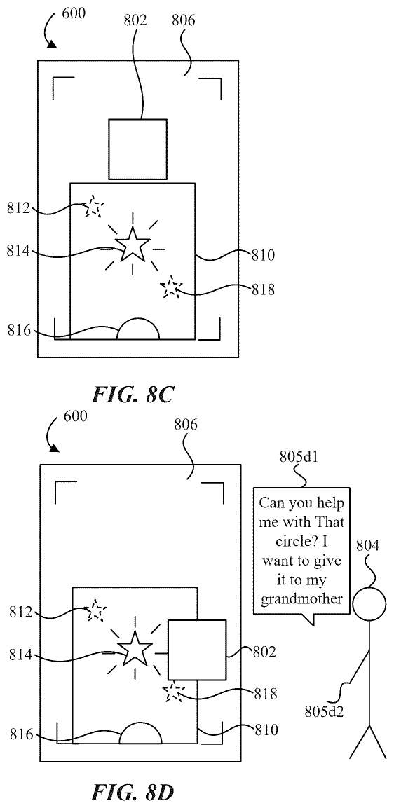

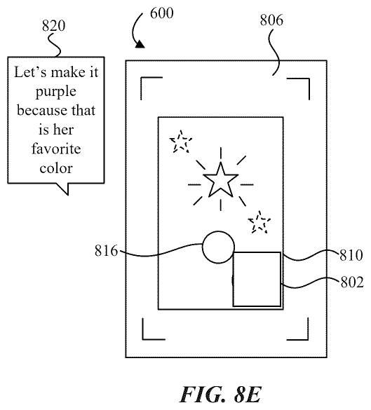

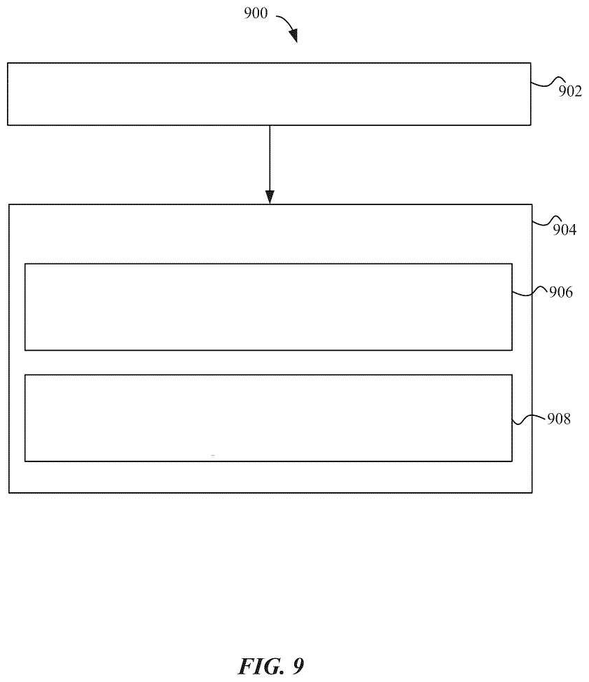

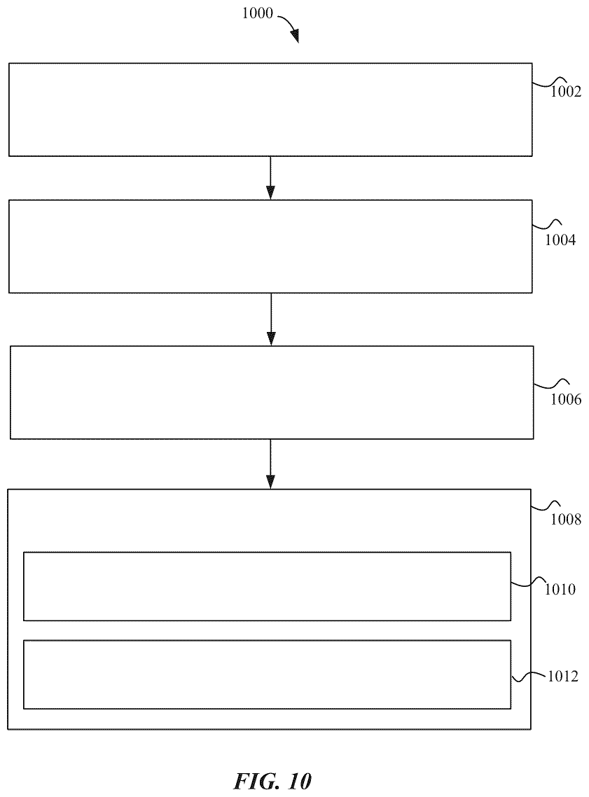

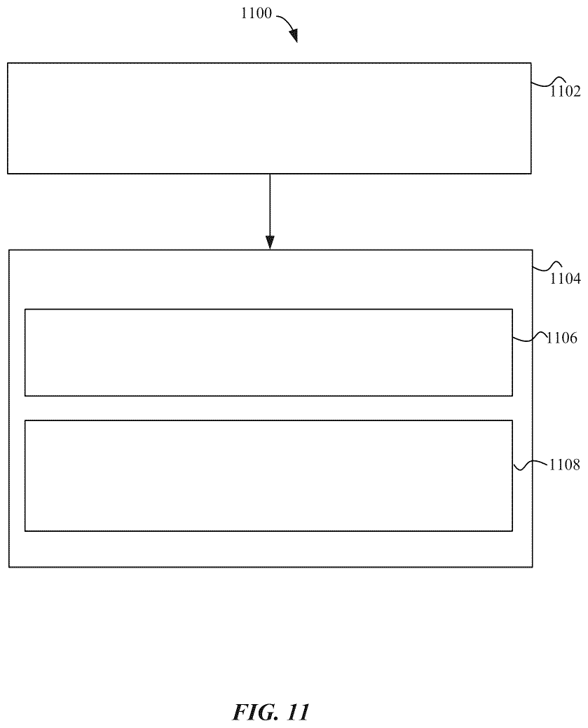

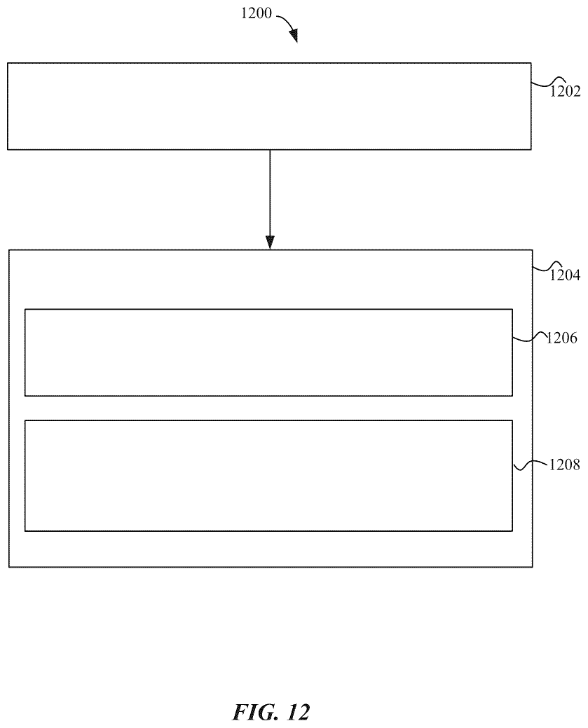

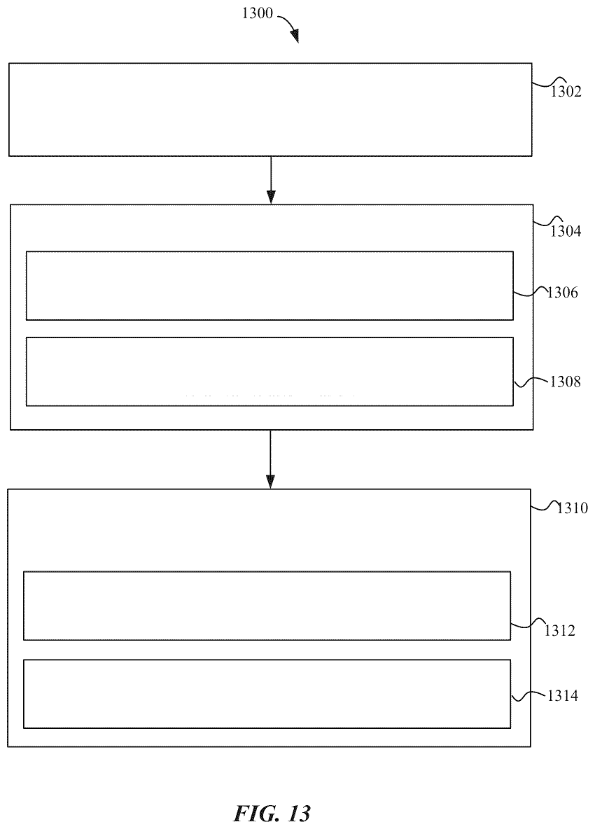

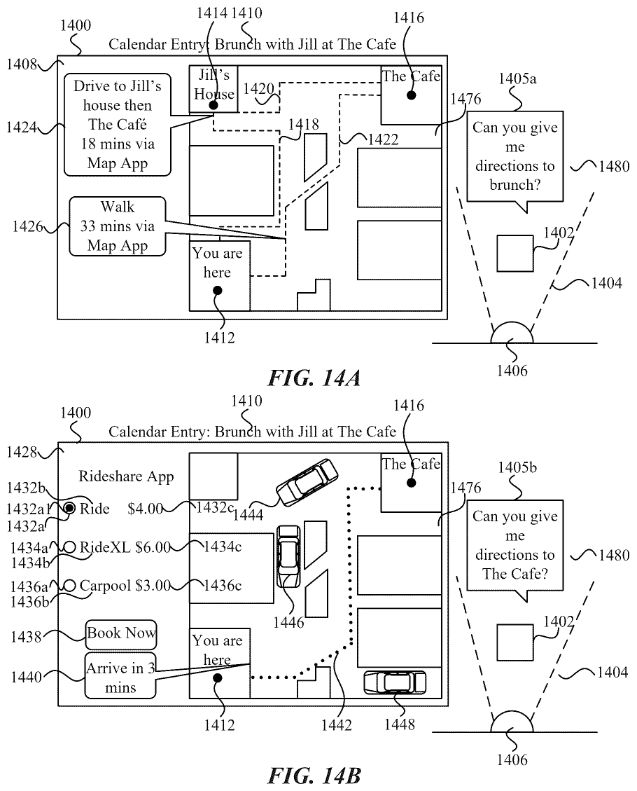

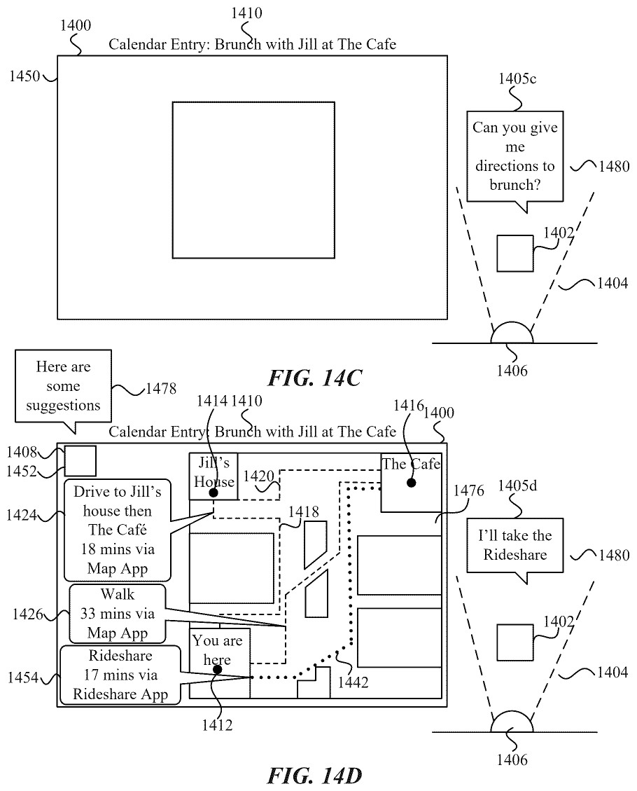

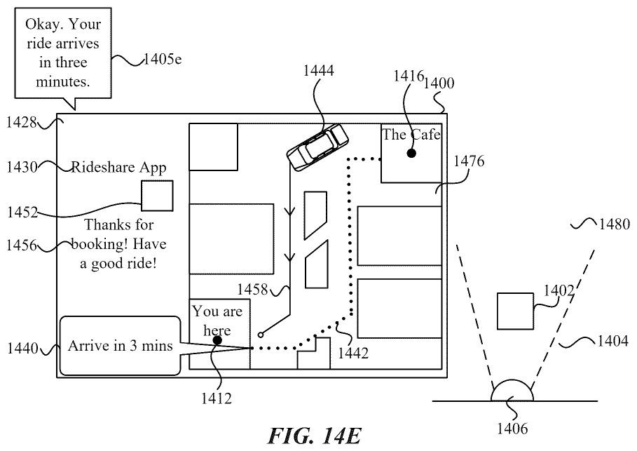

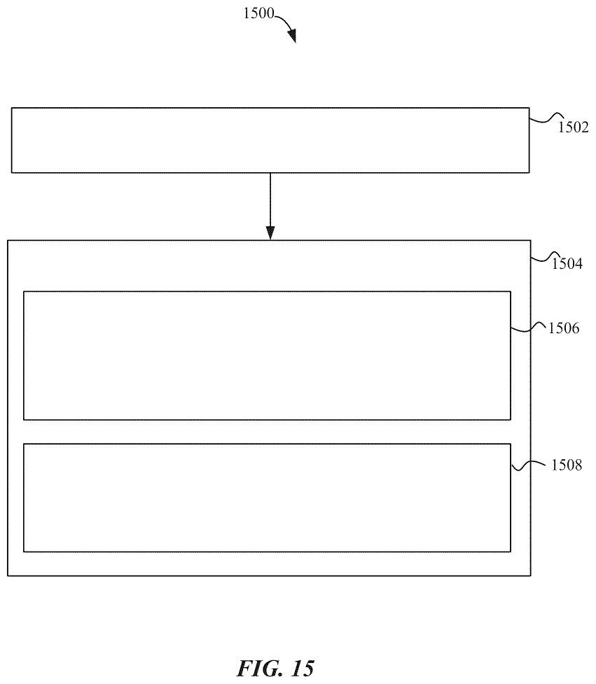

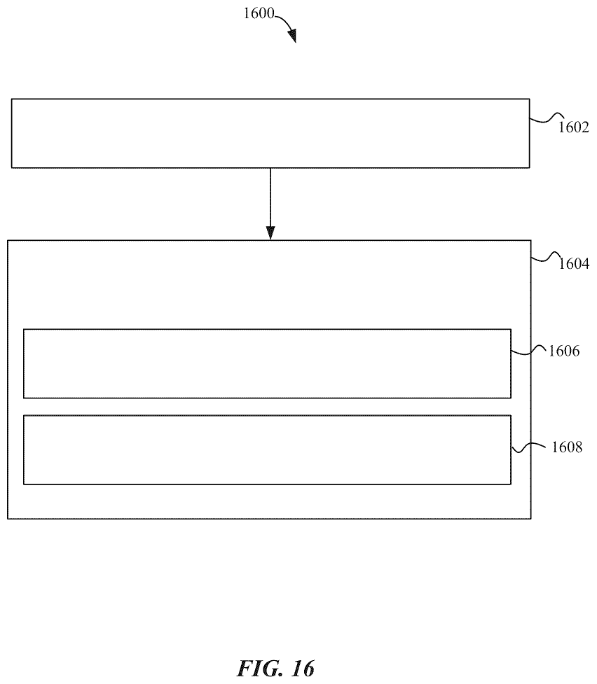

Below, FIGS. 1, 2A-2C, and 3-5 provide a description of exemplary devices for performing the techniques for managing content. FIGS. 6A-6F illustrate exemplary user interfaces for moving to capture content in accordance with some embodiments. FIG. 7 is a flow diagram illustrating methods for moving to capture content in accordance with some embodiments. The user interfaces in FIGS. 6A-6F are used to illustrate the processes described below, including the processes in FIG. 7. FIGS. 8A-8E illustrate exemplary user interfaces for changing an object to display a portion of interest in accordance with some embodiments. FIG. 9 is a flow diagram illustrating methods for displaying a portion of interest based on context in accordance with some embodiments. FIG. 10 is a flow diagram illustrating methods for displaying an object closer to content in accordance with some embodiments. FIG. 11 is a flow diagram illustrating methods for outputting a suggestion to add an object in accordance with some embodiments. FIG. 12 is a flow diagram illustrating methods for outputting an object to incorporate in content in accordance with some embodiments. FIG. 13 is a flow diagram illustrating methods for establishing a dialogue in accordance with some embodiments. The user interfaces in FIGS. 8A-8E are used to illustrate the processes described below, including the processes in FIGS. 9, 10, 11, 12, and 13. FIGS. 14A-14E illustrate exemplary user interfaces for moving a computer system toward another computer system for transferring content in accordance with some embodiments. FIG. 15 is a flow diagram illustrating methods for moving a computer system toward another computer system for transferring content in accordance with some embodiments. FIG. 16 is a flow diagram illustrating methods for outputting generated instructions to perform a skill related to content in accordance with some embodiments. The user interfaces in FIGS. 134-14E are used to illustrate the processes described below, including the processes in FIGS. 15 and 16.

FIG. 1 depicts a block diagram of computer system 100 (e.g., electronic device and/or electronic system) including a set of electronic components in communication with (e.g., connected to) (e.g., wired or wirelessly) to each other. It should be understood that computer system 100 is merely one example of a computer system that can be used to perform functionality described below and that one or more other computer systems can be used to perform the functionality described below. Additionally, while FIG. 1 depicts a computer architecture of computer system 100, other computer architectures (e.g., including more components, similar components, and/or fewer components) of a computer system can be used to perform functionality described herein.

In some embodiments, computer system 100 can correspond to (e.g., be and/or include) a system on a chip, a server system, a personal computer system, a smart phone, a smart watch, a wearable device, a tablet, a laptop computer, a fitness tracking device, a head-mounted display (HMD) device, a desktop computer, a communal device (e.g., smart speaker, connected thermostat, and/or additional home based computer systems), an accessory (e.g., switch, light, speaker, air conditioner, heater, window cover, fan, lock, media playback device, television, and so forth), a controller, a hub, and/or a sensor.

In some embodiments, a sensor includes one or more hardware components capable of detecting (e.g., sensing, generating, and/or processing) information about a physical environment in proximity to the sensor. For example, a sensor can be configured to detect information surrounding the sensor, detect information in one or more directions casting away from the sensor, and/or detect information based on contact of the sensor with an element of the physical environment. In some embodiments, a hardware component of a sensor includes a sensing component (e.g., a temperature and/or image sensor), a transmitting component (e.g., a radio and/or laser transmitter), and/or a receiving component (e.g., a laser and/or radio receiver). In some embodiments, a sensor includes an angle sensor, a breakage sensor, a flow sensor, a force sensor, a gas sensor, a humidity or moisture sensor, a glass breakage sensor, a chemical sensor, a contact sensor, a non-contact sensor, an image sensor (e.g., a RGB camera and/or an infrared sensor), a particle sensor, a photoelectric sensor (e.g., ambient light and/or solar), a position sensor (e.g., a global positioning system), a precipitation sensor, a pressure sensor, a proximity sensor, a radiation sensor, an inertial measurement unit, a leak sensor, a level sensor, a metal sensor, a microphone, a motion sensor, a range or depth sensor (e.g., RADAR, LiDAR), a speed sensor, a temperature sensor, a time-of-flight sensor, a torque sensor, and an ultrasonic sensor, a vacancy sensor, a presence sensor, a voltage and/or current sensor, a conductivity sensor, a resistivity sensor, a capacitive sensor, and/or a water sensor. While only a single computer system is depicted in FIG. 1, functionality described below can be implemented with two or more computer systems operating together. Additionally, in some embodiments, computer system 100 includes one or more sensors as described above, and information about the physical environment is captured by combining data from one sensor with data from one or more additional sensors (e.g., that are part of the computer and/or one or more additional computer systems).

As illustrated in FIG. 1, computer system 100 consists of processor subsystem 110, memory 120, and I/O interface 130. Memory 120 corresponds to system memory in communication with processor subsystem 110. The electronic components making up computer system 100 are electrically connected through interconnect 150, which allows communication between the components of computer system 100. For example, interconnect 150 can be a system bus, one or more memory locations, and/or additional electrical channels for connective multiple components of computer system 100. Also, I/O interface 130 is connected to, via a wired and/or wireless connection, I/O device 140. In some embodiments, computer system 100 includes a component made up of I/O interface 130 and I/O device 140 such that the functionality of the individual components is included in the component. Additionally, it should be understood that computer system 100 can include one or more I/O interfaces, communicating with one or more I/O devices. In some embodiments, computer system 100 consists of multiple processor subsystem 100s, each electrically connected through interconnect 150.

In some embodiments, processor subsystem 110 includes one or more processors or individual processing units capable of executing instructions (e.g., program, system, and/or interrupt) to perform functionality described herein. For example, operating system level and/or application level instructions executed by processor subsystem 110. In some embodiments, processor subsystem 110 includes one or more components (e.g., implemented as hardware, software, and/or a combination thereof) capable of supporting, interpreting, and/or performing machine learning instructions and/or operations. For example, computer system 100 can perform operations according to a machine learning model locally. Alternatively, or in addition, computer system 100 can communicate with (e.g., performing calculations on and/or executing instructions corresponding to) a remote interactive knowledge base (e.g., a processing resource that implements a machine learning model, artificial intelligence model, and/or large language model) to perform operations that can be otherwise outside a set of capabilities of computer system 100. For example, computer system 100 can determine a set of inputs (e.g., instructions, data, and/or parameters) to the interactive knowledge base for performing desired machine learning operations.

Memory 120 in communication with processor subsystem 110 can be implemented by a variety of different physical, non-transitory memory media. In some embodiments, computer system 100 includes multiple memory components and/or multiple types of memory components, each connected to processor subsystem 110 directly and/or via interconnect 150. For example, memory 120 can be implemented using a removable flash drive, storage array, a storage area network (e.g., SAN), flash memory, hard disk storage, optical drive storage, floppy disk storage, removable disk storage, random access memory (e.g., SDRAM, DDR SDRAM, RAM-SRAM, EDO RAM, and/or RAMBUS RAM), and/or read only memory (e.g., PROM and/or EEPROM). Additionally, in some embodiments, processor subsystem 110 and/or interconnect 150 is connected to a memory controller that is electrically connected to memory 120.

In some embodiments, instructions can be executed by processor subsystem 110. In this example, memory 120 can include a computer readable medium (e.g., non-transitory or transitory computer readable medium) usable to store (e.g., configured to store, assigned to store, and/or that stores) instructions to be executable by processor subsystem 110. In some embodiments each instruction stored by memory 120 and executed by processor subsystem 110 corresponds to an operation for completing the functionality described herein. For example, memory 120 can store program instructions to implement the functionality associated with the methods described below including 700, 900, 1000, 1100, 1200, and 1300 (FIGS. 7, 9, 10, 11, 12, and 13).

As mentioned above, I/O interface 130 can be one or more types of interfaces enabling computer system 100 to communicate with other devices. In some embodiments, I/O interface 130 includes a bridge chip (e.g., Southbridge) from a front-side bus to one or more back-side buses. In some embodiments, I/O interface 130 enables communication with one or more I/O devices, illustrated as I/O device 140, via one or more corresponding buses or other interfaces. For example, an I/O device can include one or more: a physical user-interface devices (e.g., a physical keyboard, a mouse, and/or a joystick), storage devices (e.g., as described above with respect to memory 120), network interface devices (e.g., to a local or wide-area network), sensor devices (e.g., as described above with respect to sensors), and/or auditory and/or visual output devices (e.g., screen, speaker, light, and/or projector). In some embodiments, the visual output device is referred to as a display component. For example, the display component can be configured to provide visual output, such as displaying images on a physically viewable medium via an LED display or image projection. As used herein, “displaying” content includes causing to display the content (e.g., video data rendered and/or decoded by a display controller) by transmitting, via a wired or wireless connection, data (e.g., image data and/or video data) to an integrated or external display component to visually produce the content.

In some embodiments, computer system 100 includes a component that integrates I/O device 140 with other components (e.g., a component that includes I/O interface 130 and I/O device 140). In some embodiments, I/O device 140 is separate from other components of computer system 100 (e.g., is a discrete component). In some embodiments, I/O device 140 includes a network interface device that permits computer system 100 to connect to (e.g., communicate with) a network or other computer systems, in a wired or wireless manner. In some embodiments, a network interface device can include Wi-Fi, Bluetooth, NFC, USB, Thunderbolt, Ethernet, and so forth. For example, computer system 100 can utilize an NFC connection to facilitate a bank, credit, financial, token (e.g., fungible or non-fungible token), and/or cryptocurrency transaction between computer system 100 and another computer system within proximity.

In some embodiments, I/O device 140 includes components for detecting a user (e.g., a user, a person, an animal, another computer system different from the computer system, and/or an object) and/or an input (e.g., a tap input and/or a non-tap input (e.g., a verbal input, an audible request, an audible command, an audible statement, a swipe input, a hold-and-drag input, a gaze input, an air gesture, and/or a mouse click)) from a detected user. In some embodiments, I/O device 140 enables computer system 100 to identify users associated with and/or without an account within an environment. For example, computer system 100 can detect a known user (e.g., a user that corresponds to an account) and access information about the user using the known user's account. In some embodiments, as part of computer system 100 detecting a user, computer system 100 detects that the user's account is associated with (e.g., is included in and/or identified with respect to) a group of users. For example, computer system 100 can access information associated with a family of accounts in response to detecting a member of the family that is defined as a group of accounts. In some embodiments, as account corresponding to a user can be connected with additional accounts and/or additional computer systems. For example, computer system 100 can detect such additional computer systems and/or detect such computer systems for detecting the user. In some embodiments, computer system 100 detects unknown users and enables guest accounts for the unknown users to utilize computer system 100.

In some embodiments, I/O device 140 includes one or more cameras. In some embodiments, a camera includes an image sensor (e.g., one or more optical sensors and/or one or more depth camera sensors) that provides computer system 100 with the ability to detect a user and/or a user's gestures (e.g., hand gestures and/or air gestures) as input. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body). In some embodiments, the one or more cameras enable computer system 100 to transmit pictorial and/or video information to an application. For example, image data captured by a camera can enable computer system 100 to complete a video phone call by transmitting video data to an application for performing the video phone call.

In some embodiments, I/O device 140 includes one or more microphones. For example, a microphone can be used by 100 to obtain data and/or information from a user without a contact input. In some embodiments, a microphone enables computer system 100 to detect verbal and/or speech input from a user. In some embodiments, computer system 100 utilizes speech input to enable personal assistant functionality. For example, a user eliciting a request to computer system 100 to perform an action and/or obtain information for the user. In some embodiments, computer system 100 utilizes speech input (e.g., along with one or more other input and/or output techniques) to request and/or detect information from a user without requiring the user to make physical contact with computer system 100.

In some embodiments, I/O device 140 includes physical input mediums for a user to interact directly with computer system 100. In some embodiments, a physical input medium includes one or more physical buttons (e.g., tactile depressible button and/or touch sensitive non-depressible component) on computer system 100 and/or connected to computer system 100, a mouse and keyboard input method (e.g., connected to computer system 100 together and/or separately with one or more I/O interfaces), and/or a touch sensitive display component.

In some embodiments, I/O device 140 includes one or more components for outputting information (e.g., a display component, an audio generation component, a speaker, a haptic output device, a display screen, a projector, and/or a touch-sensitive display). In some embodiments, computer system 100 uses I/O device 140 to convey information and/or a state of computer system 100. In some embodiments, I/O device 140 includes a tactile output component. For example, a tactile output component can be a haptic generation component that enables computer system 100 to convey information to a user in contact with (e.g., holding, touching, and/or nearby) computer system 100. In some embodiments, I/O device 140 includes one or more components for outputting visual outputs (e.g., video, image, animation, 3D rendering, augmented reality overlay, motion graphics, data visualization, digital art, etc.). For example, displaying content from one or more applications and/or system applications, and/or displaying a widget (e.g., a control that displays real-time information and/or data) corresponding to one or more applications.

In some embodiments, I/O device 140 includes one or more components for outputting audio (e.g., smart speakers, home theater system, soundbars, headphones, earphones, earbuds, speakers, television speakers, augmented reality headset speakers, audio jacks, optical audio output, Bluetooth audio outputs, HDMI audio outputs, audio sensors, etc.). In some embodiments, computer system 100 is able to output audio through the one or more speakers. For example, computer system 100 outputting audio-based content and/or information to a user. In some embodiments, the one or more speakers enable spatial audio (e.g., an audio output corresponding to an environment (e.g., computer system 100 detecting materials and/or objects within the environment and/or computer system 100 altering the audio pattern, intensity, and/or waveform to compensate for varying characteristics of an environment)).

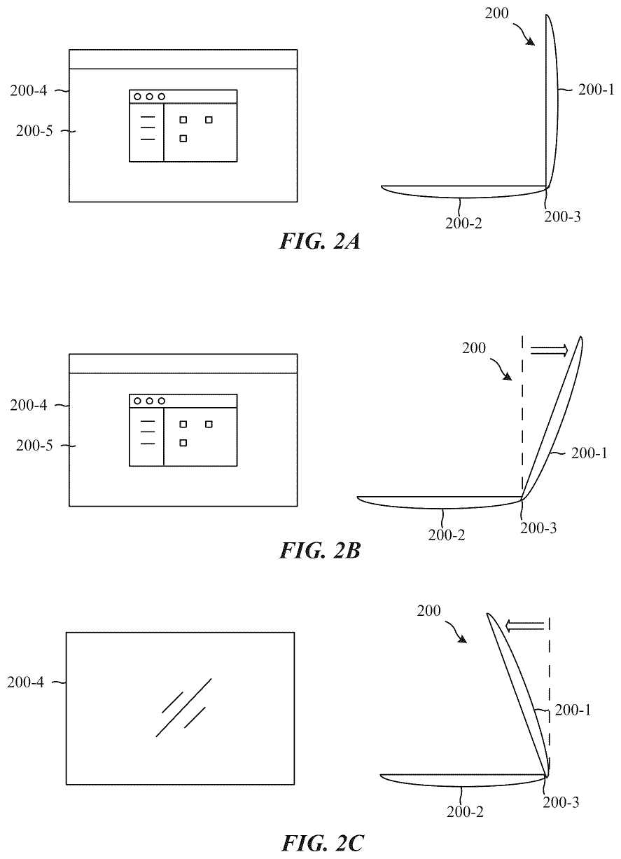

FIGS. 2-5 illustrate exemplary components and user interfaces of device 200 in accordance with some embodiments. Device 200 (sometimes referred to herein as device 200) can include one or more features of computer system 100. In the examples described with respect to FIGS. 2-5, device 200 is a laptop computer. In some embodiments, device 200 is not limited to being a laptop computer and one of ordinary skill in the art should recognize that device 200 can be one or more other devices (e.g., as described herein and/or that include one or more of the components and/or functions described herein with respect to device 200). For example, device 200 can be a communal device (such as a smart display, a smart speaker, and/or a television) and/or a personal device (such as a smart phone, a smart watch, a tablet, a desktop computer, a fitness tracking device, and/or a head mounted display device). In some embodiments, a communal device is configured to provide functionality to multiple users (e.g., at the same time and/or at different times). In such embodiments, the communal device can be administered and/or set up by a single user. In some embodiments, a personal device is configured to provide functionality to a single user (e.g., at a time, such as when the single user is logged into the personal device).

FIGS. 2A-2C illustrate device 200 in three different physical positions. As illustrated in FIG. 2A, device 200 is a laptop computer (also referred to herein as a “laptop”) that includes base portion 200-2 (e.g., that rests on a surface, such as a desk, horizontally as shown in FIG. 2A) and display portion 200-1 that is connected to base portion 200-2 at connection 200-3 (e.g., one or more connection points, a motorized arm, a hinge, and/or a joint) that enables display portion 200-1 to pivot and/or change orientation with respect to base portion 200-2. For example, device 200 can pivot at connection 200-3 to rotate display portion 200-1 and/or device 200 to one or more positions corresponding to an “OFF” internal state (e.g., as further described below in relation to FIG. 2C). In some embodiments, a position corresponding to an “OFF” internal state is a position in which device 200 is in a predetermined pose. For example, a predetermined pose can include display portion 200-1 positioned parallel to base portion 200-2 or display portion 200-1 forming a predetermined angle (e.g., 60-degree angle) with respect to base portion 200-2. In some embodiments, in the “OFF” internal state, an area in which content is displayed by device 200 is positioned in a manner that corresponds to (e.g., represents, is associated with, and/or is configured to accompany) the “OFF” internal state (e.g., facing down, not visible, and/or obscuring the area in which content is displayed). In some embodiments, in the “OFF” internal state, an area in which content is displayed by device 200 is not positioned in a manner that corresponds to (e.g., represents, is associated with, and/or is configured to accompany) the “OFF” internal state (e.g., instead is positioned in a manner that corresponds to an “ON” internal state). For example, when not in the “OFF” internal state, device 200 can be positioned within a range of different open positions (e.g., in which display portion 200-1 is not parallel to base portion 200-2 and the area in which content is displayed by device 200 is visible and/or not obscured). It should be recognized that display portion 200-1 being parallel to base portion 200-2 is an example of a position corresponding to an “OFF” internal state (e.g., a closed position) of device 200. In some embodiments, another configuration could set another orientation of display portion 200-1 with respect to base portion 200-2 as the closed position of device 200, such as illustrated in FIG. 2C.

FIG. 2A illustrates display screen 200-4 (representing the area in which content is displayed by device 200) on the left and device 200 in a corresponding pose on the right. As illustrated in FIG. 2A, device 200 is in a first position (e.g., display portion 200-1 is perpendicular to base portion 200-2 forming a 90-degree angle). In FIG. 2A, display screen 200-4 represents what is currently being displayed (e.g., via a display component) by device 200 while open in the first position. In FIG. 2A, display screen 200-4 illustrates an internal state in which device 200 is “ON” (e.g., operational, powered on, awake, a higher powered and/or more resource intensive state than the “OFF” state, and/or activated). In some embodiments, device 200 displays (e.g., via display screen 200-4) one or more user interfaces (e.g., user interface objects, windows, application user interfaces, system user interfaces, controls, and/or other visual content). In some embodiments, device 200 displays (e.g., via display screen 200-4) the one or more user interfaces while in the “ON” internal state. For example, in FIG. 2A, device 200 is in the “ON” internal state and display screen 200-4 displays a desktop user interface 200-5 that includes an application window. In some embodiments, a user interface includes (and/or is) one or more user interface objects (e.g., windows, icons, and/or other graphical objects). For example, a user interface (e.g., 200-5) can include one or more graphical objects different than, and/or the same as, an application window.

FIG. 2B illustrates display screen 200-4 on the left and device 200 in a corresponding pose on the right. As illustrated in FIG. 2B, device 200 is in a second position (e.g., display portion 200-1 is angled (e.g., via connection 200-3) with respect to base portion 200-2 forming at a 120-degree angle (e.g., a larger angle than in FIG. 2A)). In FIG. 2B, display screen 200-4 represents what is being displayed by device 200 while in the second position. Display screen 200-4 illustrates an internal state in which device 200 is “ON” (e.g., the same internal state as the top diagram of FIG. 2A). In FIG. 2B, device 200 displays (e.g., via display screen 200-4) desktop user interface 200-5 (e.g., and is the same as displayed in FIG. 2A). In some embodiments, device 200 displays a different user interface (e.g., other than desktop user interface 200-5). For example, although FIG. 2B illustrates device 200 displaying the same desktop user interface 200-5 as in FIG. 2A while in a different position than in FIG. 2A, device 200 can display a different user interface. In some embodiments, device 200 displays a user interface that corresponds to (e.g., is based on, due to, caused by, related to, and/or configured to accompany) a physical state (e.g., position, location, and/or orientation), including content that is specific to a particular angle or specific to a current context.

FIG. 2C illustrates display screen 200-4 on the left and device 200 in a corresponding pose on the right. As illustrated in FIG. 2C, device 200 is in a third position (e.g., display portion 200-1 is angled (e.g., via connection 200-3) with respect to base portion 200-2 forming at a 60-degree angle (e.g., a smaller angle than in FIG. 2A and FIG. 2B)). In FIG. 2C, display screen 200-4 represents what is being displayed by device 200 while in the third position. In FIG. 2C, display screen 200-4 illustrates an internal state in which device 200 is “OFF” (e.g., not operational, not powered on, not awake, not activated, powered off, asleep, hibernating, inactive, and/or deactivated). In some embodiments, device 200 does not display (e.g., via display screen 200-4) (e.g., forgoes displaying) the one or more user interfaces while in the “OFF” internal state (e.g., does not display any visual content). In some embodiments, device 200 displays (e.g., via display screen 200-4) one or more user interfaces while in the “OFF” internal state (e.g., the same and/or different from one or more user interfaces displayed while in the “ON” internal state) (e.g., a user interface specific to the “OFF” state and/or a manner of displaying a user interface that is not specific to the “OFF” internal state). In FIG. 2C, display screen 200-4 is blank because nothing is being displayed on the display of device 200 (e.g., display screen 200-4 is off and/or not displaying a user interface) (e.g., desktop user interface 200-5 is not displayed on display screen 200-4).

In some embodiments, device 200 includes one or more components (also referred to herein as “movement components”) that enable device 200 to perform (e.g., cause and/or control) movement (and/or be moved). For example, performing movement can include moving a portion of device 200 (e.g., less than or all components of the device move), moving all of device 200 (e.g., the entire device (including all of its components) moves, such as by changing location), and/or moving one or more other devices and/or components (e.g., that are in communication with device 200 and/or movement components of device 200). For example, device 200 can automatically move (e.g., pivot), cause, and/or control movement of display portion 200-1 relative to base portion 200-2, such as to any of the positions illustrated in FIGS. 2A-2C. In some embodiments, device 200 performs movement based on an internal state of device 200. Performing movement based on an internal state can enable new (e.g., otherwise unavailable) interactions by device 200. For example, such new interactions of device 200 can be configured using special features, functions, modes, and/or programs that take advantage of the ability of device 200 to perform movement. Examples of such interaction include using movement to communicate (e.g., to a user) an internal state (e.g., on, off, sleeping, and/or hibernating) of the device, to assist with user input (e.g., reduce distance to a user), and/or to augment interaction behavior of the device (e.g., moving in particular ways, during an interaction with a user, that convey information such as importance and/or direction of attention). In some embodiments, the movement performed corresponds to (e.g., is caused by, is in response to, and/or is determined and/or performed based on) one or more of: detected input, detected context (e.g., environmental context and/or user context), and/or an internal state of device 200 (e.g., an internal state and/or a set of multiple internal states). For example, device 200 can perform a movement of the display portion such that device 200 moves from being in the first position illustrated in FIG. 2A to being in the second position illustrated in FIG. 2B. In this example, device 200 can detect that a user has repositioned with respect to device 200 (e.g., the user stood up), and in response, device 200 can perform the movement to the second position so that the display is at an optimized viewing angle based on the repositioned height and/or angle of the user's eyes with respect to the display of device 200. As another example, device 200 can perform a movement such that device 200 moves from being in the first position illustrated in FIG. 2A to being in the third position illustrated in FIG. 2C. In this example, device 200 can perform the movement to the third position in response to detecting an internal state with reduced activity (e.g., the “OFF” internal state as described above). In this way, the movement of device 200 to one or more positions can indicate an internal state of device 200.

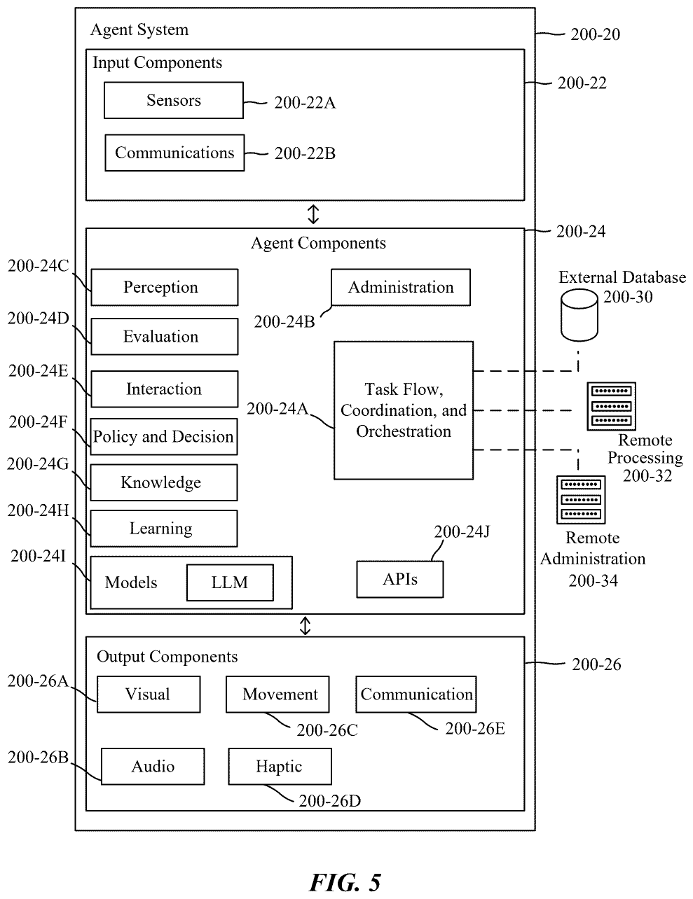

FIGS. 2A-2C illustrate device 200 having a display portion that is able to move with one degree of freedom via connection 200-3 (e.g., a hinge) connecting display portion 200-1 to base portion 200-2. In some embodiments, device 200 includes one or more components that have one or more degrees of freedom. For example, a movement component (e.g., an output component that causes and/or allows movement) (e.g., 200-26C of FIG. 5) of device 200 can include multiple degrees of freedom (e.g., six degrees of freedom including three components of translation and three components of rotation). For example, device 200 can be implemented to be able to move the display portion in a telescoping forward or backward motion (e.g., display portion 200-1 moves forward while base portion 200-2 remains stationary in space relative to the base portion (e.g., to reduce and/or extend viewing distance for a user)). As yet another example, device 200 can be implemented to be able to move the display portion to rotate about an axis that is perpendicular to the hinge such that the display portion can turn to position the display to follow a user as they walk around device 200. While the examples shown in FIGS. 2A-2C illustrate a hinge, other movement components can be included in device 200, such as an actuator (e.g., a pneumatic actuator, hydraulic actuator and/or an electric actuator), a movable base, a rotatable component, and/or a rotatable base. In some embodiments, one or more movement components can cause device 200 to move in different ways, such as to rotate (e.g., 0-360 degrees), to move laterally (e.g., right, left, down, up, and/or any combination thereof), and/or to tilt (e.g., 0-360 degrees).

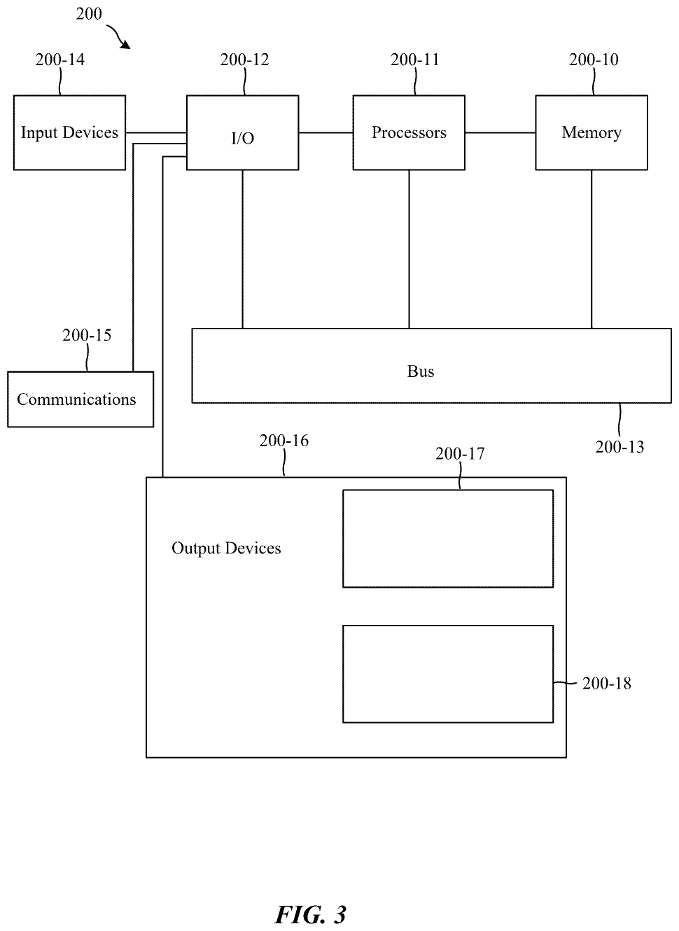

FIG. 3 illustrates exemplary block diagram of device 200. In some embodiments, device 200 includes some or all of the components described with respect to FIGS. 1A, 1, 3, and 5B. As illustrated in FIG. 3, device 200 has bus 200-13 that operatively couples I/O section 200-12 (also referred to as an I/O subsection and/or an I/O interface) with processors 200-11 and memory 200-10. As illustrated in FIG. 3, I/O section 200-12 is connected to output devices 200-16 (also referred to herein as “output components”). In some embodiments, output devices 200-16 include one or more visual output devices (e.g., a display component, such as a display, a display screen, a projector, and/or a touch-sensitive display), one or more haptic output devices (e.g., a device that causes vibration and/or other tactile output), one or more audio output devices (e.g., a speaker), and/or one or more movement components (e.g., an actuator, a motor, a mechanical linkage, devices that cause and/or allow movement, and/or one or more movement components as described above). As illustrated in FIG. 3, output devices 200-16 include two exemplary movement components (e.g., movement controller 200-17 and actuator 200-18). Actuator 200-18 can be any component that performs physical movement (e.g., of a portion and/or of the entirety) of a device (e.g., device 200 and/or a device coupled to and/or in contact with device 200). Movement controller 200-17 can be any component (e.g., a control device) that controls (e.g., provides control signals to) actuator 200-18. For example, movement controller 200-17 can provide control signals that cause actuator 200-18 to actuate (e.g., cause physical movement). In some embodiments, movement controller 200-17 includes one or more logic component (e.g., a processor), one or more feedback component (e.g., sensor), and/or one or more control components (e.g., for applying control signals, such as a relay, a switch, and/or a control line). In some embodiments, movement controller 200-17 and actuator 200-18 are embodied in the same device and/or component as each other (e.g., a dedicated onboard movement controller 200-17 that is affixed to actuator 200-18). In some embodiments, movement controller 200-17 and actuator 200-18 are embodied in different devices and/or components from each other (e.g., one or more processors 200-11 can function as the movement controller 200-17 of actuator 200-18). In some embodiments, movement controller 200-17 and/or actuator 200-18 are embodied in a device (or one or more devices) other than device 200 (e.g., device 200 is coupled to (e.g., temporarily and/or removably) another device and can instruct movement controller 200-17 and/or control actuator 200-18 of the other device). Actuator 200-18 can function to cause one or more types of mechanical movement (e.g., linear and/or rotational) in one or more manners (e.g., using electric, magnetic, hydraulic, and/or pneumatic power). Examples of actuator 200-18 can include electromechanical actuators, linear actuators, and/or rotary actuators.

As illustrated in FIG. 3, I/O section 200-12 is connected to input devices 200-14. In some embodiments, input devices 200-14 include one or more visual input devices (e.g., a camera and/or a light sensor), one or more physical input devices (e.g., a button, a slider, a switch, a touch-sensitive surface, and/or a rotatable input mechanism), one or more audio input devices (e.g., a microphone), and/or other input devices (e.g., accelerometer, a pressure sensor (e.g., contact intensity sensor), a ranging sensor, a temperature sensor, a GPS sensor, an accelerometer, a directional sensor (e.g., compass), a gyroscope, a motion sensor, and/or a biometric sensor). In addition, I/O section 200-12 can be connected with communication unit 200-15 for receiving application and operating system data, using Wi-Fi, Bluetooth, near field communication (NFC), cellular, and/or other wireless (and/or wired) communication techniques.

Memory 200-10 of device 200 can include one or more non-transitory computer-readable storage mediums, for storing computer-executable instructions, which, when executed by one or more computer processors 200-11, for example, cause the computer processors to perform the techniques described below, including processes 700, 900, 1000, 1100, 1200, 1300, 1500, and 1600 (FIGS. 7, 9, 10, 11, 12, 13, 15, and 16). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, and Blu-ray technologies, as well as persistent solid-state memory such as flash and solid-state drives. Device 200 is not limited to the components and configuration of FIG. 3 but can include other and/or additional components in a multitude of possible configurations, all of which are intended to be within the scope of this disclosure.

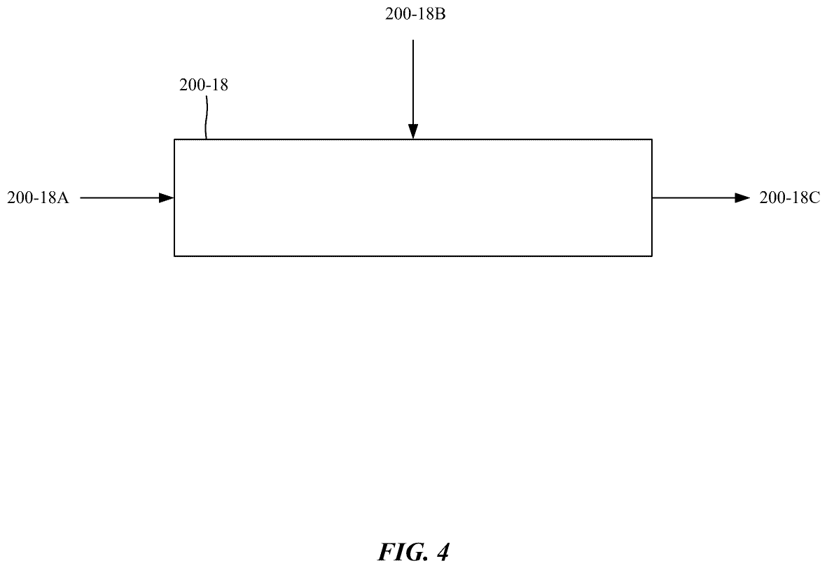

FIG. 4 illustrates a functional diagram of actuator 200-18B in accordance with some embodiments. As described above, actuator 200-18B can be any component that performs physical movement. In some embodiments, actuator 200-18B operates using input that includes control signal 200-18A and/or energy source 200-18B. For example, actuator 200-18 can be a rotary actuator that converts electric energy into rotational movement. This rotational movement can cause the movement of the display portion of device 200 described above with respect to FIGS. 2A-2C (e.g., a counterclockwise rotational movement of the actuator causes device 200 to move to a position having a larger angle (e.g., the second position illustrated in FIG. 2B) and a clockwise (e.g., opposite) rotational movement of the actuator causes device 200 to move to a position having a smaller angle (e.g., the third position illustrated in FIG. 2C)). Control signal 200-18A can indicate one or more start and/or stop instructions, a movement and/or actuation direction, a movement and/or actuation speed, an amount of time to move and/or actuate, a goal position (e.g., pose and/or location) for movement and/or actuation, and/or one or more other characteristics of movement and/or actuation. In some embodiments, the control signal and the energy source are the same signal and/or input. In some embodiments, one or more additional components (e.g., mechanical and/or electric) are coupled (e.g., removably or permanently) to actuator 200-18B for affecting movement and/or actuation (e.g., mechanical linkage such as a lead screw, gears, and/or other component for changing (e.g., converting) a characteristic of movement and/or actuation). In some embodiments, actuator 200-18B includes one or more feedback components (e.g., position sensor, encoder, overcurrent sensor, and/or force sensor) that form part of a feedback loop for modifying and/or ceasing movement and/or actuation (e.g., slowing actuation as a goal position is reached and/or ceasing actuation if physical resistance to actuation is detected via a sensor). In some embodiments, the one or more feedback components are included (e.g., partially and/or wholly) in a movement controller (e.g., movement controller 200-13) operatively coupled to the actuator.

Attention is now turned to functionality (e.g., features and/or capabilities) of one or more devices (e.g., computer system 100 and/or device 200). One such functionality is implementing an “agent,” which can alternatively be referred to as a software agent, an intelligent agent, an interactive agent, a virtual assistant, an intelligent virtual assistant, an interactive virtual assistant, a personal assistant, an intelligent personal assistant, an interactive personal assistant, an intelligent interactive personal assistant, and/or an artificial intelligence (AI) assistant. In some embodiments, an agent refers to a set of one or more functions implemented in hardware and/or software (e.g., locally and/or remotely) on an agent system (e.g., a single device and/or multiple devices). In some embodiments, an agent performs operations to perceive an environment, acquire knowledge, retrieve knowledge, learn skills, interact with users, and/or perform tasks. The agent can, for example, perform these (and/or other) operations in response to user input and/or automatically (e.g., at an appropriate time determined based on a perceived context). A non-exhaustive list of exemplary operations that an agent can be used for and/or with includes: tracking a user's eyes, face, and/or body (e.g., to move with the user and/or identify an intent and/or activity of the user); detecting, recognizing, and/or classifying a user in the environment; detecting and/or responding to input (e.g., verbal input, air gestures, and/or physical input, such as touch input and/or force inputs to physical hardware components (e.g., button, knobs, and/or sliders)); detecting context (e.g., user context, operating context, and/or environmental context); moving (e.g., changing pose, position, orientation, and/or location); performing one or more operations in response to input, context, and/or stimulus (e.g., an object or event (e.g., external and/or internal to a device) that causes one or more responsive operations by a device); providing intelligent interaction capabilities (e.g., due to in part to one or more machine learning (“ML”) models such as a large language model (“LLM”)) for responding and/or causing operations to be performed; and/or performing tasks (e.g., a set of operations for achieving a particular goal) (e.g., automatically and/or intelligently). In some embodiments, an agent performs operations in response to non-contact inputs (e.g., air gestures and/or natural language commands). The preceding list is meant to be illustrative of operations that can be performed using an agent but is not meant to be an exhaustive list. Other operations fall within the intended scope of the capabilities of an agent. Additionally, for the purposes of this disclosure, an agent does not need to include all of the functionality mentioned herein but can include less functionality or more functionality (e.g., an agent can be implemented on an agent system that does not have movement functionality but that otherwise includes an intelligent personal assistant that can interact with a user).

In some embodiments, a user is (e.g., represents, includes, and/or is included in) one or more of a user, person, object, and/or animal in an environment (e.g., a physical and/or virtual environment) (e.g., of the device). In some embodiments, a user is (e.g., represents, includes, and/or is included in) an entity that is perceived (e.g., detected by the device, one or more other devices, and/or one or more components thereof). In some embodiments, an entity is something that is distinguished from surrounding entities (e.g., pieces of environments and/or other users) and/or that is considered as a discrete logical construct via one or more components (e.g., perception components and/or other components). In some embodiments, a user is physical and/or virtual. For example, a physical user can represent a user standing in front of, and being perceived by, the device. As another example, a virtual user can represent an avatar in a virtual scene perceived by the device (e.g., the avatar is detected in a media stream received by the device and/or captured by a camera of the device). Although presented above as examples of a “user,” the terms and/or concepts referred to as “user,” “person,” “object,” and/or “animal” can be interchanged with “user” throughout this disclosure, unless explicitly indicated otherwise. For example, use the term “user” can likewise be understood to also refer to “user,” unless explicitly indicated otherwise.

As an example, and referring back to FIGS. 2A-2C, an agent implemented at least partially on device 200 can perform operations that cause display portion 200-1 of device 200 to move with respect to base portion 200-2. For example, the agent detects (e.g., perceives and determines the occurrence of) a context that includes the user standing up (e.g., based on facial detection and tracking); and, in response, the agent causes device 200 to open and/or device 200 opens display portion 200-1 to the larger angle. As another example, the agent can detect verbal input that corresponds to (e.g., is interpreted as and/or that refers to an operation that includes) a request to move the display (e.g., “Please move my display,” or “Please enter sleep mode.”); and, in response, the agent causes device 200 to move and/or device 200 moves display portion 200-1.

FIG. 5 illustrates a functional diagram of an exemplary agent system 200-20A. As illustrated in FIG. 5, agent system 200-20A has a dotted box boundary that encloses input components 200-22, agent components 200-24, and output components 200-26. In some embodiments, agent system 200-20A includes fewer, more, and/or different components than illustrated in FIG. 5. In some embodiments, agent system 200-20 is implemented on a single device (e.g., computer system 100 and/or device 200). In some embodiments, agent system 200-20 is implemented on multiple devices. In some embodiments, one or more components of agent system 200-20 illustrated in and/or described with respect to FIG. 5 are external to but operatively coupled to agent system 200-20 (e.g., an accessory, an external device, an external sensor, an external actuator, an external display component, an external speaker, and/or an external database). In some embodiments, one or more components of agent system 200-20 are local to one or more other components of agent system 200-20. In some embodiments, one or more components of agent system 200-20 are remote from one or more other components of agent system 200-20.

In some embodiments, input components 200-22 includes components for performing sensing and/or communications functions of agent system 200-20. As illustrated in FIG. 5, input components 200-22 includes one or more sensors 200-22A. One or more sensors 200-22A can include any component that functions to detect data corresponding to a physical environment. Examples of one or more sensors 200-22A can include: a camera, a light sensor, a microphone, an accelerometer, a position sensor, a pressure sensor, a temperature sensor, olfactory sensor, and/or a contact sensor. This list is not intended to be exhaustive, and one or more sensors 200-22A can include other sensors not explicitly identified herein that detect, generate, and/or otherwise provide data that can be used (e.g., processed, stored, and/or transformed) for detecting data corresponding to a physical environment. As illustrated in FIG. 5, input components 200-22 includes one or more communications components 200-22B. One or more communications components 200-22B can include any component that functions to send and/or receive communications (e.g., an antenna, a modem, a network interface component, an encoder, a decoder, and/or a communication protocol stack) internal and/or external to agent system 200-20. Communications components 200-22B can be between different devices and/or between components of the same device. The communications can include control signals and/or data (e.g., messages, instructions, files, application data, and/or media streams). In some embodiments, input components 200-22 includes fewer, more, and/or different components than those illustrated in FIG. 5. In some embodiments, input components 200-22 is implemented in hardware and/or software.

In some embodiments, agent components 200-24 includes components that manage and/or carry out functions of an agent of agent system 200-20. As illustrated in FIG. 5, agent components 200-24 includes the following functional components: task flow, coordination, and/or orchestration component 200-24A, administration component 200-24B, perception component 200-24C, evaluation component 200-24D, interaction component 200-24E, policy and decision component 200-24F, knowledge component 200-24G, learning component 200-24H, models component 200-24I, and APIs component 200-24J. Each of these components is described briefly below. Notably, this list of agent components 200-24 is not intended to be exhaustive, and agent components 200-24 can include other functional components not explicitly identified herein that can be used (e.g., processed, stored, and/or transformed) for performing any function of an agent, such as those described herein. In some embodiments, agent components 200-24 includes fewer, more, and/or different components than those illustrated in FIG. 5. In some embodiments, agent components 200-24 is implemented in hardware and/or software.

In some embodiments, task flow, coordination, and/or orchestration component 200-24A performs operations that enable an agent to handle coordination between various components. For example, operations can include handling a data processing task flow to move from perception component 200-24C (e.g., that detects speech input) to models component 200-24I (e.g., for processing the detected speech input using a large language model to determine content and/or intent of the speech input). In some embodiments, task flow, coordination, and/or orchestration component 200-24A performs operations that enable an agent to handle coordination between one or more external components (e.g., resources). For example, FIG. 5 illustrates examples of external components, such as external database 200-30. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, administration component 200-24B performs operations that enable an agent system to handle administrative tasks like managing system and/or component updates, managing user accounts, managing system settings, and/or managing component settings. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, perception component 200-24C performs operations that enable an agent to perceive environmental input. For example, operations can include detecting that a context and/or environmental condition has occurred, detecting the presence of a user (e.g., user, person, object, and/or animal in an environment), detecting an input that includes speech, detecting an input that includes an air gesture, detecting facial expressions, detecting characteristics (e.g., visible and/or non-visible) of a user, and/or detecting verbal and/or physical cues. In some embodiments, perception component 200-24C includes functionality performed by an operating system of a device implementing agent system 200-20. In some embodiments, perception component 200-24C includes functionality performed by one or more applications of a device implementing agent system 200-20.

In some embodiments, evaluation component 200-24D performs operations that enable an agent to process evaluate data (e.g., to determine a context such as a user context, an environmental context, and/or an operating context). For example, operations can include evaluating data gathered from perception component 200-24C, knowledge component 200-24G, external database 200-30, and/or remote processing resource 200-32. In some embodiments, evaluation component 200-24D includes functionality performed by an operating system of a device implementing agent system 200-20. In some embodiments, evaluation component 200-24D includes functionality performed by one or more applications of a device implementing agent system 200-20.

Reference is made herein to environmental context (also referred to herein as a “context of an environment” and/or “a context corresponding to an environment”). In some embodiments, an environmental context is a context based on one or more characteristics of the environment (e.g., users, locations, time, weather, and/or lighting). For example, an environmental context can include that it is raining outside, that it is daytime, and/or that a device is currently located in a park. In some embodiments, a device (e.g., using an agent) determines an environmental context (e.g., to be currently true, occurring, and/or applicable) using one or more of detecting input (e.g., via one or more input components) and/or receiving data (e.g., from one or more other devices and/or components in communication with the device).

Reference is made herein to user context (also referred to herein as a “context of a user” and/or “a context corresponding to a user”) (and/or a user context). In some embodiments, a user context is a context based on one or more characteristics of the user (and/or a user). For example, a user context can include the user's appearance and/or clothing, personality, actions, behavior, movement, location, and/or pose. In some embodiments, a device (e.g., using an agent) determines a user context (e.g., to be currently true, occurring, and/or applicable) using one or more of detecting input (e.g., via one or more input components) and/or receiving data (e.g., from one or more other devices and/or components in communication with the device). In some embodiments, a device determines user context based on historical context and/or learned characteristics of the user, where one or more characteristics of the user are learned and/or stored over a period of time by the device.

Reference is made herein to operational context (also referred to herein as a “context of operation” and/or an “operating context”). In some embodiments, an operational context is a context based on one or more characteristics of the operation of a device (e.g., the device determining and/or accessing the operational context and/or one or more other devices). For example, an operational context can include the internal state of the device (and/or of one or more components of the device), an internal dialogue of the device (e.g., the device's understanding of a context), operations being performed by the device, applications and/processes that are executing (e.g., running and/or open) on the device. In some embodiments, a device (e.g., using an agent) determines an operational context (e.g., to be currently true, occurring, and/or applicable) using one or more of detecting input (e.g., via one or more input components) and/or receiving data (e.g., from one or more other devices and/or components in communication with the device). In some embodiments, a device (e.g., using an agent) determines an operational context (e.g., to be currently true, occurring, and/or applicable) using one or more internal states (e.g., accessed, retrieved, and/or queried by a process of the device).

In some embodiments, interaction component 200-24E performs operations that enable an agent to manage and/or perform interactions with users. For example, operations can include determining an appropriate interaction model for a particular context and/or in response to a particular input. In some embodiments, interaction component 200-24E includes functionality performed by an operating system of a device implementing agent system 200-20. In some embodiments, interaction component 200-24E includes functionality performed by one or more applications of a device implementing agent system 200-20.

In some embodiments, policy and decision component 200-24F performs operations that enable an agent to take actions in view of available data. For example, operations can include determining which operations to perform and/or which functional components to utilize in response to a detected context. In some embodiments, policy and decision component 200-24F includes functionality performed by an operating system of a device implementing agent system 200-20. In some embodiments, policy and decision component 200-24F includes functionality performed by one or more applications of a device implementing agent system 200-20.

In some embodiments, knowledge component 200-24G performs operations that enable an agent to access and use stored knowledge. For example, operations can include indexing, storing, and/or retrieving data from a data store, a database, and/or other resource. In some embodiments, knowledge component 200-24G includes functionality performed by an operating system of a device implementing agent system 200-20. In some embodiments, knowledge component 200-24G includes functionality performed by one or more applications of a device implementing agent system 200-20.

In some embodiments, learning component 200-24H performs operations that enable an agent to learn through experiences. For example, operations can include observing and/or keeping track of data that includes preferences, routines, user characteristics, and/or environmental characteristics in a manner in which such data can be used to inform future operation by the agent and/or a component thereof (e.g., such as when performing tasks and/or interactions with users). In some embodiments, learning component 200-24H includes functionality performed by an operating system of a device implementing agent system 200-20. In some embodiments, learning component 200-24H includes functionality performed by one or more applications of a device implementing agent system 200-20.

In some embodiments, models component 200-24I performs operations that enable an agent to apply ML models (e.g., such as a large language model (LLM)) to process data. For example, operations can include storing ML models, executing ML models, training and/or re-training ML models, and/or otherwise managing aspects of implementing ML models. In some embodiments, models component 200-24I includes functionality performed by an operating system of a device implementing agent system 200-20. In some embodiments, models component 200-24I includes functionality performed by one or more applications of a device implementing agent system 200-20.

In some embodiments, agent system 200-20 responds to natural language input. For example, agent system 200-20 responds to a natural language input that is in the form of a statement, a question, a command, and/or a request. In some embodiments, agent system 200-20 outputs text and/or speech output that is provided in a natural language or mimicking a natural language style. For example, agent system 200-20 can process the natural language question “How hot is it outside?” with a speech response that indicates the current temperature outside at the user's location (e.g., “It is 18 degrees outside.”). In some embodiments, agent system 200-20 responds to natural language input by providing information (e.g., weather, travel, and/or calendar information) and/or performing a task (e.g., opening a document, searching a database, and/or opening an application).

In some embodiments, agent system 200-20 includes and/or relies on one or more data models to process input (e.g., natural language input, gesture input, visual input, and/or other data input) and/or provide output (e.g., output of information via natural language output, visual output, audio output, and/or textual output). Such data models can include and/or be trained using user data (e.g., based on particular interactions and/or data from the user being interacted with) and/or global data (e.g., general data based on interactions and/or data from many users). For example, user data (e.g., preferences, previous use of language and/or phrases, calendar entries, a contact list, and/or activity data) can be used to better infer user intent and/or provide responses that are more likely to address a user's request. In some embodiments, data models used by agent system 200-20 include, are used by, and/or are implemented using one or more machine learning components (e.g., hardware and/or software) (e.g., one or more neural networks). Such machine learning components can be used to process verbal input to determine words and/or phrases therein, one or more contexts that correspond to the words, a user intent corresponding to the words, one or more confidence scores, and/or a set of one or more actions to take in response to the verbal input. Analogous operations can be performed to process other types of inputs, such as visual input, data input, and/or textual input. Such data models can include machine learning and/or data processing models, including, but not limited to, natural language processing models, language models, speech recognition models, object recognition models, visual processing models, ontologies, task flow models, and/or intent recognition models (e.g., used to determine user intent).

In some embodiments, Application Programming Interfaces (APIs) component 200-24J performs operations that enable an agent to interface with services, devices, and/or components. For example, operations can include relaying data (e.g., requests, responses, and/or other messages) between data interfaces (e.g., between software programs, between a system process and application process, between system processes, between application processes, between communication protocols, between a client and a server, between file systems, and/or between components on different sides of a trust boundary). In some embodiments, the data interfaces served by APIs component 200-24J are local (e.g., to the device, such as two application processes exchanging data) and/or remote (e.g., from the device, such as interfacing with a web service via a remote server). In some embodiments, APIs component 200-24J includes functionality performed by an operating system of a device implementing agent system 200-20. In some embodiments, APIs component 200-24J includes functionality performed by one or more applications of a device implementing agent system 200-20.

In some embodiments, output components 200-26 includes components for performing output functions of agent system 200-20. The exemplary output components illustrated in FIG. 5 are described briefly below. In some embodiments, output components 200-26 include fewer components, more, and/or different components than those illustrated in FIG. 5. In some embodiments, input components are implemented in hardware and/or software.

As illustrated in FIG. 5, output components 200-26 includes one or more visual output components 200-26A. One or more visual output components 200-26A can include any component that functions to output (e.g., generate, create, and/or display), and/or cause output of, a visual output (e.g., an output that is visually perceptible, such as graphical user interface, playback of visual media content, and/or lighting). Examples of one or more visual output components 200-26A can include: a display component, a projector, a head mounted display (HMD), a light-emitting diode (“LED”), and/or a component that creates visually perceptible effects (e.g., movement). This list is not intended to be exhaustive, and one or more visual output components 200-26A can include other visual output components not explicitly identified herein that detect, generate, and/or otherwise provide data that can be used (e.g., processed, stored, and/or transformed) for outputting visual output.

As illustrated in FIG. 5, output components 200-26 include one or more audio output components 200-26B. One or more audio output components 200-26B can include any component that functions to output (e.g., generate and/or create), and/or cause output of, an audio output (e.g., an output that is audibly perceptible, such as a sound, music, speech, and/or audio media content). Examples of one or more audio output components 200-26B can include: a speaker, an audio amplifier, a tone generator, and/or a component that creates audibly perceptible effects (e.g., movement such as vibrations). This list is not intended to be exhaustive, and one or more audio output components 200-26B can include other audio output components not explicitly identified herein that detect, generate, and/or otherwise provide data that can be used (e.g., processed, stored, and/or transformed) for outputting audio output.

As illustrated in FIG. 5, output components 200-26 include one or more movement output components 200-26C (also referred to herein as a “movement component”). One or more movement output components 200-26C can include any component that functions to output (e.g., generate and/or create), and/or cause output of, a movement output (e.g., an output that includes physical movement of the device and/or another device/component). Examples of one or more movement output components 200-26C can include: a movement controller, an actuator, a mechanical linkage, an electromechanical device, and/or a component that creates physical movement. This list is not intended to be exhaustive, and one or more movement output components 200-26C can include other movement output components not explicitly identified herein that detect, generate, and/or otherwise provide data that can be used (e.g., processed, stored, and/or transformed) for outputting movement output. As illustrated in FIG. 5, output components 200-26 include one or more haptic output components 200-26D. One or more haptic output components 200-26D can include any component that functions to output (e.g., generate, create, and/or display), and/or cause output of, a haptic output (e.g., an output that is physically perceptible using tactile sensation, such as a vibration, pressure, texture, and/or shape). Examples of one or more haptic output components 200-26D can include: a speaker, a component that generates vibrations, a component that generates texture changes, a component that generates pressure changes, and/or a component that creates perceivable tactile effects. This list is not intended to be exhaustive, and one or more haptic output components 200-26D can include other haptic output components not explicitly identified herein that detect, generate, and/or otherwise provide data that can be used (e.g., processed, stored, and/or transformed) for outputting haptic output.

As illustrated in FIG. 5, output components 200-26 include one or more communications components 200-26E. One or more communications components 200-26E can include any component that functions to send and/or receive communications (e.g., an antenna, a modem, a network interface component, an encoder, a decoder, and/or a communication protocol stack) internal and/or external to agent system 200-20. In some embodiments, the communications can be between different devices and/or between components of the same device. In some embodiments, the communications can include control signals and/or data (e.g., messages, instructions, files, application data, and/or media streams). In some embodiments, one or more communications components 200-26E includes one or more features of one or more communications components 200-22B (e.g., as described above). In some embodiments, one or more communications components 200-26E are the same as one or more communications components 200-22B (e.g., one or more components that handle communication inputs and outputs and thus be considered as either and/or both an input component and an output component).

Throughout this disclosure, reference can be made to movement output (e.g., referred to in various forms such as: movement, device movement, output of movement, device motion, output of motion, and/or motion output). In some embodiments, outputting (e.g., causing output of) movement refers to movement of an electronic device (e.g., a portion or component thereof relative to another portion and/or of the whole electronic device). For example, referring back to FIG. 2B, movement output can refer to device 200 actuating movement component 200-3 to move display portion 200-1 to the position illustrated in FIG. 2B (e.g., from the position in FIG. 2A). In some embodiments, movement output is not (e.g., does not include and/or does not only include) haptic output (e.g., haptic movement output). In some embodiments, movement output is not (e.g., does not include and/or does not only include) vibration output. In some embodiments, movement output is not (e.g., does not include and/or does not only include) oscillating movement (e.g., movement of an actuator that merely causes vibration by moving a component repeatedly along a path that is internal to the device). In some embodiments, movement output includes (e.g., requires and/or results in) changing a location and/or pose of at least a portion of (and/or the entirety of) a component or the electronic device. In some embodiments, movement output includes output that moves at least a portion of (and/or the entirety of) a component or the electronic device from a first location and/or first pose to a second location and/or second pose. For example, with respect to FIGS. 2A-2C, display portion 200-1 is shown in a different location (e.g., in space) and pose (e.g., relative to base portion 200-2) in each of FIGS. 2A, 2B, and 2C. In some embodiments, movement output includes output that moves at least a portion (and/or the entirety of) a component or the electronic device to a third location and/or third pose (e.g., from the first location and/or first pose and/or from the second location and/or the second pose). In some embodiments, the third location and/or the third pose is the same as the first location and/or first pose and/or as the second location and/or the second pose. For example, movement output can include device 200 in FIG. 2A beginning from the first position illustrated in FIG. 2A, moving to the second position illustrated in FIG. 2B, and moving to return to the first position illustrated in FIG. 2A. For example, movement output can include device 200 in FIG. 2A beginning from the first position illustrated in FIG. 2A, moving to the second position illustrated in FIG. 2B, and continuing movement to come to rest at the third position illustrated in FIG. 2C.

Throughout this disclosure, an electronic device can be illustrated in (and/or described as being in) different locations and/or poses at different times. For example, in FIG. 2A illustrates device 200 in the first position, FIG. 2B illustrates device 200 in the second position, and FIG. 2A illustrates device 200 in the third position. In some embodiments, the electronic device moves itself between such locations and/or poses (e.g., using movement output). For example, device 200 moves from the first position to the second position under its own power (e.g., using a power source and one or more actuators to cause movement). In particular, any example herein that illustrates and/or describes an electronic device being at different locations and/or poses (e.g., at different times) should be understood to cover a scenario in which the device moved itself between such locations and/or poses (e.g., unless otherwise clearly indicated).

Throughout this disclosure, reference can be made to “performing output,” “causing output,” and/or “outputting” (e.g., by one or more output generation devices and/or by one or more output generation components) (and/or similar such phrases). In some embodiments, outputting (e.g., or the aforementioned variants) includes (and/or is) outputting movement (e.g., movement output as described above).

Throughout this disclosure, reference can be made to “displaying,” “causing display of,” and/or “outputting visual content” (e.g., by one or more display components) (and/or similar such phrases). In some embodiments, displaying (e.g., or the aforementioned variants) includes displaying visual content in connection with outputting movement (e.g., movement output as described above).

Throughout this disclosure, reference can be made to “outputting audio,” “causing output of audio,” and/or “providing audio output” (e.g., by one or more audio generation components and/or by one or more audio output devices) (and/or similar such phrases). In some embodiments, outputting audio (e.g., or the aforementioned variants) includes outputting audio content in connection with outputting movement (e.g., movement output as described above).

Throughout this disclosure, reference can be made to movement of an avatar (e.g., or other representation of a user, an agent and/or a character that is displayed) (e.g., by one or more display components) (and/or similar such phrases). In some embodiments, moving an avatar (e.g., or the aforementioned variants) includes displaying movement of visual content in connection with outputting movement (e.g., movement output as described above). For example, displaying an avatar nodding in agreement can include movement of the electronic device in a similar manner as the avatar movement (e.g., mimicking nodding). In some embodiments, moving an avatar (e.g., or the aforementioned variants) includes outputting movement (e.g., movement output as described above) without displaying movement of visual content. For example, a device can perform movement output that mimics nodding without moving a displayed avatar (e.g., the avatar does not move relative to the display). As illustrated in FIG. 5, agent system 200-20 can optionally interface with external components such as external database 200-30, remote processing component 200-32, and/or remote administration component 200-34. In some embodiments, external database 200-30 represents one or more functions that provide data storage resources accessible to agent system 200-20. In some embodiments, access to the data of external database 200-30 is provided directly to agent system 200-20 (e.g., the agent system manages the database) and/or indirectly to agent system 200-20 (e.g., a database is managed by a different system, but data stored therein can be provided and/or stored for use by agent system 200-20). In some embodiments, external database 200-30 is dedicated to (e.g., only for use by) agent system 200-20, is not dedicated to agent system 200-20 (e.g., is a database of a web service accessible to different agent systems), and/or is a combination of both dedicated and non-dedicated database resources. In some embodiments, remote processing component 200-32 represents one or more components that function as a data processing resource that is accessible to agent system 200-20. In some embodiments, access to remote processing component 200-32 is provided directly to agent system 200-20 (e.g., the agent system manages the processing resources) and/or indirectly to agent system 200-20 (e.g., a processing resource managed by a different system, but that can provide data processing for the benefit of agent system 200-20). In some embodiments, remote processing component 200-32 is dedicated to (e.g., only for use by) agent system 200-20, is not dedicated to agent system 200-20 (e.g., is a processing resource of a web service accessible to different agent systems), and/or is a combination of both dedicated and non-dedicated processing resources. Examples of data processing include processing image data (e.g., for feature extraction and/or object detection), processing audio data (e.g., for processing natural language speech input via a large language model), and/or training a machine learning algorithm and/or model. In some embodiments, remote administration component 200-34 represents functions that include and/or are related to administrative functions. For example, such administrative functions can include providing component updates to agent system 200-30 (e.g., software and/or firmware updates), managing accounts (e.g., permissions, access control, and/or preferences associated therewith), synchronizing between different agent systems and/or components thereof (e.g., such that an agent accessible via multiple devices of a user can provide a consistent user experience between such devices), managing cooperation with other services and/or agent systems, error reporting, managing backup resources to maintain agent system reliability and/or agent availability, and/or other functions required by agent system 200-20 to perform operations, such as those described herein.

The various components of agent system 200-20 described above with respect to FIG. 5 represent functional blocks that represent functionality. This functionality can be implemented on the same and/or different hardware (e.g., physical components) and/or by the same and/or different software. For example, the functional blocks can be implemented using one or more physical components, devices (e.g., computer system 100 and/or device 200), and/or software programs. In other words, each functional block does not necessarily represent a single, discrete physical component, device, and/or software program, but can be implemented using one or more of these. Further, agent system 200-20 can include multiple implementations of functionality represented by a respective functional block. For example, agent system 200-20 can include multiple different model components representing ML models that are used in different contexts, can include multiple different API components representing different APIs that are used for different services, and/or can include multiple different visual output components that are used for outputting different types of visual output.

Attention is now turned to discussion of concepts that can arise with respect to operation of an agent.

As discussed throughout, an agent can be capable of interacting with a user. In some embodiments, this capability includes the ability to process explicit requests, commands, and/or statements. In some embodiments, explicit requests, commands, and/or statements include and/or are interpreted as instructions directed to accomplishing a task (e.g., display X, complete task Y, and/or perform operation Z). In some embodiments, an agent includes the ability to process implicit requests, commands, and/or statements. In some embodiments, an implicit request, command, and/or statement does not include an explicit request, command, and/or statement. For example, “I like going to Europe,” can be interpreted as an implicit request, command, and/or statement which, in response to detecting, device 200 displays an itinerary in response to the statement. As another example, “This picture is for my grandmother,” can be interpreted as an implicit request, command, and/or statement which, in response to detecting, device 200 displays suggestions for modifying the picture). As another example, “I'm so tired,” can be interpreted as an implicit request, command, and/or statement which, in response to detecting, device 200 causes a sleep meditation application to begin a meditation session. As yet another example, “I miss my grandad” can be interpreted as an implicit request, command, and/or statement when, in response to detecting, device 200 can initiate a live communication session (e.g., telephone call, video call, and/or text messaging session) with grandad. In some embodiments, an implicit request is more likely to be processed according to one or more current environmental context, operational context, and/or user context, while an explicit request is less likely to be processed according to one or more current environmental context, operational context, and/or user context. For example, the phrase, “call my grandad,” can be an explicit request, and in response to detecting the request, device 200 will initiate a live communication session with grandad, irrespective of one or more current environmental context, operational context, and/or user context. However, the phrase, “I miss my grandad,” can be an implicit request, and in response to detecting the request, device 200 can display a list of gifts to buy for grandad if a user has been recently talking about buying gifts or could call grandad in another context that does not include the user recently discussing buying gifts. In some embodiments, a request can include one or more explicit requests and one or more implicit requests. In some embodiments, an implicit request is responded to independently from an explicit request; and in other embodiments, a response to an implicit request is dependent on an explicit request.

Reference can be made herein to a response by an agent that is output by a device. In some embodiments, a response includes an audio portion (e.g., audio output, audible output, sound, and/or speech) (also referred to herein as a “verbal response,” an “audio response,” and/or an “audible response) and/or a visual portion (e.g., display and/or movement of a representation and/or avatar). In some embodiments, a response includes a movement portion (e.g., movement of the device). In some embodiments, a response includes a haptic portion (e.g., touch and/or vibration).

Reference can be made herein to an internal dialogue, internal context, and/or an operational context, which can refer to a dynamic context or dynamic decision-making process of the device, an internal state of device 200, and/or internal data the device is partially basing its decision on. In some embodiments, an internal dialogue includes a set of one or more rules, characteristics, detections, and/or observations that the computer system uses to generate a response to one or more commands, questions, and/or statements). In some embodiments, the set of one or more rules, characteristics, detections, and/or observations are learned and/or generated via deep learning and/or one or more machine learning algorithms, and/or using one or more machine learning and/or system agents. In some embodiments, an internal dialogue is generated in real-time. In some embodiments, an internal dialogue is locally stored and/or stored via the cloud. In some embodiments, an internal dialogue can be modified, updated, and/or deleted. In some embodiments, an internal dialogue is generated based on other internal dialogues.

Reference can be made herein to personality and/or behavior (or a representation of personality/behavior) (e.g., of an agent, user, and/or character). In some embodiments, personality and/or behavior refers to a set of one or more characteristics that the device detects, has knowledge of, conforms to, applies, and/or tracks. In some embodiments, the personality or behavior is used as basis to perform operations. For example, an agent can detect a user's personality and respond in a manner based on the personality (e.g., output different responses in response to different user personalities). As another example, the agent can output a response having characteristics that correspond to one or more characteristics that correspond to the personality and/or behavior (e.g., output a response in different ways that depend on personality of the agent). In some embodiments, such characteristics represent and/or mimic personality of a user, such as how the user acts and/or speaks. In some embodiments, such characteristics approximate a user's personality.

In some embodiments, an agent is a system agent. In some embodiments, a system agent is an agent that corresponds to a process that originates from and/or is controlled by an operating system of the device (e.g., the device implementing the agent). In some embodiments, an agent is an application agent. In some embodiments, an application agent is an agent that corresponds to a process that originates from and/or is controlled by an application of (e.g., installed on and/or executed by) the device (e.g., the device implementing the agent).

Reference can be made herein to a representation (e.g., an avatar and/or avatar representation) of an agent (e.g., and/or of a user (e.g., user, person, object, and/or an animal) and/or a user interface object (e.g., an animated character)). In some embodiments, a representation of an agent refers to a set of output characteristics (e.g., visual and/or audio) of the agent (and/or the user and/or the user interface object). For example, a representation of an agent can include (and/or correspond to) a set of one or more visual characteristics (e.g., facial features of an animated face) and/or one or more audio characteristics (e.g., language and voice characteristics of audio output). In some embodiments, a representation (e.g., of an agent) is used to represent output by the agent. For example, a device implementing an interactive agent outputs audio in a voice of the agent and displays an animated face of the agent moving in a manner to simulate the agent speaking the audio output. In this way, a user can feel like they are having a normal conversation with the agent. In some embodiments, a representation of an agent is (or is not) inclusive of personality and/or behavior characteristics (e.g., as described above). For example, a representation of an agent can include (and/or correspond to) a set of visual characteristics (e.g., facial features of an animated face) and also a set of personality characteristics. In some embodiments, a representation of an agent includes a set of user characteristics that correspond to visual representation of a user (e.g., representations of a user's appearance, voice, and/or personality are used as an avatar that appears to move and/or speak). In some embodiments, a representation is a representation of a face (e.g., a user interface object that is output having features that simulate a face and/or facial expressions of a person (e.g., for conveying information to a viewer)).

In some embodiments, a character (e.g., of an agent and/or avatar) refers to a particular set of characteristics of a representation. For example, an avatar can take on (e.g., use, apply, interact with, and/or output according to) characteristics of a fictional and/or non-fictional character (e.g., from a movie, a show, a book, a series, and/or popular culture).

In some embodiments, a voice (e.g., of an agent and/or avatar) refers to a set of one or more characteristics corresponding to sound output that resembles (e.g., represents, mimics, and/or recreates) vocal utterance (e.g., attributable and/or simulated as being output by an agent and/or avatar). For example, device 200 can output a sentence that sounds different depending on a voice used. In some embodiments, a particular character and/or avatar can be configured to use a particular voice (e.g., have a corresponding voice). In some embodiments, the particular voice can mimic a user's voice.

In some embodiments, an appearance (e.g., of an agent and/or avatar) refers to a set of one or more characteristics corresponding to visual output that represents an avatar (and/or an agent). For example, device 200 can output an avatar that has a set of facial features forming an appearance that resembles a particular character from a movie.

In some embodiments, an expression of an avatar refers to a set of one or more characteristics corresponding to a particular visual appearance of a user, an avatar, and/or an agent. For example, device 200 can output an avatar that has a set of facial features arranged in a particular way to give the appearance of a facial expression (e.g., which can be used as a form of non-verbal communication to a user) (e.g., a frown is an expression of sadness, a smile is an expression of happiness, and/or wide open eyes is an expression of surprise). As another example, device 200 can output an avatar that has a set of body features (e.g., arms and/or legs) arranged in a particular way to give the appearance of a body expression (e.g., which can be used as a form of non-verbal communication to a user) (e.g., a hand gesture is an expression of approval, covering eyes is an expression of fear, and/or shrugging shoulders is an expression of lack of knowledge). In some embodiments, an expression includes movement (e.g., a head nod is an expression of agreement and/or disagreement) of the avatar. In some embodiments, device 200 can move, via the movement component, to indicate an expression with or without the avatar moving. In some embodiments, an agent performs one or more operations that depend on a user's expression (e.g., detects if a person is sad and responds with a kind statement or question). In some embodiments, expressions (e.g., whether and/or how they are used and/or how they are output) depends on personality. For example, a first personality can use a particular expression more than a second personality. As another example, an expression (e.g., frown, smile, and/or how wide eyes are opened) for the first personality can appear different from the expression (and/or a similar and/or equivalent expression) for a second personality (e.g., the first personality smiles in a manner that reveals teeth, but the second personality smiles without revealing teeth).

In some embodiments, an agent (e.g., an avatar of the agent and/or an agent system (e.g., hardware and/or software) implementing the agent) mimics characteristics of another user, agent, and/or character (e.g., in personality, behavior, expressions, and/or voice). In some embodiments, mimicking includes mirroring a user (e.g., copying use of a phrase and/or movement detected from a user interacting with the agent). In some embodiments, mimicking characteristics of a user includes attempting to reproduce the characteristics of the user (e.g., in the exact same manner and/or in manner that resembles the characteristics but is not an exact reproduction of the characteristics). For example, an agent mimicking voice and/or expressions does not require the agent have the exact same voice and/or expressions as the user being mimicked (e.g., but rather simply resembles the user's voice and/or expressions).

In some embodiments, a component and/or device uses (e.g., performs operations, makes decisions, and/or determines context based on) learned characteristics (e.g., characteristics of a context, user, and/or environment that the device has learned over time (e.g., via detection, prior experience, and/or feedback (e.g., from one or more users)). For example, characteristics learned over time can include a user's routine. In such example, if a particular user asks an agent for a summary of any new messages for the user at the same time every day, the agent can learn to perform operations automatically based on the learned characteristics of the routine (e.g., what data is needed, when the data is needed, and/or for which user). In some embodiments, use of learned characteristics enables an agent (and/or device) to improve understanding of (and/or responses to) a context, user, and/or environment, and/or to understand a context, user, and/or environment that otherwise was not (and/or would not be) understood (e.g., not responded to or responded to incorrectly). In some embodiments, learned characteristics are formed (e.g., by and/or for an agent) using reinforcement learning. In some embodiments, learned characteristics correspond to one or more levels of confidence, certainty, and/or reward (e.g., that are shaped by one or more reward functions). In some embodiments, learned characteristics (and/or how they are used to affect output of an agent and/or device) can change over time (e.g., levels confidence, certainty, and/or reward change over time). For example, output of a device before learning a set of learned characteristics can be different from output of the device after learning the set of learned characteristics. In some embodiments, a component and/or device uses learned knowledge. For example, similar to described above with respect to learned characteristics, learned knowledge can refer to information used to update (e.g., enhance, add to, and/or augment) a knowledge base of a device (e.g., for use by an agent implemented thereon). In some embodiments, multiple sets of learned characteristics for a user can be stored and/or used. In some embodiments, different sets of learned characteristics for different users can be stored and/or used.

Reference can be made herein to interaction with an agent (and/or a device). In some embodiments, an interaction refers to a set of one or more inputs and/or outputs of a device implementing the agent and one or more users. For example, an interaction can be an input by a user (e.g., “Please turn on the lights”) and a corresponding output (e.g., causing the lights to turn on and/or a response by the device of “Okay”). In some embodiments, interaction can include multiple inputs/outputs by one or more of the parties to the interaction (e.g., device and/or users). For example, an interaction can include a first input by a user (e.g., “Please turn on the lights”) and a corresponding first output (e.g., “Which lights?”), and also include a second input by the user (e.g., “Kitchen lights”) and a second output from the device (e.g., “Okay”). In some embodiments, which inputs and/or outputs are considered together as an interaction is based on a logical and/or contextual grouping (e.g., interactions within the previous thirty (30) seconds and/or interactions relating to turning on the lights). As one of skill will appreciate, an interaction can be considered in a manner that depends on the implementation (e.g., determining when an interaction is complete can involve determining if the user still present (e.g., speaking at all) and/or if the user still talking about the lights or has moved onto a different topic). In some embodiments, an interaction is a current interaction (e.g., ongoing, presently occurring, and/or active). In some embodiments, an interaction is a previous interaction. The examples above describe a device having a conversation with a user. In some embodiments, a conversation is between two or more users (e.g., users in an environment). For example, a device can detect a conversation between to users (e.g., the users are directing speech and responses to each other, rather than to the device).

In some embodiments an agent (and/or device) determines and/or performs an operation based on an intent corresponding to a user. For example, a device detects user input and outputs a response that depends on an intent of the user input. For example, a device detects user input that includes a pointing gesture detected together with verbal instruction to “turn on that light,” and in response, the device turns on the light that is determined to correspond to the intent of the input (e.g., the light toward which the pointing gesture directed). In some embodiments, intent is determined (e.g., by the device that detects input and/or by one or more other devices) using one or more of: one or more inputs, knowledge (e.g., learned knowledge about a user based on a history of observed behavior, personality, and interactions), learned characteristics, and/or context. In some embodiments, intent is determined from one or more types of input (e.g., verbal input, visual input via a camera, and/or contextual input).

Attention is now directed towards embodiments of user interfaces (“UI”) and associated processes that are implemented on an electronic device, such as computer system 100 and/or device 200.

FIGS. 6A-6F illustrate exemplary user interface for moving to capture content in accordance with some embodiments. The user interfaces in these figures are used to illustrate the processes described below, including the processes in FIG. 7.

FIGS. 6A-6F illustrate computer system 600 displaying different user interfaces. In some embodiments, computer system 600 is a tablet, smart phone, a smart watch, a laptop, a communal device, a smart speaker, an accessory, a personal gaming system, a desktop computer, a fitness tracking device, and/or a head-mounted display (HMD) device. In some embodiments, computer system 600 includes and/or is in communication with one or more sensors (e.g., one or more cameras, one or more LiDAR detectors, one or more motion sensors, one or more infrared sensors, and/or one or more microphones). In some embodiments, computer system 600 includes and/or is in communication with one or more output devices (e.g., a display screen, a projector, a touch-sensitive display, and/or a speaker). In some embodiments, computer system 600 includes and/or is in communication with one or more movement components (e.g., an actuator, a moveable base, a rotatable component, and/or a rotatable base). In some embodiments, computer system 600 includes one or more components and/or features described above in relation to devices 100 and/or 200.

FIGS. 6A-6C illustrate one or more scenarios where computer system 600 automatically moves to determine what comprises content in the environment in response to a request from a user. In particular, the content that computer system 600 looks for in the environment is work product. In some embodiments, work product is art, such as a drawing, a sculpture, statue, painting, and/or picture. In some embodiments, work product is physical work product that has been created in the physical environment without the use of a computer system. In some embodiments, work product is virtual work product that is computer generated. In some embodiments, work product is content that has been created and/or produced by a user and/or based on a user's creativity. In some embodiments, work product includes one or more physical contents and/or virtual contents that have been modified by a user.

To determine content in the environment (e.g., work product), at least a portion (e.g., a camera portion) of computer system 600 moves around to capture different parts of the environment. In some embodiments, computer system 600 determines the bounds of work product in the environment (e.g., the volume, area, perimeter, and/or occupied space of the work product). In some embodiments, the amount that computer system 600 moves around is based on the size of the work product, where computer system 600 moves around more when the work product is larger in size and less when the work product is smaller in size. In some embodiments, the amount that computer system 600 moves around is based on whether the work product has void space, such as a hole in the middle of the work product, and computer system 600 is intelligent enough, using machine learning, to identify whether a bound of the work product is reached and/or whether a void space has been identified with regards to the work product. Thus, in some embodiments, computer system 600 moves more when the work product is determined to have a void space at a location as opposed to moving less when computer system 600 has captured a bound (e.g., edge and/or perimeter) of the work product.

The left side of FIG. 6A illustrates computer system 600 displaying user interface 602, which includes avatar 602a. In some embodiments, avatar 602a represents a digital and/or system assistant. In some embodiments, computer system 600 updates avatar 602a to indicate to the user that computer system 600 is interacting with one or more users in the environment. For example, computer system 600 can update avatar 602a, such that avatar 602a appears to be looking at, looking away from, talking to, nodding at, and/or motioning to one or more users in the environment. In FIG. 6A, avatar 602a is a face having one or more human characteristics. In some embodiments, avatar 602a has a different appearance (e.g., different colors (e.g., sets of colors, flesh tones, reds, oranges, yellows, greens, blues, and/or purples), textures (e.g., skin, hair, fur, scales, plastic, glass, feathers, and/or wood), accessories (e.g., hat, glasses, monocle, wand, book, collar, bow, wings, halo, and/or crown), and/or face types (e.g., human, animal, anthropomorphized content, alien, non-descript face, fantasy creature, and/or a collection of contents that resemble a face)).

The right side of FIG. 6A includes a graphical representation of environment 604, which includes camera 606 and content 610. Here, camera 606 is directly coupled to computer system 600, such that camera 606 moves when a portion of computer system 600 moves. In some embodiments, camera 606 is in communication with computer system 600 but is not directly coupled to computer system 600. It should also be understood that environment 604 is a physical environment at FIG. 6A, and content 610 is physical content. However, in some embodiments, environment 604 is a virtual environment and/or content 610 is virtual content. Additionally, the right side of FIG. 6A includes field-of-detection 608, which is the field-of-view of camera 606. In some embodiments, field-of-detection 608 is and/or includes a field-of-detection of one or more other sensors, such as one or more microphones, LiDAR sensors, and/or thermal sensors. It should be understood that, while voice inputs are used herein to describe how computer system 600 can be caused to performed one or more operations, other inputs, such as air gestures, mouse clicks, gaze inputs, and/or touch inputs, could be used in lieu of or in addition to the detection of voice input to perform one or more of the same and/or similar operations. At FIG. 6A, computer system 600 detects voice input 605a directed to content 610 (e.g., “Can you help me with this drawing?”).

As illustrated in FIG. 6B, in response to detecting voice input 605a computer system 600 displays camera application user interface 612 and generates output 620b (e.g., “Yes, I can help.”). Camera application user interface 612 includes avatar 602b and representation of content 612a representing a portion of content 610 in field-of-detection 608 that is currently being captured by camera 606. In some embodiments, computer system 600 includes a movement component. In some embodiments, the movement component is capable of moving the pose (e.g., the pitch, roll, yaw and/or position) of camera 606 and/or computer system 600. In some embodiments, computer system 600 moves to center camera application user interface 612 including moving camera 606 and/or computer system 600 to center representation of content 612a in field-of-detection 608. In some embodiments, moving camera 606 includes computer system 600 changing the pose of camera 606. In some embodiments, moving camera 606 includes computer system 600 moving camera 606 in the environment corresponding to graphical representation of environment 604 in a spatial direction (e.g., x, y, and/or z axis). In some embodiments, avatar 602b is a smaller version of avatar 602a and looks in direction of one or more objects detected within field-of-detection 608 (e.g., representation of content 612a). In some embodiments, avatar 602b is displayed in a location in which no object is located and/or an object determined to be related to a request by a user is not located (e.g., representation of content 612a). At FIG. 6B, in response to detecting voice input 605a, computer system 600 initiates moving to determine the bounds of content 610.

As illustrated in FIG. 6C, computer system 600 has moved clockwise from the position that computer system 600 was previously in as illustrated in FIG. 6B. As illustrated in FIG. 6C, representation of content 612a has been updated to show that the entirety of content 610 is in field-of-detection 608 of camera 606. Thus, computer system 600 has moved clockwise by a certain amount in order to capture the bounds of content 610. While the example provided in relation to content 610 only illustrates computer system 600 moving clockwise, computer system 600 can move in other ways to determine the bounds of content, such as moving counterclockwise, tilting, moving right, moving left, moving up, moving down, and/or any combination thereof. In some embodiments, computer system 600 stops moving in a direction once computer system 600 has determined a boundary of the content in a certain direction. For example, at FIG. 6C, computer system 600 stops moving clockwise when the right side of content 610 is within the field-of-detection (e.g., by a certain amount). In some embodiments, computer system 600 stops moving in a direction even though the movement component of computer system 600 has not reached a maximum amount of movement and/or pose in the direction (e.g., stops rotating because boundary of content is determined even though computer system 600 can rotate more). In some embodiments, computer system 600 moves a minimum amount to fully capture representation of content 612a in field-of-detection 608 of camera 606.

In some embodiments, computer system 600 moves based on voice input 605a which identified content 610 as “drawing.” Thus, if the voice input identified content 610 as something else, such as graphical wall art, computer system 600 could move more to make sure that the boundary of content 610 in field-of-detection 608 is actually the boundary of the content (and/or the work product) for which the user is asking for help. In some embodiments, if voice input 605A identified content 610 as something else, such as a sticker, computer system 600 could move less in determining the boundary of content 610. For example, the boundary of the star that is a part of content 610 could be the identified boundary instead of the paper on which the star is drawn that makes up content 610. In some embodiments, computer system 600 moves based on the context of voice input 605a. In some embodiments, computer system 600 uses previous inputs to determine how much to move. For example, if voice input 605a did not identify content 610 as a drawing, computer system 600 could use previous input identifying the content 610 as a drawing to determine how much to move to identify the bounds of content 610. In some embodiments, computer system 600 establishes different internal dialogues (e.g., as further described below) based on different inputs (e.g., drawing being a sticker will establish a different internal dialogue than drawing being wall art).

In some embodiments, the amount that computer system 600 moves is based on whether there are one or more obstructions between camera 606 and content 610 and/or within the path of movement of computer system 600. In some embodiments, an obstruction is an obstacle, object, or item that blocks and/or obscures at least a portion of the field-of-detection 608 of camera 606 from content 610. In some embodiments, computer system 600 moves to avoid the obstruction in field-of-detection 608 while determining the bounds of content 610. In some embodiments, the amount of the movement to avoid the obstruction in field-of-detection 608 is based on the size of the obstruction. In some embodiments, computer system 600 moves more to avoid a larger obstruction than a smaller obstruction and/or vice-versa.

In some embodiments, computer system 600 moves a different amount based on whether content 610 is known content or unknown content. In some embodiments, computer system 600 moves less when computer system 600 has previously determined the bounds of content 610. In some embodiments, computer system 600 moves according to whether content 610 is a landmark, public domain art, or other content with data available to computer system 600, irrespective of whether the computer system itself previously captured and/or determined the bounds of content 610. In some embodiments, where content 610 is a known content, computer system 600 does not move. In some embodiments, in addition to and/or in lieu of determining the bounds of content 610, computer system 600 moves to determine the point of interest of content 610, which will be described in further detailed below in relation to FIGS. 8A-8E.

In some embodiments, display of avatar 602b is maintained as computer system 600 moves. In some embodiments, avatar 602b is moved as other content is captured in field of detection 608. For example, avatar 602b can be moved to a location in which no object is located and/or an object determined to be related to a request by a user is not located (e.g., representation of content 612a). In some embodiments, as avatar 602b is moved and/or content moved within display of computer 600, computer system 600 displays avatar 602b to look in direction of one or more objects detected within field-of-detection 608 (e.g., representation of content 612a).

FIGS. 6D-6F illustrate one or more scenarios where computer system 600 automatically moves by a different amount to determine the bounds of different content. The left side of FIG. 6D illustrates computer system 600 displaying user interface 602, which includes avatar 602a, and the right side of FIG. 6D illustrates camera 606 at the same position that camera 606 was in as illustrated in FIG. 6A and content 616 (e.g., larger content than content 610) in the field-of-detection 608 of camera 606. At FIG. 6D, computer system 600 receives voice input 605d directed to content 616 (e.g., “Can you help me with this drawing?”).

As illustrated in FIG. 6E, in response to detecting voice input 605d, computer system 600 displays camera application user interface 612 and generates output 620e1 (e.g., “Yes I can help.”). Camera application user interface 612 includes avatar 602b and representation of content 612b corresponding to content 616 in field-of-detection 608 of camera 606. Moreover, at FIG. 6E, computer system 600 generates output 620e2 (e.g., “arrow”) to indicate that content 616 has been identified as a drawing of an arrow. In some embodiments, avatar 602b looks in direction of one or more objects detected within field-of-detection 608 (e.g., representation of content 612b). In some embodiments, avatar 602b is displayed in a location in which no object is located and/or an object determined to be related to a request by a user is not located (e.g., representation of content 612b). At FIG. 6E, in response to detecting voice input 605d, computer system 600 starts moving clockwise to determine the bounds of content 616.

As illustrated in FIG. 6F, computer system 600 has moved clockwise and representation of content 612b is center in camera application user interface 612, and field-of-detection 608 of camera 606 is centered on content 616. As illustrated in FIG. 6F, computer system 600 provides output 620f (e.g., “mountain”) to indicate that content 616 is now being identified as a drawing of a mountain. Notably, at FIG. 6F, computer system 600 has changed its determination of what content 610 is by gathering more information by moving within environment 604. Moreover, at FIG. 6F, computer system 600 has moved further clockwise to identify the right side boundary of content 616 than computer system 600 moved to identify the right side boundary of content 610 at FIG. 6C. As suggested above, the difference in movement is at least due to content 616 being larger than content 610, longer than content 610, and/or extending more in a direction in the environment than content 616.

In some embodiments, display of avatar 602b is maintained as computer system 600 moves. In some embodiments, avatar 602b is moved as other content is captured in field of detection 608. For example, avatar 602b can be moved to a location in which no object is located and/or an object determined to be related to a request by a user is not located (e.g., representation of content 612b). In some embodiments, as avatar 602b is moved and/or content moved within display of computer 600, computer system 600 displays avatar 602b to look in direction of one or more objects detected within field-of-detection 608 (e.g., representation of content 612b). It should be recognized that FIG. 6B and FIG. 6F illustrate avatar 602b at different locations as a result of content within field-of-detection 608 being a different size (e.g., avatar 602b is displayed a predefined distance from the content within field-of-detection 608). It should also be recognized that avatar 602b can be moved differently.

FIG. 7 is a flow diagram illustrating a method for moving to capture content using a computer system in accordance with some embodiments. Process 700 is performed at a computer system (e.g., 100, 200, and/or 600). Some operations in process 700 are, optionally, combined, the orders of some operations are, optionally, changed, and some operations are, optionally, omitted.

As described below, process 700 provides an intuitive way for moving to capture content. The method reduces the cognitive burden on a user for moving to capture content, thereby creating a more efficient human-machine interface. For battery operated computing devices, enabling a user to move to capture content faster and more efficiently conserves power and increases the time between battery charges.

In some embodiments, process 700 is performed at a computer system (e.g., 600) that is in communication with one or more input devices (e.g., a camera, a depth sensor, and/or a microphone), a movement component (e.g., an actuator, a motor, an electronic arm, a lift, and/or a lever), and one or more cameras (e.g., a telephoto, wide angle, and/or ultra-wide angle camera). In some embodiments, the computer system is a watch, a phone, a tablet, a fitness tracking device, a processor, a head-mounted display (HMD) device, a communal device, a media device, a speaker, a television, and/or a personal computing device.

While capturing (e.g., storing representations of and/or recording) one or more images via the one or more cameras (e.g., a representation of the field-of-view of the one or more cameras), the computer system detects (702), via the one or more input devices, a request (e.g., 605a, and/or 605d) (e.g., a tap input and/or a non-tap input (e.g., a verbal input, an audible request, an audible command, an audible statement, a swipe input, a hold-and-drag input, a gaze input, an air gesture, and/or a mouse click)) corresponding to content (e.g., 612a, and/or 612b) (e.g., features, characteristics, objects, and/or work product) in the field-of-view of the one or more cameras (e.g., 608) (e.g., captured in the one or more images).

In response to (704) detecting the request (e.g., 605a, and/or 605d) corresponding to the content (e.g., 612a, and/or 612b) in the field-of-view of the one or more cameras (e.g., 608) (e.g., captured in the one or more images), in accordance with a determination that a portion of the content (e.g., 612a, and/or 612b) is outside of the field-of-view of the one or more cameras (e.g., 608) (e.g., the portion of the content is outside the frame of capture of the one or more cameras, and/or the portion of the content is not viewable by the one or more cameras) and that the content has a first set of one or more characteristics (e.g., the edge (e.g., the termination of the object on at least one side, and/or a region where the object includes minimal to no additional detail) of the object is a distance from the current field-of-view of the one or more cameras, and/or the object is above a certain size at the current distance between the computer system and the object), the computer system moves (706) (e.g., physically moving; and/or changing the pitch, yah, direction, and/or rotation), via the movement component, a first amount to capture one or more portions of the content that was previously not captured in the one or more images (e.g., as described above at FIGS. 6B-6C and/or 6E-6F) (and, in some embodiments, capturing, via the one or more cameras, one or more portions of content that was previously not in the field-of-view of the one or more cameras before moving the first amount).

In response to (704) detecting the request corresponding to the content in the field-of-view of the one or more cameras, in accordance with a determination that the portion of the content (e.g., 612a, and/or 612b) is outside of the field-of-view of the one or more cameras (e.g., 608) and that the content has a second set of one or more characteristics, different from the first set of one or more characteristics, the computer system moves (708), via the movement component, a second amount, different from the first amount, to capture the one or more portions of the content that was previously not captured in the one or more images (e.g., as described above at FIGS. 6B-6C and/or 6E-6F) (and, in some embodiments, capturing, via the one or more cameras, one or more portions of content that was previously not in the field-of-view of the one or more cameras before moving the second amount) (e.g., without and/or in addition to moving the first amount). In some embodiments, in accordance with a determination that a portion of the content is outside of the field-of-view and that the content has the first set of one or more characteristics, the computer system does not move, via the movement component, the second amount. In some embodiments, moving, via the movement component, the first amount includes moving, via the movement component, the one or more cameras. In some embodiments, the determination that the portion of the content is outside of the field-of-view of the one or more cameras includes moving the one or more cameras an initial amount, and in accordance with a determination that an additional portion of the content is in the field-of-view of the one or more cameras that moved the initial amount, the portion of the content is outside of the field-of-view of the one or more cameras; and in accordance with a determination that no additional portion of the content is in field-of-view of the one or more cameras that moved the initial amount, the portion of the content is outside of the field-of-view of the one or more cameras. In some embodiments, the initial movement is the same for the content and/or additional content different from the first content. Moving the first amount to capture one or more portions of the content that was previously not captured in the one or more images in accordance with a determination that a portion of the content is outside of the field-of-view of the one or more cameras and that the content has a first set of one or more characteristics in response to detecting the request corresponding to the content in the field-of-view of the one or more cameras and moving the second amount to capture the one or more portions of the content that was previously not captured in the one or more images in accordance with a determination that the portion of the content is outside of the field-of-view and that the content has a second set of one or more characteristics in response to detecting the request corresponding to the content in the field-of-view of the one or more cameras enables the computer system to move as needed to place the content in the field-of-view as directed by the user thereby performing an operation when a set of conditions has been met without requiring further user input, reducing the number of inputs needed to perform an operation, and providing improved visual feedback to the user.

In some embodiments, the computer system (e.g., 600) is in communication with a microphone (and, in some embodiments, that is included in the one or more input devices). In some embodiments, the request (e.g., 605a, and/or 605d) corresponding to content (e.g., 612a, and/or 612b) in the field-of-view of the one or more cameras (e.g., 608) includes detecting the request corresponding to content in the field-of-view of the one or more cameras includes capturing, via the microphone, audio that includes a verbal request (e.g., a voice input, and/or audible input) corresponding to the content in the field-of-view of the one or more cameras. In some embodiments, the verbal request includes an identification (e.g., name, symbol, or feature) of the content. In some embodiments, the verbal request does not include an identification of the content but rather a description that leads to the identification of content (e.g., “a request that says this is a picture of London” and the computer system identifying a box as “Big Ben” based on one or more characteristics of the content; and/or a request that says “I really like eating pizza,” and the computer system identifying a table in a living room in the content as the portion of interest instead of a chair in the living room or a television in the living room; however, if the request said “I really like TV Show 1,” the computer system would identify the television as the portion of interest instead of the table”). In some embodiments, the request corresponding to the content in the field-of-view of the one or more cameras is a verbal request. In some embodiments, detecting the request corresponding to the content in the field-of-view of the one or more cameras includes capturing, via the one or more input devices, an input (e.g., verbal input, sound input, and/or audio input) associated with (e.g., including, corresponding to, and/or having) the request corresponding to the content in the field-of-view of the one or more cameras. Moving the first amount to capture one or more portions of the content that was previously not captured in the one or more images in accordance with a determination that a portion of the content is outside of the field-of-view of the one or more cameras and that the content has a first set of one or more characteristics in response to detecting the request corresponding to the content in the field-of-view of the one or more cameras and moving the second amount to capture the one or more portions of the content that was previously not captured in the one or more images in accordance with a determination that the portion of the content is outside of the field-of-view and that the content has a second set of one or more characteristics in response to detecting the request that includes a verbal request corresponding to the content in the field-of-view of the one or more cameras enables the computer system to move as needed to place the content in the field-of-view as directed by the user via the verbal request thereby performing an operation when a set of conditions has been met without requiring further user input, reducing the number of inputs needed to perform an operation, and providing improved visual feedback to the user.

In some embodiments, in accordance with a determination that the content (e.g., 612a, and/or 612b) has a first size characteristic (e.g., the content is above a threshold size and/or the content is within a size range), the first amount is a third amount (e.g., moving the one or more cameras and/or the computer system from a first pose (e.g. pan, tilt, pitch, yaw, and/or position) to a second pose, a physical distance, and/or amount of rotation). In some embodiments, in accordance with a determination that the content (e.g., 612a, and/or 612b) has a second size characteristic different from the first size characteristic, the first amount is a fourth amount, different from the third amount (e.g., as described above at FIG. 6F). In some embodiments, in accordance with a determination that the content has a third size characteristic, the second amount is a first respective amount; and, in accordance with a determination that the content has a fourth size characteristic, the second amount is a second respective amount different from the first respective amount. In some embodiments, the first set of one or more characteristics includes the content (and/or the portion of the content) being a first size, and the second set of one or more characteristics includes the content (and/or the portion of the content) being a second size different from the first size. In some embodiments, the amount of movement is dependent on the size of the content. Moving the first amount that includes a third amount in accordance with the determination that the content has the first size characteristic and the fourth amount in accordance with the determination that the content has the second size characteristic to capture one or more portions of the content that was previously not captured in the one or more images in accordance with a determination that a portion of the content is outside of the field-of-view of the one or more cameras enables the computer system to move a different amount to place the content in the field-of-view as directed by the user thereby performing an operation when a set of conditions has been met without requiring further user input, reducing the number of inputs needed to perform an operation, and providing improved visual feedback to the user.

In some embodiments, in accordance with a determination that a first obstruction (e.g., an object between the one or more cameras and the content and/or an artifact in the one or more images that is in view of the content) is in the field-of-view of the one or more cameras (e.g., 608) captured in the one or more images, the first amount is a fifth amount. In some embodiments, in accordance with a determination that a second obstruction, different from the first obstruction (e.g., different in size, location in the environment, transparency, dispersion (amount of light the obstruction spreads through the environment (e.g., a tree with multiple of branches versus a tree with one branch), and/or optical properties)), is in the field-of-view of the one or more cameras (e.g., 608) captured in the one or more images, the first amount is a sixth amount, different from the fifth amount (e.g., as described above at FIGS. 6A-6F). In some embodiments, the first set of one or more characteristics includes a detection of a first set of one or more obstructions in the field-of-view of the one or more cameras, and the second set of one or more characteristics includes a detection of a second set of one more obstructions, different from (e.g., in number, in size, and/or in location) the first set of one or more obstructions, in the field-of-view of the one or more cameras. In some embodiments, the amount of movement is dependent on obstructions (e.g., number of obstructions, size of one or more obstructions, and/or the location of one or more obstructions). Moving the first amount that includes a fifth amount in accordance with the determination that a first obstruction is in the field-of-view of the one or more cameras captured in the one or more images and the sixth amount in accordance with the determination that a second obstruction is in the field-of-view of the one or more cameras captured in the one or more images and in accordance with a determination that a portion of the content is outside of the field-of-view of the one or more cameras enables the computer system to move a different amount to place the content in the field-of-view without the obstruction as directed by the user thereby performing an operation when a set of conditions has been met without requiring further user input, reducing the number of inputs needed to perform an operation, and providing improved visual feedback to the user.

In some embodiments, in accordance with a determination that the request (e.g., 605a, and/or 605d) corresponds to (e.g., was made in, denotes, is determined to be provided in, and/or determined to be associated with) a first context criteria (e.g., the verbal request incudes a request to move a particular amount, the verbal request includes previous requests for a particular amount to move, and/or the verbal request indicates additional content in the field-of-view of the one or more cameras), the first amount is a seventh amount. In some embodiments, a context is determined based on the verbal request (e.g., move right) and one or more environmental conditions (e.g., moving right would make the computer system collide with an object that is in the computer systems path if the computer system moved a certain amount), situation conditions (e.g., moving right is not appropriate to accomplish a tasks made by the user) (e.g., the computer system should move left and/or shouldn't move at all to complete the tasks), and/or historical conditions (e.g., the computer system was corrected to only move a certain amount before when it moved more/less than the certain amount (e.g., corrected by a user and/or corrected based on a user's interaction with the computer system)). In some embodiments, in accordance with a determination that the verbal request (e.g., 605a, and/or 605d) corresponds to a second context criteria, different from the first context criteria, the first amount is an eighth amount, different from the seventh amount. In some embodiments, the content has the first set of one or more characteristics when a determination is made that one or more respective characteristics of the verbal request relative to one or more respective characteristics content satisfy the first context criteria, and the content has the second set of one or more characteristics when a determination is made that the one or more respective characteristics of the verbal request relative to the one or more respective characteristics of the content satisfy the second context criteria different from the first context criteria. Moving the first amount that includes a seventh amount in accordance with the determination that the request corresponds to a first context criteria and the eighth amount in accordance with the determination that the verbal request corresponds to a second context criteria and in accordance with a determination that a portion of the content is outside of the field-of-view of the one or more cameras enables the computer system to move a different amount based on the verbal request thereby performing an operation when a set of conditions has been met without requiring further user input, reducing the number of inputs needed to perform an operation, and providing improved visual feedback to the user.

In some embodiments, the content (e.g., 612a, and/or 612b) in the field-of-view of the one or more cameras (e.g., 608) captured in the one or more images includes physical content (e.g. content in the physical, non-computer generated, and/or real environment) (e.g., a physical drawing, physical sculpture, physical painting in the field-of-view of the one or more cameras, and/or physical content produced by a user (e.g., of the computer system and/or in the field-of-view of the one or more cameras), of the computer system). In some embodiments, the content is physical content. In some embodiments, the physical content includes and/or is work product (e.g., content specified in the request as being and/or content that is something user has produced (and/or edited, modified, put together, generated, drawn, sculptured, and/or made), a drawing, a unfinished product, a sculpture, a work of art, physical content that is being and/or will be edited, and/or a schematic (e.g., as described below in relation to process 900)). In some embodiments, the content includes virtual content (e.g., a virtual drawing, virtual sculpture, and/or virtual painting in the field-of-view of the one or more cameras). In some embodiments, the content is virtual content.

In some embodiments, in accordance with a determination that the portion of the physical content (e.g., 612a, and/or 612b) that the content includes a first physical characteristic (e.g., size, orientation, style, and/or known features (e.g., the physical content is a public landmark and/or previously recorded content is available for the feature)) (and, in some embodiments, that the physical content is outside of the field-of-view), the computer system forgoes moving (e.g., to capture one or more portions of the content that was previously not captured in the one or more images). In some embodiments, in accordance with a determination that the physical content includes a second physical characteristic, the first amount is a zero-movement amount. Not moving in accordance with a determination that the portion of the physical content includes the first physical characteristic enables the computer system to not move when certain characteristics of the content are met, thereby performing an operation when a set of conditions has been met without requiring further user input, reducing the number of inputs needed to perform an operation, and providing improved visual feedback to the user.

In some embodiments, moving the first amount to capture the one or more portions of content (e.g., 612a, and/or 612b) includes capturing an edge of the content that was not that was previously not captured in the one or more images. In some embodiments, moving the second amount to capture the one or more portions of content includes capturing the edge of the content that was not that was previously not captured in the one or more image (e.g., as described above at FIG. 6F). In some embodiments, in accordance with a determination that the portion of the content is outside of the field-of-view of the one or more cameras and that the content has the first set of one or more characteristics, the computer system would not capture the edge of the content when the computer system is moved by the second amount (e.g., the edge of content would not be in the field-of-view of the one or more cameras) (e.g., the edge of content would not be in the field-of-view of the one or more cameras while moving or while the computer system is at the position that the computer system is in after being moved by the second amount). In some embodiments, in accordance with a determination that the portion of the content is outside of the field-of-view of the one or more cameras and that the content has the second set of one or more characteristics, the computer system would not capture the edge of the content when the computer system is moved by the first amount (e.g., the edge of content would not be in the field-of-view of the one or more cameras while moving or while the computer system is at the position that the computer system is in after being moved by the first amount). In some embodiments, the computer system moves from a third pose (e.g., pan, tilt, pitch, yaw, and/or position to a second pose, a physical distance, and/or amount of rotation) to a fourth pose different from the third pose. In some embodiments, the fourth pose includes an edge (e.g., a side and/or limit) (and, in some embodiments, one or more edges and/or all edges) of the content that was previously not captured in the one or more images. In some embodiments, the content includes physical content. In some embodiments, before moving the first amount to capture one or more portions of the content that was previously not captured in the one or more images the edge is not in the field-of-view of the one or more cameras, and moving, via the movement component, the first amount to capture one or more portions of the content that was previously not captured in the one or more images includes adjusting the positioning of the computer system so that the edge of the content is in the field-of-view of the one or more cameras. In some embodiments, before moving the second amount to capture one or more portions of the content that was previously not captured in the one or more images the edge is not in the field-of-view of the one or more cameras. In some embodiments, moving, via the movement component, the second amount to capture one or more portions of the content that was previously not captured in the one or more images includes adjusting the positioning of the computer system so that the edge of the content is in the field-of-view of the one or more cameras. In some embodiments, when the portion of content outside of the field of view has the first set of one or more characteristics, the edge would not be in the field-of-view of the one or more cameras if the computer system was moved by the second amount. In some embodiments, when the portion of content outside of the field of view has the first set of one or more characteristics, the edge would not be in the field-of-view of the one or more cameras if the computer system was moved by the first amount. Moving the second amount to capture the one or more portions of content including capturing the edge of the content that was not that was previously not captured in the one or more image enables the computer system to move the amount needed to capture the edge of the content, thereby performing an operation when a set of conditions has been met without requiring further user input, reducing the number of inputs needed to perform an operation, and providing improved visual feedback to the user.

In some embodiments, moving the first amount to capture the one or more portions of content (e.g., 612a, and/or 612b) includes receiving an indication that a first portion of the content is a portion of interest. In some embodiments, moving the first amount includes receiving an indication that the second portion of the content is the portion of interest (e.g., as described in relation to process 900). In some embodiments, in accordance with a determination that the portion of the content is a portion of interest and that the content has a first set of one or more characteristics, the computer system would not capture the portion of interest when the computer system is moved the second amount (e.g., the portion of interest would not be in the field-of-view of the one or more cameras) (e.g., the portion of interest would not be in the field-of-view of the one or more cameras while moving or while the computer system is at the position that the computer system is in after being moved by the second amount). In some embodiments, in accordance with a determination that the portion of the content is the portion of interest and that the content has a second set of one or more characteristics, the computer system would not capture the portion of interest when the computer system is moved the first amount. In some embodiments, the computer system moves from a fifth pose (e.g., pan, tilt, pitch, yaw, and/or position to a sixth pose, a physical distance, and/or amount of rotation) to a seventh pose different from the fifth pose. In some embodiments, the seventh pose includes the portion of interest the content that was previously not captured in the one or more images. In some embodiments, the content includes physical content. In some embodiments, the first portion of the content is the same as the second portion of the content. In some embodiments, the second portion of the content is different from the first portion of the content. In some embodiments, in conjunction with (e.g., while or after) moving, via the movement component, the first amount to capture one or more portions of the content that was previously not captured in the one or more images, the computer system identifies a second portion of the content as a portion of interest. In some embodiments, the second portion of the content is included in and/or is the portion of the content. In some embodiments, the second portion of the content is not included in and/or is not the portion of the content. In some embodiments, the second portion of the content is determined based on the portion of the content. In some embodiments, in conjunction with (e.g., while or after) moving, via the movement component, the second amount to capture one or more portions of the content that was previously not captured in the one or more images, the computer system identifies a third portion of the content as the portion of interest. In some embodiments, when the portion of content outside of the field of view has the first set of one or more characteristics, the computer system would not identify and/or identify another portion of the content other than the second portion as the portion of interest if the computer system was moved by the second amount. In some embodiments, when the portion of content outside of the field of view has the second set of one or more characteristics, the computer system would not identify and/or identify another portion of the content other than the second portion as the portion of interest if the computer system was moved by the first amount. Moving the first amount including receiving an indication that the second portion of the content is the portion of interest enables the computer system to determine the portion of interest from the second portion of content, thereby performing an operation when a set of conditions has been met without requiring further user input, reducing the number of inputs needed to perform an operation, and providing improved visual feedback to the user.

In some embodiments, the computer system (e.g., 600) has (and/or, in some embodiments, is configured to have) (e.g., where the movement is restricted via source code, a program, and/or an application) a maximum amount (and/or degree) of movement (e.g., 1-360 degrees in pitch, yaw, and/or roll and/or 1-100 meters). In some embodiments, the first amount and the second amount are less than the maximum amount of movement (e.g., as described above at FIG. 6F). In some embodiments, the movement component has the maximum amount of movement and/or is configured to have a maximum of movement. In some embodiments, the computer system moves by the first amount in a first direction, and after moving the first amount to capture one or more portions of the content that was previously not captured in the one or more images, the computer system moves, via the movement component, a third amount in the first direction. In some embodiments, the third amount is greater than, less than, and/or equal to the first amount. In some embodiments, the computer system moves by the second amount in a second direction. In some embodiments, after moving the second amount to capture one or more portions of the content that was previously not captured in the one or more images, the computer system moves, via the movement component, a fourth amount in the second direction. In some embodiments, the fourth amount is greater than, less than, and/or equal to the second amount. In some embodiments, the computer system is capable of moving more than the first amount and/or second amount and/or the computer system does not need to move and/or have to move by a limited amount (e.g., a maximum amount, an amount that is near and/or at the edge of a degree of freedom or movement of the computer system). Moving the first amount less than the maximum amount of movement to capture one or more portions of the content that was previously not captured in the one or more images in accordance with a determination that a portion of the content is outside of the field-of-view of the one or more cameras and that the content has a first set of one or more characteristics in response to detecting the request corresponding to the content in the field-of-view of the one or more cameras and moving the second amount less than the maximum amount of movement to capture the one or more portions of the content that was previously not captured in the one or more images in accordance with a determination that the portion of the content is outside of the field-of-view and that the content has a second set of one or more characteristics in response to detecting the request corresponding to the content in the field-of-view of the one or more cameras enables the computer system to move as needed but less than the maximum amount of movement to place the content in the field-of-view as directed by the user thereby performing an operation when a set of conditions has been met without requiring further user input, reducing the number of inputs needed to perform an operation, and providing improved visual feedback to the user.

In some embodiments, the computer system (e.g., 600) is in communication with one or more output devices (e.g., a speaker, a haptic output device, a display screen, a projector, and/or a touch-sensitive display). In some embodiments, in response to detecting the request (e.g., 605a, and/or 605d) corresponding to the content (e.g., 612a, and/or 612b) in the field-of-view of the one or more cameras (e.g., 608) captured in the one or more images and in accordance with a determination that the portion of the content is outside of the field-of-view of the one or more cameras (e.g., the portion of the content is outside the frame of capture of the one or more cameras, and/or the portion of the content is not viewable by the one or more cameras) and that the content has the first set of one or more characteristics, the computer system outputs, via the one or more output devices, an indication (e.g., a representation of the second portion of content is bolded, highlighted, and/or emphasized) of a first type of content (e.g., a building, object, person, statue, and/or art) in conjunction with (e.g., after and/or while) moving the first amount to capture the one or more portions of the content that was previously not captured in the one or more images. In some embodiments, the content includes physical content. In some embodiments, in response to detecting the request corresponding to the content in the field-of-view of the one or more cameras captured in the one or more images and in accordance with a determination that the portion of the content is outside of the field-of-view of the one or more cameras and that the content has the second set of one or more characteristics, outputting, via the one or more output devices, the indication of the first type of content in conjunction with moving the second amount to capture the one or more portions of the content that was previously not captured in the one or more images. In some embodiments, in response to detecting the request corresponding to the content in the field-of-view of the one or more cameras captured in the one or more images and in accordance with a determination that the portion of the content is outside of the field-of-view of the one or more cameras and that the content has the second set of one or more characteristics, outputting, via the one or more output devices, a respective indication of a respective type of content, different from the indication of the first type of content in conjunction with moving the second amount to capture the one or more portions of the content that was previously not captured in the one or more images. In some embodiments, in conjunction with (e.g., while or after) moving, via the movement component, the first amount to capture one or more portions of the content that was previously not captured in the one or more images, outputting, via the one or more output devices, the indication that the content is a first respective type of content. In some embodiments, in conjunction with (e.g., while or after) moving, via the movement component, the first amount to capture one or more portions of the content that was previously not captured in the one or more images, the computer system outputs the indication that the content is a first type of content. In some embodiments, in conjunction with (e.g., while or after) moving, via the movement component, the second amount to capture one or more portions of the content that was previously not captured in the one or more images, the computer system outputs the indication that the content is a respective type of content, different from the first type of content. In some embodiments, the computer system determines that the content is the respective type of content while moving, by moving, and/or because of moving (e.g., by the first amount, the second amount, and/or another amount) in response to detecting the request corresponding to the content in the field-of-view of the one or more cameras. Outputting an indication of a first type of content in conjunction with moving the first amount to capture the one or more portions of the content that was previously not captured in the one or more images in response to detecting the request corresponding to the content in the field-of-view of the one or more cameras captured in the one or more images and in accordance with a determination that the portion of the content is outside of the field-of-view of the one or more cameras and that the content has the first set of one or more characteristics enables the computer system to output the type of content and move to capture the content as directed by the user, thereby performing an operation when a set of conditions has been met without requiring further user input, reducing the number of inputs needed to perform an operation, and providing improved visual feedback to the user.

In some embodiments, before moving the first amount to capture the one or more portions of the content (e.g., 612a, and/or 612b) that was previously not captured in the one or more images (and, in some embodiments, while capturing the one or more images via the one or more cameras, detecting the one or more input devices, the request corresponding to the content, and/or in response to detecting the request corresponding to the content in the field-of-view of the one or more cameras captured in the one or more images), the computer system outputs, via the one or more output devices, an indication of a second type of content, different from the first type of content, wherein the indication of the first type of content is different from the indication of the second type of content. In some embodiments, before moving the second amount to capture the one or more portions of the content that was previously not captured in the one or more images (and, in some embodiments, while capturing the one or more images via the one or more cameras, detecting the one or more input devices, the request corresponding to the content, and/or in response to detecting the request corresponding to the content in the field-of-view of the one or more cameras captured in the one or more images), outputting, via the one or more output devices, a indication of a respective type of content, different from the first type of content, wherein the indication of the first type of content is different from the indication of the respective type of content. In some embodiments, before moving, via the movement component, the first amount to capture one or more portions of the content that was previously not captured in the one or more images, outputting, via the one or more output devices, an indication that the content is a respective type of content (e.g., the first type of content, second type of content, and/or a different type of content). In some embodiments, in conjunction with (e.g., while or after) moving, via the movement component, the first amount to capture one or more portions of the content that was previously not captured in the one or more images, the computer system output, via the one or more output devices, an indication that the content has changed from being identified as and/or as being the second type of content to being identified as and/or as being the first type of content. Outputting an indication of a second type of content before moving the first amount to capture the one or more portions of the content that was previously not captured in the one or more images enables the computer system to output an indication of type of content before outputting the indication of a change in the type of content, thereby performing an operation when a set of conditions has been met without requiring further user input, reducing the number of inputs needed to perform an operation, and providing improved visual feedback to the user.

In some embodiments, the first set of one or more characteristics includes a third type of content (e.g., 612a, and/or 612b) (e.g., type of art (e.g., painting, sculpture, printmaking, ceramics, photography, textile arts, digital art, installation art, performance art, and/or mixed media), object type (e.g., buildings, people, animals, plants, vehicles, electronics, clothing, furniture, tools, and/or toys), and/or type of media (movies, television shows, books, magazines, newspapers, radio programs, podcasts, music, video games, and/or online content)). In some embodiments, the second set of one or more characteristics includes a fourth type of content different from the third type of content. In some embodiments, the first set of one or more characteristics does not include the fourth type of content. In some embodiments, the second set of one or more characteristics does not include the third type of content. Moving the first amount to capture one or more portions of the content that was previously not captured in the one or more images in accordance with a determination that a portion of the content is outside of the field-of-view of the one or more cameras and that the content has a first set of one or more characteristics including a third type of content in response to detecting the request corresponding to the content in the field-of-view of the one or more cameras and moving the second amount to capture the one or more portions of the content that was previously not captured in the one or more images in accordance with a determination that the portion of the content is outside of the field-of-view and that the content has a second set of one or more characteristics including a fourth type of content in response to detecting the request corresponding to the content in the field-of-view of the one or more cameras enables the computer system to move as needed to place the content in the field-of-view based on the type of content as directed by the user thereby performing an operation when a set of conditions has been met without requiring further user input, reducing the number of inputs needed to perform an operation, and providing improved visual feedback to the user.

In some embodiments, the first set of one or more characteristics includes a first context (e.g., as described above) of the content (e.g., 612a, and/or 612b). In some embodiments, the second set of one or more characteristics includes a second context, different from the first context. In some embodiments, the first set of one or more characteristics does not include the second context. In some embodiments, the second set of one or more characteristics does not include the first type of content. In some embodiments, a context of the content (e.g., the first context of the content and/or the second context of the content) is determined based on previous content (e.g., content that was previously in the field-of-view of the one or more cameras and/or content that moved in the field-of-view of the one or more cameras), current additional features of the content, and/or future content (e.g., a trajectory of movement of the content to a new location and/or trajectory of movement of the computer system). Moving the first amount to capture one or more portions of the content that was previously not captured in the one or more images in accordance with a determination that a portion of the content is outside of the field-of-view of the one or more cameras and that the content has a first set of one or more characteristics including a first context of content in response to detecting the request corresponding to the content in the field-of-view of the one or more cameras and moving the second amount to capture the one or more portions of the content that was previously not captured in the one or more images in accordance with a determination that the portion of the content is outside of the field-of-view and that the content has a second set of one or more characteristics including a second context of content in response to detecting the request corresponding to the content in the field-of-view of the one or more cameras enables the computer system to move as needed to place the content in the field-of-view based on the context of the content as directed by the user thereby performing an operation when a set of conditions has been met without requiring further user input, reducing the number of inputs needed to perform an operation, and providing improved visual feedback to the user.

Note that details of the processes described above with respect to process 700 (e.g., FIG. 7) are also applicable in an analogous manner to the methods described below/above. For example, process 800 optionally includes one or more of the characteristics of the various methods described above with reference to process 700. For example, the computer system can use one or more techniques of process 900 to display a portion of content is a portion of interest based on a context of a request using one or more techniques of process 700. For brevity, these details are not repeated below.

FIGS. 8A-8E illustrate exemplary user interface for changing an object to display a portion of interest in accordance with some embodiments. The user interfaces in these figures are used to illustrate the processes described below, including the processes in FIGS. 9-13.

FIGS. 8A-8E illustrate a computer system 600 displaying avatar 802. In some embodiments, computer system 600 has one or more components and/or features as described above in relation to FIG. 6A. FIGS. 8A-8E illustrate one or more scenarios where computer system 600 assists a user with content (e.g., work product) in an environment. In some embodiments, one or more techniques described above in relation to FIGS. 6A-6F are used in combination with one or more techniques described below in relation to FIGS. 8A-8E to manage content and/or work product. In some embodiments, computer system 600 identifies a point of interest in content in order to assist a user with work product. In some embodiments, in conjunction with identifying the point of interest, computer system 600 makes one or more suggestions to modify the work product. In some embodiments, the suggestions can include one or more suggestions to add content to the work product and/or remove content from the work product. In some embodiments, the one or more suggestions can be provided as visual representations, audio output, and/or haptic output. In some embodiments, a visual representation of a suggestion can be overlaid on the work product in a detected style (e.g., drawing style and/or artistic style) and/or a system style. In some embodiments, a suggestion is generated based on what portion of the work product that computer system 600 has identified as the point of interest. In some embodiments, the one or more suggestions are generated based on historical information and/or learned characteristics of a particular user.

FIG. 8A illustrates computer system 600 displaying avatar 802. FIG. 8A illustrates user 804 within a physical environment making a verbal input 805a asking computer system 600 for assistance with a work product that user 804 made. Verbal input 805a indicates a request for computer system 600 to aid user 804 with their drawing (e.g., work product). It should be understood that, while voice inputs are used herein to describe how computer system 600 can be caused to performed one or more operations, other inputs, such as air gestures, mouse clicks, gaze inputs, and/or touch inputs, could be used in lieu of or in addition to the detection of voice input to perform one or more of the same and/or similar operations.

FIG. 8B illustrates computer system 600 displaying work product 810, which is in the field-of-view of computer system 600 (e.g., as described above in relation to FIGS. 6A-6F). In response to detecting verbal input 805a and the appearance of work product 810, computer system 600 shrinks the display of avatar 802 and moves a portion of computer system 600 to capture more of work product 810 within the field-of-view of computer system 600 (e.g., using one or more techniques described above in relation to FIG. 6A).

FIG. 8C illustrates computer system continuing to display work product 810 in the field-of-view of computer system 600 with most of the drawing visible. As computer system 600 displays more of work product 810, computer system 600 works to determine a point of interest. In some embodiments, a point of interest is an aspect of a work product that computer system 600 determines is the focal point of the work product. In some embodiments, computer system 600 determines the point of interest of a work product based on what appears to be the most important aspect and/or characteristic of the work product. In some embodiments, computer system 600 determines the important aspect and/or characteristic of the work product based on one or more inputs, such as verbal input 805a. For example, if verbal input 805a indicated that the work product is a drawing of a sky, computer system 600 can determine that the point of interest is something (e.g., a portion of the work product) in the sky rather than something that is not in the sky of the drawing. On the other hand, if verbal input 805a indicated that the work product is a drawing of a field, computer system 600 can determine that the point of interest is something (e.g., a portion of the work product) in the field rather than something that is not in the field.

At FIG. 8C, computer system 600 determines that content 812 is the point of interest based on content 812 being the first content to appear within the field-of-view of computer system 600. Because computer system 600 determines that content 812 is the point of interest, computer system 600 updates avatar 802, such that avatar 802 is directed to (e.g., looking at) content 812, which is a portion of work product 810. In some embodiments, computer system 600 indicates the point of interest with a question mark, an arrow, and/or highlighting of the point of interest.

In some embodiments, after avatar 802 appears to be directed to a point of interest for a period of time, computer system 600 updates avatar 802 to appear to look in a different direction, such as facing user 804. Avatar 802 can appear to be directed to a portion of the environment and/or the eyes of user 804. In some embodiments, computer system 600 updates the display of avatar 802, such that the eyes of avatar 802 appear to be directed toward user 804 (and, in some embodiments, appear to make eye content with user 804). In some embodiments, after avatar 802 appears to be directed to a point of interest for a period of time, computer system 600 updates avatar 802, such that avatar 802 appears to be directed to a different portion of content within the work product.

In some embodiments, computer system 600 outputs audio concerning the point of interest. For example, when computer system 600 determines a point of interest within a work product, computer system 600 can output audio to indicate to user 804 which portion of work product 810 that computer system 600 has identified as the point of interest. In some embodiments, computer system 600 outputs audio to indicate information concerning the point of interest. In some embodiments, computer system 600 dynamically animates avatar 802 to appear as though avatar 802 is talking when outputting audio. In some embodiments, dynamically animating avatar 802 includes computer system 600 moving the eyes, mouth, and/or face of avatar 802 according to the audio output. In some embodiments, computer system 600 can update avatar 802 to indicate an emotional response and/or a factual response related to the audio output. For example, if computer system 600 does not understand a request from user 804, computer system 600 can display avatar 802 as frowning and/or blinking while outputting audio such as “I don't understand.”

When indicating a portion of interest, computer system 600 displays avatar 802 closer to the portion of interest than to another portion of the work product. For example, as illustrated in FIG. 8C, computer system 600 displays avatar 802 closer to content 812 than to content 814 and content 818. In some embodiments, to display avatar 802 closer to the point of interest than other portions of the work product, computer system 600 prioritizes displaying avatar 802 in an empty space of content in work product 810 than a space that is occupied by content. That is, when indicating a point of interest with avatar 802, computer system 600 attempts to avoid displaying avatar 802 as covering contents (e.g., the point of interest or other contents) within the work product, in some embodiments. In some embodiments, if no empty space is near the point of interest (e.g., except for background color), computer system 600 attempts to display avatar 802 on content in work product 810 that is less interesting. For example, computer system 600 can choose to display avatar 802 on top of the ground and/or leaves rather than an animal in the work product.

At FIG. 8D, computer system 600 continues to move within the physical environment in a way such that it displays more of work product 810 in the field-of-view. As computer system 600 displays more content of work product 810, computer system 600 determines that content 818 is a better point of interest than content 812. Because computer system 600 determined that content 818 should be the new point of interest, computer system 600 updates avatar 802 to be directed to content 818 instead of content 812. At FIG. 8D, computer system 600 detects verbal input 805d1 from user 804, which includes a request for computer system 600 to make suggestions to improve content 816 according to the preferences of the grandmother of user 804. In addition, at FIG. 8D, computer system 600 detects air gesture 805d2 from user 804 toward content 816. In some embodiments, air gesture 805d2 indicates an explicit request to identify content 816 as the point of interest. Note that voice input 805d1 and air gesture 805d2 are not necessarily performed simultaneously. That is, in some embodiments, verbal input 805d1 and air gesture 805d2 obtain the same results described below if user 804 performs them individually.

As illustrated in FIG. 8E, in response to detecting verbal input 805d1 and/or air gesture 805d2, computer system 600 identifies content 816 as the new point of interest. Computer system 600 indicates the new point of interest by displaying avatar 802 near content 816 with the eyes of avatar 802 directed at content 816. In some embodiments, computer system 600 outputs audio to indicate the change. In the example of FIG. 8E, computer system 600 can output audio saying, “I am now looking at the circle.” As another example in view of verbal input 805d1 requesting assistance with modifying content 816, computer system 600 can output audio indicating that content 816 is the new point of interest by saying, “Would you like to make changes to the circle?”

In some embodiments, suggestions that computer system 600 makes regarding a work product can change based on the point of interest. For example, if the point of interest is a star (as illustrated in FIGS. 8C-8D), computer system 600 can make a suggestion for improvement such as, “Would you like to add more stars to the sky?” However, if the point of interest is a circle (e.g., as illustrated in FIG. 8E), computer system 600 can make a suggestion for improvement such as, “Would you like to make the circle rounder?” In some embodiments, instead of making different suggestions based on the point of interest via audio outputs, computer system 600 can provide different suggestions based on the point of interest via displaying different visual representations. For example, instead of (or in addition to) computer system 600 asking, “Would you like to add more stars to the sky?” computer system 600 automatically overlays one or more visual representations of additional stars in the sky at the appropriate locations on work product 810. As another example, instead of (or in addition to) asking, “Would you like to make the circle rounder?” computer system 600 can display an overlay that visually modifies the circle to be rounder as a suggested improvement to the user. In some embodiments, instead of or in addition to outputting audio relating to a suggestion, computer system 600 highlights suggested additions to a work product to indicate the suggested content and its placement. In the example of the addition of a bench described below, computer system 600 displays a highlighted/emphasized bench at a specific location on the work product.

As computer system 600 makes the suggested changes mentioned above via audio outputs, some suggested changes can be visual. That is, computer system 600 can suggest changes to be made to a work product by visually adding content to the content of the work product and, in some embodiments, adding content based on the content that is in the field-of-view of the work product. Suggestions of additions to a work product that computer system 600 makes are locational and contextual. That is, computer system 600 suggests specific contents, colors, and/or styles to add to a work product and also suggests appropriate locations for those suggestions. For example, if computer system 600 detects that a work product is a drawing of a park, computer system 600 can determine that the drawing would be improved by adding a bench and would display a bench on its display component at the respective location of the work product on which the bench would fit best or most naturally, such as under a tree in the park. In some embodiments, computer system 600 prioritizes placing a suggested content in empty space within the content. That is, in some embodiments, computer system 600 places a suggested content in an empty space of the work product before placing a suggested content overlapping another content (e.g., using similar techniques to those discussed above in relation to overlaying the point of interest on empty space). In some embodiments, computer system 600 displays a suggested content overlapping a portion of the content and/or the point of interest of work product 810. For example, if the point of interest of a work product is a drawing of a face, computer system 600 can suggest adding a mustache to the face, after which computer system 600 displays a mustache overlapping the face in the appropriate position (e.g., the space under the nose). In some embodiments, computer system 600 makes suggestions based on the context of the content. In the example of computer system 600 suggesting the addition of the mustache to the face, computer system 600 would not suggest adding the mustache to the forehead or chin of the face based on the context of a face being the point of interest. If computer system 600 knows, based on previous interactions, that the user has a mustache, computer system 600 might suggest the addition of a mustache to a point of interest on a work product. However, if the designated point of interest is the face of a dog, computer system 600 will not suggest adding a mustache to the dog's face because the suggestion would not correlate to the content of the work product. That is, in some embodiments, a determination should be made that content relates to the point of interest for computer system 600 to suggest the addition of the content.

After computer system 600 displays addition and/or change suggestions on the work product within the field-of-view of computer system 600, a user has the ability to lock the suggestion in place (e.g., via one or more inputs). A suggestion that is locked in place stays overlaid at the locked location even when the field-of-view of computer system 600 is moved and/or work product 810 is moved in the field-of-view. For example, if computer system 600 displays a suggested content locked on the left side of the work product and is moved such that the left side of the work product is no longer in the field-of-view of computer system 600, computer system 600 does not display the suggested content at the locked location. In some embodiments, if computer system 600 displays a suggested content on the left side of the work product without the suggested content being locked and is moved such that the left side of the work product is no longer in the field-of-view of computer system 600, computer system 600 continues to display the suggested content. In some embodiments, a user can tap on suggested content to lock and/or unlock the suggested content with respect to a location. However, it should be understood that other types of inputs can be used to lock/unlock suggested content, such as air gestures, mouse clicks, gaze inputs, and/or touch inputs.

In some embodiments, computer system 600 suggests modifications to a work product in the same visual style as the style of the point of interest. For example, if the point of interest of a work product is a word written in cursive, computer system 600 provides a suggestion to modify the word but maintains the cursive font. In some embodiments, the modifications that computer system 600 suggests are of a predetermined and/or system style that is different from the style used in the work product. For example, computer system 600 suggests modifications in the predetermined style irrespective of detected style of the work product. In some embodiments, if the point of interest is in a different style than the other portions of a work product, computer system 600 provides suggestions of improvement in the style of the point of interest and not in the style of other portions of the work product. In the example of FIGS. 8D-8E, user 804 makes verbal input 805d1 to computer system 600 which indicates that work product 810 is intended for the grandmother of user 804 and that user 804 would like computer system 600 to suggest changes to content 816 that is intended to be given to the user's grandmother.

As illustrated in FIG. 8E, in response to detecting verbal input 805d1, computer system 600 generates audio output 820, which is a suggested change from avatar 802 via computer system 600 to the user. Audio output 820 includes a suggestion to alter the color of content 816 (e.g., the point of interest determined by verbal input 805d1 and/or air gesture 805d2) according to the preferences of a person other than user 804 (e.g., the grandmother of user 804). In this example, preferences and characteristics of the grandmother of user 804 are determined based on previous conversations and interactions concerning the grandmother. In this example, based on previous interactions concerning the grandmother's favorite color, computer system 600 suggest making content 816 purple, as purple is the grandmother's favorite color. Thus, in some embodiments, computer system 600 can suggest changes to a work product based on preferences and/or characteristics of a person other than the user. In some embodiments, computer system 600 suggests additions to a work product based on a reference to another person (e.g., without a direct reference of what to add for the second person), such as their favorite color or other preferences as described above based on past conversations and interactions with and/or about the secondary person.

In some embodiments, computer system 600 can suggest changes and/or additions to a work product based on more than one person other than the user. For example, as illustrated in FIG. 8D, user 804 requests for computer system 600 to make suggestions to work product 810 that includes an indication that the work product is for the grandmother of user 804. In some embodiments, after computer system 600 makes suggestions to the work product based on the preferences of the grandmother of user 804, user 804 makes a request for computer system 600 to make suggestions based on their grandfather. In this situation, computer system 600 can either cease to display the suggestions based on the grandmother's preferences and replace them with suggestions based on the grandfather's preferences or can display preferences of both the grandmother and the grandfather simultaneously. For example, as illustrated in FIG. 8E, computer system 600 suggests coloring content 816 purple, as it is the grandmother's favorite color. If computer system 600 detects that user 804 wants to give the work product to their grandfather, computer system 600 can change content 816 from the grandmother's favorite color to the grandfather's favorite color (e.g., from purple to blue). In some embodiments, computer system 600 can change more than one content, color, and/or style within a work product based on the recipient of the work product. That is, upon receiving the request to change the work product according to the grandfather's preferences instead of the grandmother's, computer system 600 can change one, two, or more characteristics of the work product but does not necessarily change all characteristics. In some embodiments, if user 804 indicates that the work product was for the grandmother and the grandfather, computer system 600 can provide suggestions that satisfy both preferences of the grandmother and grandfather, such as a suggestion to change the content to a memorable color encountered on the grandmother's and grandfather's first date. In some embodiments, computer system 600 establishes different internal dialogues (e.g., as further described below) based on different inputs (e.g., input indicating the grandmother will establish a different internal dialogue than input indicating grandfather).

FIG. 9 is a flow diagram illustrating a method for displaying a portion of interest based on context using a computer system in accordance with some embodiments. Process 900 is performed at a computer system (e.g., 100, 200, and/or 600). Some operations in process 900 are, optionally, combined, the orders of some operations are, optionally, changed, and some operations are, optionally, omitted.

As described below, process 900 provides an intuitive way for displaying a portion of interest based on context. The method reduces the cognitive burden on a user for displaying a portion of interest based on context, thereby creating a more efficient human-machine interface. For battery operated computing devices, enabling a user to display a portion of interest based on context faster and more efficiently conserves power and increases the time between battery charges.

In some embodiments, process 900 is performed at a computer system (e.g., 600) that is in communication with one or more output devices (e.g., a speaker, a haptic output device, a display screen, a projector, and/or a touch-sensitive display), a display component (e.g., a display screen, a projector, and/or a touch-sensitive display), and one or more cameras (e.g., a telephoto, wide angle, and/or ultra-wide angle camera). In some embodiments, the computer system is a watch, a phone, a tablet, a fitness tracking device, a processor, a head-mounted display (HMD) device, a communal device, a media device, a speaker, a television, and/or a personal computing device.

While outputting (e.g., displaying, outputting audio and/or outputting haptic output) a representation of a field-of-view of one or more cameras (e.g., 806), the computer system detects (902) a request (e.g., 805a, 805d1, and/or 805d2) concerning content in the field-of-view of the one or more cameras.

In response to (904) detecting the request concerning content in the field-of-view of the one or more cameras, in accordance with (906) a determination that a first portion of content (e.g., 812, 814, and/or 818) is a portion of interest based on the context of the request (e.g., 805a, and/or 805d1) (e.g., the topic, the subject matter of, and the timing of the request, how the request was received, what type of input was detected for detecting the request, and/or how the computer system was operating while, after, and/or before detecting the request) outputting an indication (e.g., audio, visual, and/or haptic indication) that the first portion of content is the portion of interest (e.g., as described above at FIGS. 8C-8D); and, in accordance with a determination that a second portion of content (e.g., 812, 814, and/or 818) is the portion of interest based on the context of the request (e.g., 805a, 805d1, and/or 805d2), the computer system outputs (908) an indication that the second portion of content is the portion of interest (e.g., as described above at FIGS. 8C-8D) (and, in some embodiments, without outputting the indication that another portion of content (e.g., the first portion of content, the second portion of content, and/or another portion of content) is the portion of interest). In some embodiments, in accordance with a determination that the first portion of content (e.g., the second portion of content, or the other portion of content) is not a portion of interest based on the context of the request, the computer system does not output the indication that the first portion of content (e.g., the second portion of content, or the other portion of content) is the portion of interest. Outputting an indication that a first portion of content is the portion of interest in accordance with a determination that the first portion of content is a portion of interest based on the context of the request and outputting an indication that a second portion of content is the portion of interest in accordance with a determination that the second portion of content is the portion of interest based on the context of the request allows the computer system to enhance user engagement and increase accessibility and reduce cognitive load by supporting a streamlined navigation (or control) of different portions of content in the representation of the field-of-view while engaging with a user, thereby providing improved visual feedback to the user, reducing the number of inputs needed to perform an operation, and performing an operation when a set of conditions has been met without requiring further user input.

In some embodiments, the request (e.g., 805a, 805d1, and/or 805d2) is a first request (e.g., 805a, 805d1, and/or 805d2). In some embodiments, while (and/or when, before, and/or after) outputting an indication that the first portion of content (e.g., 812, 814, and/or 818) is the portion of interest, the computer system detects a second request (e.g., 805a, 805d1, and/or 805d2) concerning content in the field-of-view of the one or more cameras. In some embodiments, in response to detecting the second request (e.g., 805a, 805d1, and/or 805d2) (e.g., verbal request (e.g., 805a and/or 805d1)) concerning content in the field-of-view of the one or more cameras and in accordance with a determination that a third portion of content (e.g., 812, 814, and/or 818) is the portion of interest based on the context of the second request, the computer system outputs the indication that the third portion of content is the portion of interest (e.g., as described above at FIGS. 8C-8D). In some embodiments, in accordance with a determination that the third portion of content is not a portion of interest based on the context of the request, the computer system does not display the indication that the third portion of content is the portion of interest. In some embodiments, outputting an indication that the third portion of content is the portion of interest follows (e.g., and indicates) a progression within a user interface flow of a computer system application (e.g., that includes the first portion of content (e.g., the first portion of content and the third portion of content are portions of the same computer system application)) (e.g., that does not include the first portion of content (e.g., the first portion of content and the third portion of content are portions of different computer system applications)) in the representation of the field-of-view. In some embodiments, outputting an indication that the third portion of content is the portion of interest includes updating output of an indication that the first portion of content is the portion of interest (e.g., ceasing outputting, or deemphasizing an indication that the first portion of content is the portion of interest). In some embodiments, outputting an indication that the third portion of content is the portion of interest does not includes updating output of an indication that the first portion of content is the portion of interest. In some embodiments, the computer system outputs an indication that the third portion of content is the portion of interest concurrently with an indication that the first portion of content is the portion of interest. Outputting the indication that the third portion of content is the portion of interest in response to detecting the second request concerning content in the field-of-view of one or more cameras and in accordance with a determination that a third portion of content is the portion of interest based on the context of the second request allows the computer system to further enhance user engagement and improve accessibility by actively updating the portion of interest depending on a user's request(s), thereby providing improved visual feedback to the user, reducing the number of inputs needed to perform an operation, and performing an operation when a set of conditions has been met without requiring further user input.

In some embodiments, outputting the indication includes displaying, via the display component, a representation of a face (e.g., 802) (e.g., a face of a lifelike human avatar, a cartoon character, a stylized emoji, a 3D animated character, a celebrity lookalike, an animal, or an abstract geometric shape, among others). In some embodiments, the representation of the face includes an indicator directed at (e.g., eyes looking in the direction of) the portion of interest. Having outputting the indication include displaying a representation of a face allows the computer system to enhance user engagement and provide a deepened sense of connection and familiarity to a user by drawing attention to (indicating) the portion of interest through a representation of a face, thereby providing improved visual feedback to the user, reducing the number of inputs needed to perform an operation, and performing an operation when a set of conditions has been met without requiring further user input.

In some embodiments, in response to detecting the request concerning content in the field-of-view of the one or more cameras, the computer system outputs the indication that the first portion of content (e.g., 812, 814, and/or 818) is the portion of interest includes displaying, via the display component, a representation of a face (e.g., 802) that is directed to (e.g., looks at, looks toward, turned toward, gestured toward, pointing in the direction of, gazing at, focused on, and/or is directed toward) the portion of interest. In some embodiments, in accordance with a determination that a user interface object in the field-of-view is the portion of interest based on the context of the request, the representation of the face looks directly at the user interface object. In some embodiments, the representation of the face follows the movement of the portion of interest in the field-of-view (and/or in a media playback). In some embodiments, the representation of the face looks where the user is looking in the field-of-view. In some embodiments, the representation of the face changes from not being in a first direction to being in the first direction in response to detecting the request concerning content in the field-of-view of the one or more cameras. Outputting the indication that the first portion of content is the portion of interest including displaying a representation of a face that is directed to the portion of interest in response to detecting the request concerning content in the field-of-view of the one or more cameras provides the computer system with enhanced user engagement by actively adapting the representation of the face to emphasize (indicate, point to, draw attention to) the portion of interest in the field-of-view, thereby providing improved visual feedback to the user, reducing the number of inputs needed to perform an operation, and performing an operation when a set of conditions has been met without requiring further user input.

In some embodiments, outputting the indication that the first portion of content (e.g., 812, 814, and/or 818) is the portion of interest includes displaying, via a display component, a representation of the face (e.g., 802) that is directed to the portion of interest. In some embodiments, after outputting the indication that the first portion of content (e.g., 812, 814, and/or 818) is the portion of interest and in accordance with a determination that a threshold period of time has passed (e.g., without detecting a request) (e.g., since outputting the indication that the first portion of content is the portion of interest and/or since identifying the portion of interest), the computer system updates display, via the display component, of the representation of the face (e.g., 802) that is directed to (e.g., looks at, looks toward, turned toward, gestured toward, pointing in the direction of, gazing at, focused on, and/or is directed toward) the portion of interest to be directed away (e.g., shifted from, turned away from, and/or reverted from) from the portion of interest. In some embodiments, the threshold period of time (e.g., 0.1-100 seconds) is a default period of time. In some embodiments, the representation of the face is looking at the user. In some embodiments, the representation of the face is looking at a default direction in the field-of-view. In some embodiments, the representation of the face is looking outside of the field-of-view. In some embodiments, the representation of the face is looking at a point inside the field-of-view. In some embodiments, the representation of the face is looking at a third portion of the content different from the first portion and the second portion of content. Updating display of the representation of the face that is directed to the portion of interest to be directed away from the portion of interest after outputting the indication that the first portion of content is the portion of interest and in accordance with a determination that a threshold period of time has passed provides the computer system with enhanced realism by mimicking real human interaction that promotes a more natural and engaging user experience and improved engagement by having the representation of the face look at different portions of content based on the user's needs and/or interests without the need for an explicit request, thereby providing improved visual feedback to the user, reducing the number of inputs needed to perform an operation, and performing an operation when a set of conditions has been met without requiring further user input.

In some embodiments, outputting, via the one or more output devices, the indication that the first portion of content (e.g., 812, 814, and/or 818) (e.g., or the second portion of content) is the portion of interest includes outputting, via the one or more output devices, audio including an indication that the first portion of content is the portion of interest (e.g., outputting a sound indicating the detection of the portion of interest) (e.g., outputting a sound identifying the portion of interest) (e.g., stating the location of the portion of interest within the field-of-view) (e.g., stating the type of the portion of interest (e.g., the shape and/or the object type and/or characteristics of the portion of interest)) (e.g., narrating text displayed on the portion of interest). In some embodiments, outputting, via the one or more output devices, the indication that the second portion of content is the portion of interest includes outputting, via the one or more output devices, another audio (e.g., different from the audio including an indication that the first portion of content is the portion of interest) including an indication that the second portion of content is the portion of interest. Having outputting the indication that the first portion of content is the portion of interest include outputting audio including an indication that the first portion of content is the portion of interest allows the computer system to increase user engagement and accessibility by supporting the indication of the portion of interest with audio output, thereby reducing the number of inputs needed to perform an operation, and performing an operation when a set of conditions has been met without requiring further user input.

In some embodiments, outputting the indication that the first portion of content (e.g., 812, 814, and/or 818) is the portion of interest includes displaying, via the display component, a user interface object (e.g., as described above in relation to process 700 and process 1000-process 1200) closer to the first portion than the second portion (e.g., as described above in relation to process 700 and process 1000-process 1200); and wherein outputting the indication that the second portion of content (e.g., 812, 814, and/or 818) is the portion of interest includes displaying, via the display component, the user interface object closer to the second portion than the first portion (e.g., as described above in relation to process 700 and process 1000-process 1200). In some embodiments, in accordance with a determination that a first location is at a first distance from the portion of interest shorter than a second distance from a second location or a third distance from a third location, the computer system displays the user interface object at the first location. Having outputting the indication that the second portion of content is the portion of interest include displaying the user interface object closer to the second portion than the first portion allows the computer system to provide an intuitive user experience and aligning with natural human perception and expectations by displaying the user interface object closer to the portion of interest than to other portions of content in the field-of-view, thereby providing improved visual feedback to the user, reducing the number of inputs needed to perform an operation, and performing an operation when a set of conditions has been met without requiring further user input.

In some embodiments, in accordance with a determination that an empty (negative, dead) space (e.g., as described above) is at a first location in the content (e.g., 810) that is within a threshold distance from the portion of interest, outputting an indication that the first portion of content (e.g., 812, 814, and/or 818) is the portion of interest includes displaying, via the display component, a second user interface object at the first location. In some embodiments, in accordance with a determination that the empty (negative, dead) space (e.g., as described above) is not at the first location within a threshold distance from the portion of interest, outputting the indication that the first portion of content (e.g., 812, 814, and/or 818) is the portion of interest does not include displaying, via the display component, the indication at the first location. In some embodiments, in accordance with a determination that an empty space is not at the first location and that an empty space is at a second location, outputting the indication that the first portion of content is the portion of interest includes displaying the second user interface object at the second location. In some embodiments, in accordance with a determination that an empty space is at the first location and that an empty space is not at a second location, outputting the indication that the first portion of content is the portion of interest includes displaying the second user interface object at the first location. In some embodiments, the computer system determines empty (e.g., non-important, negative, dead) space as a location (area) in the representation of the field-of-view that does not contribute to the overall user experience having low content relevance to a user (e.g., areas with excessive white space or gaps). In some embodiments, the computer system determines empty (e.g., non-important, negative, dead) space as a location (area) in the representation of the field-of-view where the user is inactive (not interacting with) for a threshold period of time. Having outputting the indication include displaying a second user interface at the first location in accordance with a determination that an empty space is at a first location in the content that is within a threshold distance from the portion of interest and having outputting the indication not include displaying the indication at the first location in accordance with a determination that the empty space is not at the first location within a threshold distance from the portion of interest allows the computer system to maximize the usability of the representation of the field-of-view and enhance content relevance by managing the presence or absence of empty spaces in proximity to the portion of interest and displaying the second user interface object at the optimal location, thereby providing improved visual feedback to the user, reducing the number of inputs needed to perform an operation, and performing an operation when a set of conditions has been met without requiring further user input.

In some embodiments, outputting the representation of the field-of-view of the one or more cameras includes providing audio output. In some embodiments, in accordance with a determination that the audio output includes a first set of one or more characteristics (e.g., first voice, a first content, a first language, a first pitch, a first volume, a first rhythm and/or a first tempo), the computer system animates, via the one or more output devices, the indication that the first portion of content (e.g., 812, 814, and/or 818) is in a first manner. In some embodiments, in accordance with a determination that the audio output includes a second set of one or more characteristics different from the first set of one or more characteristics, the computer system animates, via the one or more output devices, the indication that the first portion of content (e.g., 812, 814, and/or 818) is the portion of interest in a second manner, different from the first manner(e.g., with a first hue, saturation, intensity, tone, amount of boldness, amount of opacity, amount of zoom, amount of emphasis, amount of highlighting, amount of margin, alignment, outline, position, border style, animation, transform, background color, and/or size). In some embodiments, in accordance with a determination that the audio output includes a first set of one or more characteristics, displaying, via the one or more output devices, an indication that the second portion of content is the portion of interest in a first manner. in accordance with a determination that the audio output includes a second set of one or more characteristics different from the first set of one or more characteristics, displaying, via the one or more output devices, an indication that the second portion of content is the portion of interest in a second manner, different from the first manner. Displaying an indication that the first portion of content is the portion of interest in a first manner in accordance with a determination that the audio output includes a first set of one or more characteristics and displaying an indication that the first portion of content is the portion of interest in a second manner that is different from the first manner in accordance with a determination that the audio output includes a second set of one or more characteristics, different from the first set of one or more characteristics allows the computer system to create a more engaging and interactive user experience and enhance accessibility by synchronizing the visual indication of the portion of interest with audio output, thereby reducing the number of inputs needed to perform an operation, and performing an operation when a set of conditions has been met without requiring further user input.

In some embodiments, the request (e.g., 805a, 805d1, and/or 805d2) is a first request. In some embodiments, while outputting the representation of the field-of-view of one or more cameras (e.g., 806), the computer system detects a third request (e.g., 805a, 805d1, and/or 805d2) concerning content (e.g., 810) in the field-of-view of the one or more cameras. In some embodiments, in response to detecting the third request (e.g., 805a, 805d1, and/or 805d2) concerning content (e.g., 810) in the field-of-view of the one or more cameras, in accordance with a determination that the first portion of content is the portion of interest (e.g., the portion of interest in a subset of the portion of interest) based on the context of the third request (e.g., 805a, 805d1, and/or 805d2), the computer system visually modifies the first portion of content (e.g., without visually modifying the second portion of content) (e.g., as described in relation to process 1100). In some embodiments, in response to detecting the third request concerning content in the field-of-view of the one or more cameras, in accordance with a determination that the second portion of content (e.g., 812, 814, and/or 818) is the portion of interest (e.g., the portion of interest in a subset of the portion of interest) based on the context of the third request (e.g., 805a, 805d1, and/or 805d2), the computer system visually modifies the first portion of content (e.g., as described in relation to process 1100) (e.g., without visually modifying the first portion of content). In some embodiments, the additional content is overlayed on the field-of-view. In some embodiments, the additional content is not a portion of the field-of-view. Visually modifying the first portion of content in accordance with a determination that the first portion of content is the portion of interest based on the context of the third request and visually modifying the first portion of content in accordance with a determination that the second portion of content is the portion of interest in response to detecting the third request concerning content in the field-of-view allows the computer system to visually support the portion of interest with relevant content based on a user's need, thereby providing improved visual feedback to the user, reducing the number of inputs needed to perform an operation, and performing an operation when a set of conditions has been met without requiring further user input.

In some embodiments, in accordance with a determination that the portion of interest is displayed with a first set of one or more visual characteristics (e.g., a first visual style), the computer system visually modifies the portion of interest with the first set of one or more visual characteristics (e.g., as described above at FIGS. 8B-8E). In some embodiments, in accordance with a determination that the portion of interest is displayed with a second set of one or more visual characteristics (e.g., a second visual style), that is different from the first set of one or more visual characteristics, the computer system visually modifies the portion of interest with the second set of one or more visual characteristics (e.g., with a second hue, saturation, intensity, tone, amount of boldness, amount of opacity, amount of zoom, amount of emphasis, amount of highlighting, amount of margin, alignment, outline, position, border style, animation, transform, background color, and/or size) (e.g., as described above at FIGS. 8B-8E). Allows the computer system to enhance user experience by visually adjusting the portion of interest in a cohesive and a visually pleasing manner that aligns with the relevant portion of interest in the field-of-view, thereby providing improved visual feedback to the user, reducing the number of inputs needed to perform an operation, and performing an operation when a set of conditions has been met without requiring further user input.

In some embodiments, outputting the portion of interest includes displaying the portion of interest in a third set of one or more visual characteristics (e.g., with a third hue, saturation, intensity, tone, amount of boldness, amount of opacity, amount of zoom, amount of emphasis, amount of highlighting, amount of margin, alignment, outline, position, border style, animation, transform, background color, and/or size). In some embodiments, the third set of one or more visual characteristics is a default set of one or more visual characteristics (e.g., including a default visual style) that are determined by a setting (e.g., a system style and/or not based on the style of the portion of interest) (e.g., as described above at FIGS. 8B-8E). In some embodiments, the third set of one or more visual characteristics is pre-configured by a user of the computer system. Displaying the portion of interest in a third set of one or more visual characteristics as a part of outputting the portion of interest allows the computer system to provide a consistent user experience and increase accessibility by adjusting the portion of interest in an expected visual style that is familiar to the user, thereby providing improved visual feedback to the user, reducing the number of inputs needed to perform an operation, and performing an operation when a set of conditions has been met without requiring further user input.

In some embodiments, outputting the additional content (e.g., 810) includes emphasizing the additional content (e.g., as described above at FIGS. 8B-8E). In some embodiments, emphasizing the additional content includes using color contrasting, and/or highlighting, and/or bolding, and/or underlining, and/or increasing the size of content, and/or adding animations, and/or encapsulation in a distinct container, and/or adding arrows and pointers, and/or dimming or blurring the other portions of content, adding haptic cues, and/or adding audio cues. Emphasizing the additional content as a part of outputting the additional content allows the computer system to enhance user engagement and improve accessibility by visually drawing attention to the additional content that is not easily discernable otherwise, thereby providing improved visual feedback to the user, reducing the number of inputs needed to perform an operation, and performing an operation when a set of conditions has been met without requiring further user input.

In some embodiments, outputting the additional content (e.g., 810) includes outputting audio concerning the context of the third request (e.g., 805a, 805d1, and/or 805d2). In some embodiments, audio output includes an audio description of the modification, and/or voice feedback on the modification, and/or sound effects corresponding to the modification. Outputting audio as a part of outputting the additional content allows the computer system to increase user engagement and improve accessibility by signaling content modification using audio output, thereby reducing the number of inputs needed to perform an operation, and performing an operation when a set of conditions has been met without requiring further user input.

Note that details of the processes described above with respect to process 900 (e.g., FIG. 9) are also applicable in an analogous manner to the methods described below/above. For example, process 700 optionally includes one or more of the characteristics of the various methods described above with reference to process 900. For example, the computer system can use one or more techniques of process 700 to move an amount to capture more content using one or more techniques of process 900. For brevity, these details are not repeated below.

FIG. 10 is a flow diagram illustrating a method for displaying an object closer to content using a computer system in accordance with some embodiments. Process 1000 is performed at a computer system (e.g., 100, 200, and/or 600). Some operations in process 1000 are, optionally, combined, the orders of some operations are, optionally, changed, and some operations are, optionally, omitted.

As described below, process 1000 provides an intuitive way for displaying an object closer to content. The method reduces the cognitive burden on a user for displaying an object closer to content, thereby creating a more efficient human-machine interface. For battery operated computing devices, enabling a user to display an object closer to content faster and more efficiently conserves power and increases the time between battery charges.

In some embodiments, process 1000 is performed at a computer system (e.g., 600) that is in communication with one or more output devices (e.g., a speaker, a haptic output device, a display screen, a projector, and/or a touch-sensitive display) including a display component (e.g., a display screen, a projector, and/or a touch-sensitive display), and one or more cameras (e.g., a telephoto, wide angle, and/or ultra-wide angle camera). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more input devices (e.g., a touch-sensitive display, a rotatable input mechanism, a camera (e.g., a telephoto, wide angle, and/or ultra-wide angle camera), and/or a sensor (e.g., a gyroscope and/or a heart rate sensor)). In some embodiments, the computer system is in communication with a movement component (e.g., an actuator, a motor, an electronic arm, a lift, and/or a lever).

While displaying, via the display component, a representation of a field-of-view of one or more cameras (e.g., 806) (e.g., the extent of a viewable scene, and/or the scope of visual capture), the computer system detects (1002) a request (e.g., 805a and/or 805d1) corresponding to content (e.g., 810) (e.g., a first type of content and/or content that includes particular content (e.g., physical content and/or content on a first device, different from the computer system)) in the field-of-view of the one or more cameras.

In response to detecting the request (e.g., 805a and/or 805d1) corresponding to the content (e.g., 810) in the field-of-view of the one or more cameras, the computer system displays (1004), via the display component, a user interface object (e.g., 802) (e.g., a user-interface element, a representation of a software application, an avatar, a system avatar, a menu, and/or a button) closer to a first portion of the content (e.g., 812, 814, and/or 818) than a second portion of the content (e.g., 812, 814, and/or 818) (e.g., as described above at FIGS. 8D-8E).

While displaying the user interface object (e.g., 802) closer to the first portion of the content (e.g., 812, 814, and/or 818) than the second portion of the content (e.g., 812, 814, and/or 818), the computer system detects (1006) an air gesture (e.g., 805d2) (e.g., pointing, touching, clicking on, and/or swiping at second portion of content) that corresponds to an input directed to the second portion of the content (e.g., 812, 814, and/or 818).

In response to (1008) detecting the air gesture (e.g., 805d2) that corresponds to the input directed to the second portion of the content (e.g., 812, 814, and/or 818), the computer system displays (1010), via the display component, the user interface object (e.g., 802) closer to the second portion of the content (e.g., 812, 814, and/or 818) than the first portion of the content (e.g., 812, 814, and/or 818).

In response to (1008) detecting the air gesture that corresponds to the input directed to the second portion of the content, the computer system outputs (1012), via the one or more output devices, a first set of one or more indications (e.g., a representation of the second portion of content is bolded, highlighted, and/or emphasized) that (e.g., that indicate that, that says that, that means that, and/or that represents that) the second portion of the content (e.g., 812, 814, and/or 818) is currently a portion of interest. In some embodiments, the request corresponding to the field-of-view of the one or more cameras is an input (e.g., a tap input and/or a non-tap input (e.g., a verbal input, an audible request, an audible command, an audible statement, a swipe input, a hold-and-drag input, a gaze input, an air gesture, and/or a mouse click)). Outputting the first set of one or more indications that the second portion of content is currently the portion of interest and displaying the user interface object closer to the second portion of content in response to detecting the air gesture that corresponds to the input directed to the second portion of the content enables the computer system to display an object closer to the most recently interacted content and indicate the content is a portion of interest, thereby reducing the number of inputs needed to perform the operation, performing an operation when a set of conditions have been met without requiring further user input and/or providing improved visual feedback to the user.

In some embodiments, before detecting the air gesture (e.g., 805d2) and while displaying, via the display component, the user interface object (e.g., 802) closer to the first portion of the content (e.g., 812, 814, and/or 818) than the second portion of the content (e.g., 812, 814, and/or 818), the first portion of the content is currently the portion of interest. In some embodiments, the first portion of content is currently the portion of interest when the user interface object is displayed closer to the first portion of the content than the second portion of content. In some embodiments, the user interface object is displayed closer to the first portion of content (e.g., before the air gesture and/or before displaying the user interface object closer to the second portion of content than the first portion of content) than the second portion of content in accordance with a determination that the first portion of content is currently the portion of interest. In some embodiments, displaying, via the display component, the user interface object closer to the second portion of the content than the first portion of the content includes ceasing to display, via the display component, the user interface object closer to the first portion of the content than the second portion of the content. In some embodiments, outputting the first set of one or more indications that the second portion of the content is currently the portion of interest includes ceasing outputting the first portion of the content is currently the portion of interest. Outputting the first set of one or more indications that the second portion of content is currently the portion of interest and displaying the user interface object closer to the second portion of content in response to detecting the air gesture that corresponds to the input directed to the second portion of the content after the first portion of the content is currently the portion of interest and displaying the user interface object closer to the first portion of the content than the second portion of the content enables the computer system to automatically move an object to the most recently interacted content and indicate the content is a portion of interest, thereby reducing the number of inputs needed to perform the operation, performing an operation when a set of conditions have been met without requiring further user input and/or providing improved visual feedback to the user.

In some embodiments, in response to detecting the request (e.g., 805a and/or 805d1) corresponding to the content (e.g., 810) in the field-of-view of the one or more cameras, the computer system outputs, via the one or more output devices, a second set of one or more indications, different from the first set of one or more indications, that the first portion of the content (e.g., 812, 814, and/or 818) is currently the portion of interest. In some embodiments, in response to detecting the air gesture that corresponds to the input directed to the second portion of the content, the computer system outputs, via the one or more output devices, a respective set of one or more indications, different from the first set of one or more indications, that the first portion of content is currently the portion of interest. Outputting the second set of one or more indications that the first portion of the content is currently the portion of interest in response to detecting the request corresponding to the content in the field-of-view of the one or more cameras enables the computer system to automatically output which portion of the content that is currently the portion of interest based on interactions as directed by the user, thereby reducing the number of inputs needed to perform the operation, performing an operation when a set of conditions have been met without requiring further user input and/or providing improved visual feedback to the user.

In some embodiments, the first set of one or more indication includes a first suggestion of a first suggestion type. In some embodiments, the second set of one or more indications includes a second question of a second question type, different from the first type (e.g., as described above at FIGS. 8A-8E). In some embodiments, the second set of one or more indications that the first portion of content is currently the portion of interest includes the first type of modification of the portion of interest. In some embodiments, the first set of one or more indications that the second portion of content is currently the portion of interest includes the second suggestion of the second type of modification, different from the first type of modification, of the portion of interest. In some embodiments, the second suggestion is different from the first suggestion (e.g., does not include the first suggestion, and/or includes additional suggestions not included in the first suggestion). In some embodiments, the first set of one or more indications that the second portion of content is currently the portion of interest is different from the second set of one or more indications that the first portion of content is currently the portion of interest. In some embodiments, outputting the first suggestion of the first type of modification includes the displaying the first suggestion of the first type of modification. In some embodiments, outputting the second suggestion of the second type of modification includes displaying the second suggestion of the second type of modification. In some embodiments, in response to detecting the portion of interest change from the first portion of content to the second portion of content, the computer system outputs the second suggestion of the second type of modification of the portion of interest includes ceasing to output the first suggestion of the first type of modification of the portion of interest. In some embodiments, outputting the first suggestion of the first type of modification of the portion of interest includes outputting the first suggestion of the first type of modification of the portion of interest while displaying, via the display component, the user interface object closer to the first portion of the content than the second portion of the content. In some embodiments, outputting the second suggestion of the second type of modification of the portion of interest includes outputting the second suggestion of the second type of modification of the portion of interest while outputting the first set of one or more indications that the second portion of the content is currently the portion of interest.

In some embodiments, the second set of one or more indication includes a first question of a first question type associated with the portion of interest. In some embodiments, the first set of one or more indications includes a second question of a second question type, different from the first type, associated with the portion of interest (e.g., as described above at FIGS. 8A-8E). In some embodiments, in response to detecting the request corresponding to the content in the field-of-view of the one or more cameras, the computer system outputs, via the one or more output devices, the first question of a first question type associated with the portion of interest, and in response to detecting the air gesture that corresponds to the input directed to the second portion of interest, the computer system outputs, via the one or more output devices, a second question of a second question type, different from the first type, associated with the portion of interest. In some embodiments, the first question is different from the second question (e.g., are different questions and/or cover different topics). In some embodiments, outputting the first question of the first type associated with the portion of interest includes the computer system outputting the second suggestion of the second type of modification of the portion of interest while displaying, via the display generation component, the user interface object closer to the first portion of the content than the second portion of the content. In some embodiments, outputting the second question of the second type associated with the portion of interest includes the computer system outputs the second question of the second type associated with the portion of interest while outputting the first set of one or more indications that the second portion of the content is currently the portion of interest.

In some embodiments, in response to detecting the air gesture (e.g., 805d2) that corresponds to the input directed to the second portion of the content (e.g., 812, 814, and/or 818), the computer system outputs, via the one or more output devices, a third set of one or more indications (e.g., displaying the first portion of interest without bold, highlight, or emphasis), different from the first set of one or more indications, that (e.g., that indicate that, that says that, that means that, and/or that represents that) the first portion is not (and/or no longer) the portion of interest (e.g., as described above at FIGS. 8A-8E). In some embodiments, while displaying the user interface object closer to the first portion of content than the second portion of content, the computer system outputs, via the one or more output devices, a fourth set of one or more indications that the first portion of content is currently the portion of interest, and wherein the third set of one or more indications that the first portion is not the portion of interest includes an indication that the first portion is no longer the portion of interest. Outputting a third set of one or more indications that the first portion is not the portion of interest in response to detecting the air gesture that corresponds to the input directed to the second portion of the content enables the computer system to output that the portion of interest is no longer the first portion as directed by the user, thereby reducing the number of inputs needed to perform the operation, and/or providing improved visual feedback to the user.

In some embodiments, in response to detecting the air gesture (e.g., 805d2) that corresponds to the input directed to the second portion of the content (e.g., 812, 814, and/or 818), the computer system ceases displaying, via the display component, the user interface object (e.g., 802) closer to the first portion of the content (e.g., 812, 814, and/or 818) than the second portion of the content. Ceasing displaying the user interface object closer to the first portion of the content than the second portion of the content in response to detecting the air gesture that corresponds to the input directed to the second portion of the content enables the computer system to remove the suggestion from the first portion when inputs are directed to the second portion of content, thereby reducing the number of inputs needed to perform the operation, and/or providing improved visual feedback to the user.

In some embodiments, the user interface object (e.g., 802) is a first user interface object. In some embodiments, in response to detecting the air gesture (e.g., 805d2) that corresponds to the input directed to the second portion of the content (e.g., 812, 814, and/or 818), the computer system displays, via the display component, a second user interface object (e.g., 802) corresponding to a third suggestion (e.g., additional content different from or the same as the first portion of content, and/or modifications to the first portion of content) to the second portion of content (and, in some examples, the computer system ceases displaying the first user interface object) (e.g., as described above at FIGS. 8A-8E). Displaying a second user interface object corresponding to a third suggestion to the second portion of content in response to detecting the air gesture that corresponds to the input directed to the second portion of the content enables the computer system to add visual suggestions to portions of the content as directed by the user, thereby reducing the number of inputs needed to perform the operation, and/or providing improved visual feedback to the user.

In some embodiments, in response to detecting the air gesture (e.g., 805d2) that corresponds to the input directed to the second portion of the content (e.g., 812, 814, and/or 818), the computer system ceases displaying, via the display component, the first user interface object (e.g., 802), wherein the first user interface object is different from the second user interface object (e.g., 802). Not displaying the first user interface object in response to detecting the air gesture that corresponds to the input directed to the second portion of the content enables the computer system to keep the display free of clutter and cease displaying the portion of content as directed by the user, thereby providing improved visual feedback to the user.

In some embodiments, outputting the first set of one or more indications includes displaying a representation of a face (e.g., 802) in a first state. In some embodiments, in response to detecting an additional air gesture, different from the air gesture, the computer system changes the face from the first state to the second state different from the first state. In some embodiments, the face is of a character and/or a system avatar. In some embodiments, the character is an entity exhibiting various movement patterns. In some embodiments, the representation of the face includes one or more eyes, a mouth, and/or a nose. In some embodiments, the overlay includes a representation of a body (e.g., one or more hands, one or more feet, one or more arms, one or more legs, and/or a torso). In some embodiments, the representation of the face in the first state includes an expression via one or more facial features (e.g., eyes and/or mouth), a look direction via one or more eyes, and/or a mouth animating an indication of one or more words. Outputting the first set of one or more indications including a representation of a face in a first state that the second portion of content is currently the portion of interest and displaying the user interface object closer to the second portion of content in response to detecting the air gesture that corresponds to the input directed to the second portion of the content enables the computer system to display an object closer to the most recently interacted content and indicate via a representation of a face the content is a portion of interest, thereby reducing the number of inputs needed to perform the operation, performing an operation when a set of conditions have been met without requiring further user input and/or providing improved visual feedback to the user.

In some embodiments, after displaying the representation of the face (e.g., 802) in the second state, and in accordance with a determination that a threshold period of time has passed since displaying the representation of the face in the second state (and in some embodiments, without the computer system detecting an additional input, and/or without the computer system detecting an additional input directed to a different portion of content than the second portion of content), the computer system displays the representation of the face in a third state (e.g., the representation of the face faces a first user (e.g., a user, a person, an animal, another computer system different from the computer system, and/or an object), and/or a direction different from the first state), different from the second state (and, in some embodiments, different from the first state). Displaying the representation of the face in the third state after displaying the representation of the face in the second state in accordance with a determination that a threshold period of time has passed since displaying the representation of the face in the second state enables the computer system to automatically indicate the portion of interest via the representation of the face, thereby reducing the number of inputs needed to perform an operation and providing improved visual feedback to the user.

In some embodiments, the representation of the face (e.g., 802) in the third state is directed to a second user (e.g., a user, a person, an animal, another computer system different from the computer system, and/or an object) (and, in some examples, in the field-of-view of the one or more cameras). In some embodiments, the direction is towards the display component.

In some embodiments, the representation of face in the third state includes the representation of the face (e.g., 802) directed towards a portion of content (e.g., 812, 814, and/or 818) that is different from the second portion of the content (e.g., the first portion of content and/or a different portion of content).

In some embodiments, before detecting the air gesture (e.g., 805d2) (and, in some examples, while the computer system displays, via the display component, the user interface object closer to the first portion of the content than the second portion of the content) the computer system outputs the first set of one or more indications includes the representation of the face in a fourth state. In some embodiments, the representation of the face in the fourth state includes the representation of the face directed towards (e.g., directing gaze at a target, focus attention in a direction, and/or aiming vision at a point) the first portion of the content (e.g., 812, 814, and/or 818), and wherein the first state includes the representation of the face directed towards (e.g., directing gaze at a target, focus attention in a direction, and/or aiming vision at a point) the second portion of content (e.g., 812, 814, and/or 818). Outputting the first set of one or more indications includes the representation of the face in a fourth state before detecting the air gesture enables the computer system to automatically change the portion of interest via the representation of the face, thereby reducing the number of inputs needed to perform an operation and providing improved visual feedback to the user.

Note that details of the processes described above with respect to process 1000 (e.g., FIG. 10) are also applicable in an analogous manner to the methods described below/above. For example, process 1100 optionally includes one or more of the characteristics of the various methods described above with reference to process 1000. For example, the computer system can use one or more techniques of process 1100 to add a suggestion to add an object to content using one or more techniques of process 1000. For brevity, these details are not repeated below.

FIG. 11 is a flow diagram illustrating a method for outputting a suggestion to add an object using a computer system in accordance with some embodiments. Process 1100 is performed at a computer system (e.g., 100, 200, and/or 600). Some operations in process 1100 are, optionally, combined, the orders of some operations are, optionally, changed, and some operations are, optionally, omitted.

As described below, process 1100 provides an intuitive way for outputting a suggestion to add an object. The method reduces the cognitive burden on a user for outputting a suggestion to add an object, thereby creating a more efficient human-machine interface. For battery operated computing devices, enabling a user to output a suggestion to add an object faster and more efficiently conserves power and increases the time between battery charges.

In some embodiments, process 1100 is performed at a computer system (e.g., 600) that is in communication with one or more output devices (e.g., a speaker, a haptic output device, a display screen, a projector, and/or a touch-sensitive display) including a display component (e.g., a display screen, a projector, and/or a touch-sensitive display) and one or more cameras (e.g., a telephoto, wide angle, and/or ultra-wide angle camera). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more input devices (e.g., a touch-sensitive display, a rotatable input mechanism, a camera (e.g., a telephoto, wide angle, and/or ultra-wide-angle camera), and/or a sensor (e.g., a gyroscope and/or a heart rate sensor)). In some embodiments, the computer system is in communication one or more output devices (e.g., a speaker, a haptic output device, a display screen, a projector, and/or a touch-sensitive display). In some embodiments, the computer system is in communication with a movement component (e.g., an actuator, a motor, an electronic arm, a lift, and/or a lever).

While displaying, via the display component, a representation (e.g., a graphical representation, image, and/or user interface element) of a field-of-view of the one or more cameras (e.g., 806), the computer system detects (1102) a request (e.g., 805a, 805d1, and/or 805d2) (e.g., an input, a tap, and/or a non-tap input (e.g., an air gesture and/or voice input)) corresponding to content (e.g., 810) (e.g., features, characteristics, objects, and/or work product) in the field-of-view of the one or more cameras, wherein the representation of the field-of-view of the one or more cameras includes the content.

In response to (1104) detecting the request (e.g., 805a, 805d1, and/or 805d2) corresponding to content (e.g., 810) in the field-of-view of the one or more cameras (e.g., 806), in accordance with a determination that the content (e.g., 810) includes a first set of one or more characteristics (e.g., a color, scene (e.g., countryside, city, and/or mountains), environment of the content (e.g., a beach, library, office, and/or factory floor) style (e.g., pattern, design, and/or art type (e.g., abstract, pop art, surrealism, and/or finger paint)), and/or one or more objects), the computer system outputs (1106), via the one or more output devices, a suggestion to add a first object (e.g., 812, 814, and/or 818) (e.g., physical objects, virtual objects, and/or physical manipulations of the content in the field-of-view of the one or more cameras) to the content.

In response to (1104) detecting the request corresponding to content in the field-of-view of the one or more cameras, in accordance with a determination that the content (e.g., 810) includes a second set of one or more characteristics, different from the first set of one or more characteristics, the computer system outputs (1108), via the one or more output devices, a suggestion to add a second object (e.g., 812, 814, and/or 818), different from the first object (e.g., 812, 814, and/or 818), to the content (and, in some embodiments, without outputting the suggestion to add the first object). In some embodiments, outputting includes displaying, via the display component. In some embodiments, the work product includes products, media, objects, and features as determined by where the work product is being used (e.g., a physical space (e.g., a factory floor, design studio, and/or living room), a user (e.g., of the computer system and/or in the field-of-view of the one or more cameras), and/or a usage history (e.g., a pattern of use of the content over a threshold period of time, and/or past inputs directed to the content)) associated with the work product. Outputting the suggestion to add the first object to the content in accordance with a determination that the content includes a first set of one or more characteristics and outputting the suggestion to add the second object to the content in accordance with a determination that the content includes a second set of one or more characteristics and in response to detecting the request corresponding to content in the field-of-view of the one or more cameras enables the computer system to add a suggestion to add an object based on the content in the field-of-view and assist the user with modifying the content, thereby reducing the number of inputs needed to perform an operation, performing an operation when a set of conditions has been met without requiring further user input, and providing improved visual feedback to the user.

In some embodiments, the content (e.g., 810) is physical content (e.g., a physical drawing, physical sculpture, and/or physical painting in the field-of-view of the one or more cameras). In some embodiments, the content is physical content. Outputting the suggestion to add the first object to the content in accordance with a determination that the content includes a first set of one or more characteristics and outputting the suggestion to add the second object to the content in accordance with a determination that the content includes a second set of one or more characteristics and in response to detecting the request corresponding to content in the field-of-view of the one or more cameras enables the computer system to add a suggestion to add an object based on physical content in the field-of-view and assist the user with modifying the content, thereby reducing the number of inputs needed to perform an operation, performing an operation when a set of conditions has been met without requiring further user input, and providing improved visual feedback to the user.

In some embodiments, the content (e.g., 810) is virtual content (e.g., a virtual drawings, virtual sculpture, and/or virtual painting in the field-of-view of the one or more cameras). In some embodiments, the content is virtual content. Outputting the suggestion to add the first object to the content in accordance with a determination that the content includes a first set of one or more characteristics and outputting the suggestion to add the second object to the content in accordance with a determination that the content includes a second set of one or more characteristics and in response to detecting the request corresponding to content in the field-of-view of the one or more cameras enables the computer system to add a suggestion to add an object based on virtual content in the field-of-view and assist the user with modifying the content, thereby reducing the number of inputs needed to perform an operation, performing an operation when a set of conditions has been met without requiring further user input, and providing improved visual feedback to the user.

In some embodiments, the computer system is in communication with a microphone. In some embodiments, the request (e.g., 805a, 805d1, and/or 805d2) corresponding to content (e.g., 810) in the field-of-view of the one or more cameras (e.g., 806) is a verbal request (e.g., 805d1) (e.g., a voice input, and/or audible input), detected via the microphone, corresponding to the content (e.g., 810) in the field-of-view of the one or more cameras. In some embodiments, the verbal request includes an identification (e.g., name, symbol, or feature) of the content. In some embodiments, the verbal request does not include an identification of the content but rather a description that leads to the identification of content (e.g., “a request that says this is a picture of London” and the computer system identifying a box as “Big Ben” based on one or more characteristics of the content; and/or a request that says “I really like eating pizza,” and the computer system identifying a table in a living room in the content as the portion of interest instead of a chair in the living room or a television in the living room; however, if the request said “I really like TV Show 1,” the computer system would identify the television as the portion of interest instead of the table”). In some embodiments, the request corresponding to the content in the field-of-view of the one or more cameras is a verbal request. In some embodiments, detecting the request corresponding to the content in the field-of-view of the one or more cameras includes capturing, via the one or more input devices, an input (e.g., verbal input, sound input, and/or audio input) associated with (e.g., including, corresponding to, and/or having) the request corresponding to the content in the field-of-view of the one or more cameras. Outputting the suggestion to add the first object to the content in accordance with a determination that the content includes a first set of one or more characteristics and outputting the suggestion to add the second object to the content in accordance with a determination that the content includes a second set of one or more characteristics and in response to detecting the request including a verbal request corresponding to content in the field-of-view of the one or more cameras enables the computer system to add a suggestion to add an object based on the content in the field-of-view as directed by a verbal request, thereby reducing the number of inputs needed to perform an operation, performing an operation when a set of conditions has been met without requiring further user input, and providing improved visual feedback to the user.

In some embodiments, outputting, via the one or more output devices, the suggestion to add the first object (e.g., 812, 814, and/or 818) to the content (e.g., 810) includes: in accordance with a determination that a first location on the representation of the field-of-view of the one or more cameras (e.g., 806) includes a first set of one or more location characteristics (e.g., the first location includes sufficient space, uniform color, and/or proximity to the content in the field-of-view of the one or more cameras), displaying, via the display component, the suggestion to add the first object (e.g., 812, 814, and/or 818) to the content (e.g., 810) at the first location (e.g., overlaid on the content and/or overlaid on the environment); and in accordance with a determination that the first location on the representation of the field-of-view of the one or more cameras (e.g., 806) includes a second set of one or more location characteristics, displaying, via the display component, the suggestion to add the first object (e.g., 812, 814, and/or 818) to the content (e.g., 810) at a second location (e.g., overlaid on the content and/or overlaid on the environment), different from the first location. In some embodiments, in accordance with the determination that the first location on the representation of the field-of-view of the one or more cameras does not include the first set of one or more location characteristics, the computer system does not display the suggestion of the representation of the field-of-view of the one or more cameras. In some embodiments, in accordance with a determination that the first location on the representation of the field-of-view of the one or more cameras does not include the first set of one or more location characteristics, the computer system does not display the suggestion to add the first object to the content at the first location. Displaying the suggestion to add the first object to the content at the second location in accordance with a determination that the first location on the representation of the field-of-view of the one or more cameras includes a second set of one or more location characteristics and displaying the suggestion to add the first object to the content at the first location in accordance with a determination that a first location on the representation of the field-of-view of the one or more cameras includes a first set of one or more location characteristics enables the computer system to automatically add objects at a location of the content, thereby reducing the number of inputs needed to perform an operation, performing an operation when a set of conditions has been met without requiring further user input, and providing improved visual feedback to the user.

In some embodiments, the first set of one or more location characteristics is an empty space (e.g., locations in the content with no objects (e.g., no objects of interest and/or features), locations in the content that are blank (e.g., an area that is uniformly one color and/or an area that is blurred with hard to distinguish features), and/or does not overlap content with objects) in the content (e.g., 810) being at a third location (e.g., a location that corresponds to the first location and not the second location). In some embodiments, the second set of one or more characteristics is the empty space in the content being at a fourth location (e.g., a location that corresponds to the second location and not the first location) (e.g., and not at the third location) different from the third location. In some embodiments, determining that the content has the first set of one or more location characteristics includes detecting that the content has empty space. Outputting the suggestion to add the first object to the content in accordance with a determination that the content includes a first set of one or more characteristics in an empty space and outputting the suggestion to add the second object to the content in accordance with a determination that the content includes a second set of one or more characteristics in an empty space and in response to detecting the request corresponding to content in the field-of-view of the one or more cameras enables the computer system to add a suggestion to add an object based on the content in the field-of-view and the presence of empty space, thereby reducing the number of inputs needed to perform an operation, performing an operation when a set of conditions has been met without requiring further user input, and providing improved visual feedback to the user.

In some embodiments, outputting, via the one or more output devices, the suggestion to add the first object (e.g., 812, 814, and/or 818) to the content (e.g., 810) includes: in accordance with a determination that a first portion of the representation of the of the field-of-view of the one or more cameras (e.g., 806) is relevant to the portion of content, displaying, via the display component, the suggestion to add the first object (e.g., 812, 814, and/or 818) to the content (e.g., 810) overlapping (e.g., intersecting with, layered above, and/or at the same location as and more visible than) a location of the first portion of the representation of the of the field-of-view of the one or more cameras is relevant to the portion of content (e.g., overlaid on the content and/or overlaid on the environment); and in accordance with a determination that a second portion of the representation of the of the field-of-view, different from the first portion of the representation of the field-of-view, of the one or more cameras is relevant to the portion of content, displaying, via the display component, the suggestion to add the first object (e.g., 812, 814, and/or 818) to the content (e.g., 810) overlapping a location of the second portion of the representation of the of the field-of-view of the one or more cameras (e.g., 806) is relevant to the portion of content (e.g., overlaid on the content and/or overlaid on the environment). In some embodiments, in accordance with a determination that the second portion of the representation of the of the field-of-view, different from the first portion of the representation of the field-of-view, of the one or more cameras is relevant to the portion of content, the suggestion to add the first object to the content does not overlap the location of the first portion of the representation of the of the field-of-view of the one or more cameras is relevant to the portion of content. In some embodiments, in accordance with a determination that the first portion of the representation of the of the field-of-view of the one or more cameras is relevant to the portion of content, displaying, via the display generation component, the suggestion to add the first object to the content does not overlap the location of the second portion of the representation of the of the field-of-view of the one or more cameras is relevant to the portion of content. Displaying the suggestion to add the first object to the content overlapping a location of the second portion of the representation of the of the field-of-view of the one or more cameras is relevant to the portion of content in accordance with a determination that a second portion of the representation of the of the field-of-view of the one or more cameras is relevant to the portion of content and the suggestion to add the first object to the content overlapping a location of the first portion of the representation of the of the field-of-view of the one or more cameras is relevant to the portion of content in accordance with a determination that a first portion of the representation of the of the field-of-view of the one or more cameras is relevant to the portion of content enables the computer system to automatically display the portion of the content based on the field-of-view, thereby reducing the number of inputs needed to perform an operation, performing an operation when a set of conditions has been met without requiring further user input, and providing improved visual feedback to the user. in accordance with a determination that the request (e.g., 805a, 805d1, and/or 805d2) corresponds to a first content (e.g., 810) (e.g., as described above in relation to process 1000) (e.g., the type of verbal request, the subject matter of the verbal request, and/or attributes of the content in the field-of-view of the one or more cameras), the first object (e.g., 812, 814, and/or 818) is a third object (e.g., the same as the first object and/or different from the first object) at the first location; and in accordance with a determination that the request (e.g., 805a, 805d1, and/or 805d2) corresponds to a second content (e.g., 810) different from the first content, the first object is a fourth object, different from the third object at the first location. In some embodiments, in accordance with a determination that the request does not correspond to the first content, and in accordance with the determination that the request includes the second set of one or more verbal characteristics, different from the first set of one or more characteristics, the second object is not the fourth object. In some embodiments, in accordance with a determination that the request does not correspond to the first content, and in accordance with the determination that the request does not include the second set of one or more verbal characteristics, different from the first set of one or more characteristics, the second object is not the fourth object. In some embodiments, in accordance with a determination that the request does correspond to the first content, and in accordance with the determination that the request does not include a second set of one or more verbal characteristics, different from the first set of one or more characteristics, the second object is not the fourth object. Outputting the suggestion to add the first object to the content in accordance with a determination that the content includes a first set of one or more characteristics and outputting the suggestion to add the second object to the content in accordance with a determination that the content includes a second set of one or more characteristics and in response to detecting the request where the first object is a third object and the first object is a fourth object in accordance with a determination that the request corresponds to content in the field-of-view of the one or more cameras enables the computer system to add a suggestion to add an object based on the context of the request, thereby reducing the number of inputs needed to perform an operation, performing an operation when a set of conditions has been met without requiring further user input, and providing improved visual feedback to the user.

In some embodiments, in accordance with a determination that a context (e.g., previous content of the field-of-view of the one or more cameras and/or external (e.g., additional applications and/or features) content of the computer system) of the content (e.g., 810) is a first context (e.g., as described above in relation to process 1000), the first object (e.g., 812, 814, and/or 818) is a fifth object (and, in some examples, at the first location). In some embodiments, in accordance with a determination that the context of the content (e.g., 810) is a second context, different from the first context, the first object (e.g., 812, 814, and/or 818) is a sixth object, different from the fifth object at the first location. In some embodiments, in accordance with a determination that the context of the content is not the first context, the first object is not the fifth object. In some embodiments, in accordance with a determination that the context of the content is not the second context, the first object is not the sixth object. Outputting the suggestion to add the first object to the content in accordance with a determination that the content includes a first set of one or more characteristics and outputting the suggestion to add the second object to the content in accordance with a determination that the content includes a second set of one or more characteristics and in response to detecting the request where the first object is a fifth object and the first object is a sixth object in accordance with a determination that the request corresponds to the context of the content in the field-of-view of the one or more cameras enables the computer system to add a suggestion to add an object based on the context of the content in the field-of-view, thereby reducing the number of inputs needed to perform an operation, performing an operation when a set of conditions has been met without requiring further user input, and providing improved visual feedback to the user.

In some embodiments, outputting, via the one or more output devices, the suggestion to add the first object (e.g., 812, 814, and/or 818) to the content (e.g., 810) includes: in accordance with a determination that the content (e.g., 810) includes a first style (e.g., appearance, form, and/or design), displaying, via the display component, the suggestion to add the first object (e.g., 812, 814, and/or 818) to the content in a second style; and in accordance with a determination that the content (e.g., 810) does not include the first style, forgoing displaying, via the display component, the suggestion to add the first object (e.g., 812, 814, and/or 818) to the content in the second style. In some embodiments, the content in the field-of-view of the one or more cameras was drawn by a user, and the first style is in the style of the drawing by the user. In some embodiments, the second style is the same as the first style. In some embodiments, the second style is different from the first style but is generated based on the first type (e.g., is an approximation and/or a representation of the first style). Displaying the suggestion to add the first object to the content in a second style in accordance with a determination that the content includes a first style and displaying the suggestion to add the first object to the content in the second style in accordance with a determination that the content does not include the first style enables the computer system to automatically display the suggestion in the style of the content, thereby reducing the number of inputs needed to perform an operation, performing an operation when a set of conditions has been met without requiring further user input, and providing improved visual feedback to the user.

In some embodiments, in response to detecting the request (e.g., 805a, 805d1, and/or 805d2) corresponding to content (e.g., 810) in the field-of-view of the one or more cameras (e.g., 806), in accordance with a determination that the computer system (e.g., 600) is in a third style (e.g., appearance, form, and/or design), the computer system displays, via the display component, a suggestion to add an eighth object (e.g., 812, 814, and/or 818) to the content (e.g., 810) in a fourth style. In some embodiments, in response to detecting the request corresponding to content in the field-of-view of the one or more cameras, in accordance with a determination that the computer system (e.g., 600) is not in the third style, the computer system displays, via the display component, the suggestion to add the eighth object (e.g., 812, 814, and/or 818) to the content (e.g., 810) in the fourth style. In some embodiments, the fourth style is a system style. Displaying the suggestion to add an eighth object to the content in a fourth style in accordance with a determination that the computer system is in a third style and displaying the suggestion to add the eighth object to the content in the fourth style accordance with a determination that the computer system is not in the third style enables the computer system to display the suggestion in the same system style despite the style of the content, thereby reducing the number of inputs needed to perform an operation, performing an operation when a set of conditions has been met without requiring further user input, and providing improved visual feedback to the user.

In some embodiments, the representation of the field-of-view of the one or more cameras (e.g., 806) is a first representation of the field-of-view of the one or more cameras. In some embodiments, while outputting the first representation of the field-of-view of the one or more cameras (e.g., 806) and before detecting the request (e.g., 805a, 805d1, and/or 805d2) corresponding to the content (e.g., 810) in the field-of-view of the one or more cameras, the computer system detects a change (e.g., a new frame of media and/or a change of the content) in the field-of view of the one or more cameras. In some embodiments, in response to detecting the change in the field-of-view of the one or more cameras (e.g., 806), the computer system outputs, via the one or more output devices, a second representation of the field-of-view of the one or more cameras, different from the representation of the field-of-view of the one or more cameras. In some embodiments, outputting the representation of the field-of-view of the one or more cameras includes changing (e.g., updating and/or refresh) the representation of the field of view of the one or more cameras from the representation of the field-of-view of the one or more cameras to the second representation of the field-of-view of the one or more cameras. In some embodiments, the representation of the field-of-view of the one or more cameras is live (e.g., the representation of the field-of-view changes as the field-of-view of the one or more cameras changes). In some embodiments, the representation of the field of view of the one or more cameras corresponds to an application active on the application (e.g., a camera application and/or social media application). In some embodiments, outputting the second representation of the field-of-view of the one or more cameras includes updating the representation of the field-of-view, where the second representation is an updated version of the first representation. In some embodiments, the representation of the field-of-view is a live feed. In some embodiments, the representation of the field-of-view is not a live feed (e.g., previously captured representation and/or saved media (e.g., that is being access for some time greater than 5-10000 minutes)). In some embodiments, in response to detecting the change in the field-of-view of the one or more cameras, the computer system ceases outputting the representation of the field-of-view of the one or more cameras to the second representation of the field-of-view of the one or more cameras. Outputting a second representation of the field-of-view of the one or more cameras, different from the representation of the field-of-view of the one or more cameras in response to detecting the change in the field-of-view of the one or more cameras enables the computer system to automatically update the field-of-view as the environment changes, thereby reducing the number of inputs needed to perform an operation, performing an operation when a set of conditions has been met without requiring further user input, and providing improved visual feedback to the user.

In some embodiments, the first object (e.g., 812, 814, and/or 818) includes virtual objects (e.g., user interface objects, NFTs, digital assets (e.g., drawings and/or models), and/or text).

In some embodiments, outputting the suggestion to add the first object (e.g., 812, 814, and/or 818) includes displaying a representation of a physical object. In some embodiments, the physical objects include physical manipulations of the content corresponding to the field-of-view of the one or more cameras (e.g., a projection of an outline of a horse can be suggested on the content in the field-of-view of the one or more cameras and/or a recommendation to move a plant for better symmetry).

In some embodiments, the request (e.g., 805a, 805d1, and/or 805d2) corresponding to content (e.g., 810) in the field-of-view of the one or more cameras (e.g., 806) is a first request corresponding to content in the field-of-view of the one or more cameras. In some embodiments, after outputting the suggestion to add the first object (e.g., 812, 814, and/or 818) to the content (e.g., 810) (or, in some examples, the second object to the content) and while displaying, via the display component, a third representation of the field-of-view of the one or more cameras (e.g., 806), the computer system detects a second request (e.g., 805a, 805d1, and/or 805d2) corresponding to second content in the field-of-view of the one or more cameras, wherein the third representation of the field-of-view of the one or more cameras includes the second content. In some embodiments, in response to detecting the second request (e.g., 805a, 805d1, and/or 805d2) corresponding to second content (e.g., 810) in the field-of-view of the one or more cameras (e.g., 806), in accordance with a determination that the second content (e.g., 810) includes a first type of content (e.g., a particular style, theme, and/or design), the computer system outputs, via the one or more output devices, a suggestion to add a ninth object (e.g., 812, 814, and/or 818) to the second content. In some embodiments, in response to detecting the second request corresponding to second content in the field-of-view of the one or more cameras, in accordance with a determination that the second content (e.g., 810) does not include the first type of content, the computer system forgoes outputting, via the via the one or more output devices, the suggestion to add the ninth object (e.g., 812, 814, and/or 818) to the second content. In some embodiments, in accordance with a determination that the second content included a second type of content, different from the first type of content, outputting, via the one or more output devices, a suggestion to add a tenth object (e.g., different from and/or the same as the ninth object) to the second content. In some embodiments, the second request corresponding to second content in the field of view of the one or more cameras is different from the first request corresponding to content in the field-of-view of the one or more cameras. In some embodiments, the second request corresponding to second content in the field of view of the one or more cameras is the same as the first request corresponding to content in the field-of-view of the one or more cameras. In some embodiments, the second content is the same as the content. In some embodiments, the second content is different from the content. In some embodiments, the second representation of the field-of-view of the one or more cameras is the same as the representation of the field-of-view of the one or more cameras. Outputting a suggestion to add a ninth object to the second content in accordance with a determination that the second content includes a first type of content and not outputting the suggestion to add the ninth object to the second content in accordance with a determination that the second content does not include the first type of content enables the computer system to automatically display a suggestion to add an object when the content is a particular type, thereby reducing the number of inputs needed to perform an operation, performing an operation when a set of conditions has been met without requiring further user input, and providing improved visual feedback to the user.

Note that details of the processes described above with respect to process 1100 (e.g., FIG. 11) are also applicable in an analogous manner to the methods described below/above. For example, process 700 optionally includes one or more of the characteristics of the various methods described above with reference to process 1100. For example, the computer system can use one or more techniques of process 700 to move an amount to capture more content using one or more techniques of process 1100. For brevity, these details are not repeated below.

FIG. 12 is a flow diagram illustrating a method for outputting an object to incorporate in content using a computer system in accordance with some embodiments. Process 1200 is performed at a computer system (e.g., 100, 200, and/or 600). Some operations in process 1200 are, optionally, combined, the orders of some operations are, optionally, changed, and some operations are, optionally, omitted.

As described below, process 1200 provides an intuitive way for outputting an object to incorporate in content. The method reduces the cognitive burden on a user for outputting an object to incorporate in content, thereby creating a more efficient human-machine interface. For battery operated computing devices, enabling a user to output an object to incorporate in content faster and more efficiently conserves power and increases the time between battery charges.

In some embodiments, process 1200 is performed at a computer system (e.g., 600) that is in communication with one or more output devices (e.g., a speaker, a haptic output device, a display screen, a projector, and/or a touch-sensitive display) including a display component (e.g., a display screen, a projector, and/or a touch-sensitive display) and one or more cameras (e.g., a telephoto, wide angle, and/or ultra-wide angle camera). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more input devices (e.g., a touch-sensitive display, a rotatable input mechanism, a camera (e.g., a telephoto, wide angle, and/or ultra-wide angle camera), and/or a sensor (e.g., a gyroscope and/or a heart rate sensor)). In some embodiments, the computer system is in communication with a movement component (e.g., an actuator, a motor, an electronic arm, a lift, and/or a lever).

While displaying, via the display component, a representation of a field-of-view of the one or more cameras (e.g., 806), the computer system detects (1202) a request (e.g., 805a, 805d1, and/or 805d2) (e.g., an input, a tap, and/or a non-tap input (e.g., an air gesture and/or voice input)) corresponding to content (e.g., features, characteristics, objects, and/or work product) in the field-of-view of the one or more cameras.

In response to (1204) detecting the request (e.g., 805a, 805d1, and/or 805d2) corresponding to content in the field-of-view of the one or more cameras (e.g., 806), in accordance with a determination that the request (e.g., 805a, 805d1, and/or 805d2) indicates that a first person (e.g., a user, and/or user of the computer system) is associated with the content, the computer system outputs (1206), via the one or more output devices, an indication of a first set of one or more objects (e.g., 812, 814, and/or 818) (e.g., physical objects, virtual objects, and/or physical manipulations of the content in the field-of-view of the one or more cameras) to incorporate in the content.

In response to (1204) detecting the request corresponding to content in the field-of-view of the one or more cameras, in accordance with a determination that the request (e.g., 805a, 805d1, and/or 805d2) indicates that a second person is associated with the content, the computer system outputs (1208), via the one or more output devices, an indication of a second set of one of more objects (e.g., 812, 814, and/or 818), different from the first set of one or more objects, to incorporate in the content (and, in some embodiments, without outputting the indication to add the first set of one or more objects). In some embodiments, outputting includes displaying, via the display component. In some embodiments, the work product includes products, media, objects, and features as determined by where the work product is being used (e.g., a physical space (e.g., a factory floor, design studio, and/or living room), a user (e.g., of the computer system and/or in the field-of-view of the one or more cameras), and/or a usage history (e.g., a pattern of use of the content over a threshold period of time, and/or past inputs directed to the content) associated with the work product). Outputting the indication of the second set of one of more objects to incorporate in the content in accordance with the determination that the request indicates that the second person is associated with the content and outputting the indication of a first set of one or more objects to incorporate in the content in accordance with the determination that the request indicates that the first person is associated with the content in response to detecting the request corresponding to content in the field-of-view of the one or more cameras enables the computer system to automatically output objects of the person in the field-of-view, thereby performing an operation when a set of conditions has been met without requiring further user input, reducing the number of inputs needed to perform an operation, and providing improved visual feedback to the user.

In some embodiments, the computer system (e.g., 600) is in communication with a microphone (and, in some embodiments, that is included in one or more input devices in communication with the computer system). In some embodiments, detecting the request (e.g., 805a, 805d1, and/or 805d2) corresponding to the content in the field-of-view of the one or more cameras (e.g., 806) includes capturing, via the microphone, audio that includes a verbal request (e.g., 805d1) (e.g., a voice input, and/or audible input) corresponding to the content in the field-of-view of the one or more cameras. In some embodiments, the verbal request includes an identification (e.g., name, symbol, or feature) of the content. In some embodiments, the verbal request does not include an identification of the content but rather a description that leads to the identification of content (e.g., “a request that says this is a picture of London” and the computer system identifying a box as “Big Ben” based on one or more characteristics of the content; and/or a request that says “I really like eating pizza,” and the computer system identifying a table in a living room in the content as the portion of interest instead of a chair in the living room or a television in the living room; however, if the request said “I really like TV Show 1,” the computer system would identify the television as the portion of interest instead of the table”). In some embodiments, the request corresponding to the content in the field-of-view of the one or more cameras is a verbal request. In some embodiments, detecting the request corresponding to the content in the field-of-view of the one or more cameras includes capturing, via the one or more input devices, an input (e.g., verbal input, sound input, and/or audio input) associated with (e.g., including, corresponding to, and/or having) the request corresponding to the content in the field-of-view of the one or more cameras. Outputting the indication of the second set of one of more objects to incorporate in the content in accordance with the determination that the request including the verbal request corresponding to the content in the field-of-view of the one or more cameras indicates that the second person is associated with the content and outputting the indication of a first set of one or more objects to incorporate in the content in accordance with the determination that the request indicates that the first person is associated with the content in response to detecting the request corresponding to content in the field-of-view of the one or more cameras enables the computer system to automatically output objects of the person in the field-of-view when a verbal request is detected, thereby performing an operation when a set of conditions has been met without requiring further user input, reducing the number of inputs needed to perform an operation, and providing improved visual feedback to the user.

In some embodiments, in response to detecting the request (e.g., 805a, 805d1, and/or 805d2) corresponding to content in the field-of-view of the one or more cameras (e.g., 806), in accordance with a determination that the content indicates that a third person (e.g., the same as the second person, and/or a person different from the second person), different from the first person and the second person, is associated with the content (e.g., the content is for the third person and/or the third person is in the content), the computer system outputs, via the one or more output devices, an indication of a third set of one or more objects (e.g., 812, 814, and/or 818) (e.g., the same as the first set of one or more objects, the same as the second set of one or more objects, different from the first set of one or more objects, and/or different from the second set of one or more objects) to incorporate in the content. Outputting the indication of the third set of one or more objects to incorporate in the content in accordance with the determination that the content indicates that a third person is associated with the content enables the computer system to automatically output objects that suit the person in the field-of-view among multiple potential persons, thereby performing an operation when a set of conditions has been met without requiring further user input, reducing the number of inputs needed to perform an operation, and providing improved visual feedback to the user.

In some embodiments, the indication of the second set of one or more objects (e.g., 812, 814, and/or 818) does not include an identifier (e.g., a representation of a name, a face, a body part and/or features (e.g., clothing, facial features, and/or accessories)) associated with the second person. In some embodiments, the indication of the first set of one or more objects does not include an identifier associated with the first person. In some embodiments, the indication of the first set of one or more objects does not include a direct association with the first person. In some embodiments, the indication of the second set of one or more objects does not include a direct association with the second person. In some embodiments, displaying the second representation of the field-of-view of the one or more cameras includes displaying the content of the representation of the field-of-view of the one or more cameras at a respective location different from the fourth location. In some embodiments, outputting the indication of the first set of one or more objects at the first relative position with respect to the second representation of the field of view of the one or more cameras includes displaying the indication of the first set of one or more objects at a different respective location that is the first relative position from the respective location of the content of the representation of the field-of-view of the one or more cameras. In some embodiments, the computer system detects a change in the representation of the field-of-view of the one or more cameras (e.g., the camera moves and/or content in the field-of-view of the one or more cameras changes), and in response to detecting the change in the field-of-view of the one or more cameras: in accordance with a determination that the computer system is in the locked state: the computer system displays, via the display generation component, the second representation of the field-of-view of the one or more cameras; and the computer system ceases displaying the representation of the field-of-view of the one or more cameras; and the computer system outputs, via the one or more output devices, the indication of the indication of the first set of one or more objects at the first relative position from the content in the second representation of the field-of-view of the one or more cameras; and in accordance with a determination that the computer system is in the unlocked state: the computer system displays, via the display generation component, the second representation of the field-of-view of the one or more cameras, different from the representation of the field-of-view of the one or more cameras; the computer system ceases displaying the representation of the field-of-view of the one or more cameras; and the computer system outputs, via the one or more output devices, the indication of the first set of one or more objects at the first relative position from the content in the second representation of the field-of-view of the one or more cameras. Outputting the indication of the second set of one of more objects to incorporate in the content in accordance with the determination that the request indicates that the second person is associated with the content and outputting the indication of a first set of one or more objects to incorporate in the content in accordance with the determination that the request indicates that the first person is associated with the content in response to detecting the request corresponding to content in the field-of-view of the one or more cameras enables the computer system to automatically output objects of the person in the field-of-view, thereby performing an operation when a set of conditions has been met without requiring further user input, reducing the number of inputs needed to perform an operation, and providing improved visual feedback to the user.

In some embodiments, the indication of the second set of one or more objects (e.g., 812, 814, and/or 818) includes an indication of a fourth set of one or more objects (e.g., 812, 814, and/or 818) associated with the second person. In some embodiments, the indication of the fourth set of one or more objects includes an object the second person likes, a feature of the second person, and/or the first person is wearing. In some embodiments, the indication of the first set of one or more objects includes an indication of a respective set of one or more objects associated with the first person. In some embodiments, the indication of the respective set of one or more objects includes an object the first person likes, a feature of the first person, and/or the first person is wearing. Outputting the indication of the second set of one of more objects including the indication of the fourth set of one or more objects associated with the second person to incorporate in the content in accordance with the determination that the request indicates that the second person is associated with the content in response to detecting the request corresponding to content in the field-of-view of the one or more cameras enables the computer system to automatically output objects specific to the person, thereby performing an operation when a set of conditions has been met without requiring further user input, reducing the number of inputs needed to perform an operation, and providing improved visual feedback to the user.

In some embodiments, outputting the indication of the first set of one or more objects (e.g., 812, 814, and/or 818) to incorporate in the content includes: in accordance with a determination that the first person is associated with a first set of historical data (e.g., a previous conversation and/or interaction concerning the first person) (e.g., context as described above in relation to process 1000) and not a second set of historical data, the indication of the first set of one or more objects (e.g., 812, 814, and/or 818) includes an indication of a fifth set of one or more objects (e.g., the indication of the first set of one or more objects, the indication of the second set of one or more objects, and/or an indication of a separate set of one or more objects, different from the indication of the first set of one or more objects and/or the indication of the second set of one or more objects) and does not include an indication of a sixth set of one or more objects (e.g., 812, 814, and/or 818) (e.g., the first set of one or more objects, second set of one or more objects, and/or a separate set of one or more objects different from the first set of one or more objects and/or second set of one or more objects). In some embodiments, the indication of the fifth set of one or more objects (e.g., 812, 814, and/or 818) is different from the indication of the sixth set of one or more objects; and in accordance with a determination that the second person is associated with a second set of historical data and not the first set of historical data, the indication of the second set of one or more objects (e.g., 812, 814, and/or 818) includes the indication of the sixth set of one or more objects (e.g., 812, 814, and/or 818) and does not include the indication of the fifth set of one or more objects (e.g., 812, 814, and/or 818). Outputting the indication of the first set of one or more objects including the indication of the fifth set of one or more objects in accordance with a determination that the person is associated with the first set of historical data, and outputting the indication of the second set of one or more objects including the indication of the sixth set of one or more objects in accordance with the determination that the second person is associated with the second set of historical data enables the computer system to automatically output objects that suit the person and historical data, thereby performing an operation when a set of conditions has been met without requiring further user input, reducing the number of inputs needed to perform an operation, and providing improved visual feedback to the user.

In some embodiments, the indication of the first set of one or more objects (e.g., 812, 814, and/or 818) are associated with (e.g., correspond to and/or concern) the content. In some embodiments, the second set of one or more objects are associated with the content.

In some embodiments, outputting the indication of the first set of one or more objects (e.g., 812, 814, and/or 818) to incorporate in the content includes displaying the indication of the first set of one or more objects to incorporate in the content. In some embodiments, in accordance with a determination that a portion of the content is a portion of interest (e.g., as described above in relation to process 1000) displayed on the representation of the field-of-view of the one or more cameras (e.g., 806), the indication of the first set of one or more objects (e.g., 812, 814, and/or 818) to incorporate in the content is displayed at a first location (e.g., of the display component and/or relative to the indication of the first set of one or more objects). In some embodiments, the portion of interest is displayed at a second location on the representation of the field-of-view of the one or more cameras (e.g., 806), wherein the first location is overlaid on the second location (and, in some examples, the indication of the second set of one or more objects are displayed at a respective location that is not overlaid on the portion of interest on the representation of the field-of-view of the one or more cameras). In some embodiments, in accordance with a determination that the portion of the content is the portion of interest on the representation of the field-of-view of the one or more cameras, the first set of one or more objects to incorporate in the content is not displayed at the first location (and, in some examples, the indication of the first set of one or more objects are not displayed at a different location that overlaps the location of the portion of interest on the representation of the field-of-view of the one or more cameras). Outputting the indication of the first set of one or more objects to incorporate in the content overlaid on the portion of interest on the representation of the field-of-view of the one or more cameras in accordance with a determination that a portion of the content is a portion of interest on the representation of the field-of-view of the one or more cameras enables the computer system to automatically output objects overlaid on other outputs that suit the person and historical data, thereby performing an operation when a set of conditions has been met without requiring further user input, reducing the number of inputs needed to perform an operation, and providing improved visual feedback to the user.

In some embodiments, outputting the indication of the first set of one or more objects (e.g., 812, 814, and/or 818) includes displaying, via the display component, the indication of the first set of one or more objects. In some embodiments, while displaying the representation of the field-of-view of the one or more cameras (e.g., 806) and displaying the indication of the first set of one or more objects (e.g., 812, 814, and/or 818), the computer system detects an input (e.g., a tap input and/or a non-tap input (e.g., a verbal input, an audible request, an audible command, an audible statement, a swipe input, a hold-and-drag input, a gaze input, an air gesture, and/or a mouse click)) corresponding to selection of the indication of the first set of one or more objects. In some embodiments, in response to detecting the input corresponding to selection of the indication of the first set of one or more objects (e.g., 812, 814, and/or 818) (and, in some embodiments, while displaying the representation of the field-of-view of the one or more cameras), the computer system changes the state of the computer system (e.g., 600) to a locked state including locking the indication of the first set of one or more objects at a third location, wherein the content of the representation of the field-of-view of the one or more cameras (e.g., 806) is displayed at a fourth location, and wherein the third location is over the fourth location. In some embodiments, in response to detecting the input corresponding to selection of the indication of the second set of one or more objects, the computer system changes the state of the computer system to the locked state including locking the indication of the second set of one or more objects at a respective location corresponding to the content of the representation of the field-of-view of the one or more cameras. In some embodiments, in response to detecting the input corresponding to selection of the indication of the first set of one or more objects, the computer system outputs, via the one or more output devices, an indication that the computer system is in the locked state. In some embodiments, outputting the indication that the computer system is in the locked state includes displaying, via the display component, a representation of the indication that the computer system is in the locked state (e.g., a lock icon and/or a highlight of the indication of the first set of one or more objects). In some embodiments, outputting the indication that the computer system is in the locked state includes playing back, via the one or more output devices, an audible representation (e.g., a chime, music playback, and/or a spoken notification (e.g., “the item is locked”) of the indication that the computer system is in the locked state). Changing the state of the computer system to the locked state in response to detecting the input corresponding to selection of the indication of the first set of one or more objects enables the computer system to maintain the position of the content as directed by the user, thereby reducing the number of inputs needed to perform an operation, and providing improved visual feedback to the user.

In some embodiments, the indication of the first set of one or more objects (e.g., 812, 814, and/or 818) is displayed at a first relative position (e.g., an environment locked position) (a distance and/or dimension (one or more of three axis of position)) with respect to the content. In some embodiments, while the state of the computer system (e.g., 600) is in the locked state, the computer system detects a movement of the computer system. In some embodiments, in response to detecting the movement of the computer system (e.g., 600), the computer system displays, via the display component, a second representation of the field-of-view of the one or more cameras (e.g., 806) (e.g., the content of the field-of-view of the one or more cameras changed and/or the indication of the first of one or more objects moved in the field-of-view of the one or more cameras) including the indication of the first set of one or more objects (e.g., 812, 814, and/or 818), wherein the second representation of the field-of-view of the one or more cameras is different from the representation of the field-of-view of the one or more cameras. In some embodiments, in response to detecting the movement of the computer system, the computer system ceases displaying the representation of the field-of-view of the one or more cameras (e.g., 806). In some embodiments, in response to detecting the movement of the computer system, the computer system outputs, via the one or more output devices, the indication of the first set of one or more objects (e.g., 812, 814, and/or 818) at the first relative position with respect to the content in the second representation of the field-of-view of the one or more cameras (e.g., 806). In some embodiments, displaying the second representation of the field-of-view of the one or more cameras includes displaying the content of the representation of the field-of-view of the one or more cameras at a respective location different from the fourth location. In some embodiments, outputting the indication of the first set of one or more objects at the first relative position with respect to the second representation of the field of view of the one or more cameras includes displaying the indication of the first set of one or more objects at a different respective location that is the first relative position from the respective location of the content of the representation of the field-of-view of the one or more cameras. In some embodiments, the computer system detects a change in the representation of the field-of-view of the one or more cameras (e.g., the camera moves and/or content in the field-of-view of the one or more cameras changes), and in response to detecting the change in the field-of-view of the one or more cameras: in accordance with a determination that the computer system is in the locked state: the computer system displays, via the display component, the second representation of the field-of-view of the one or more cameras; and the computer system ceases displaying the representation of the field-of-view of the one or more cameras; and the computer system outputs, via the one or more output devices, the indication of the indication of the first set of one or more objects at the first relative position from the content in the second representation of the field-of-view of the one or more cameras; and in accordance with a determination that the computer system is in the unlocked state: the computer system displays, via the display component, the second representation of the field-of-view of the one or more cameras, different from the representation of the field-of-view of the one or more cameras; the computer system ceases displaying the representation of the field-of-view of the one or more cameras; and the computer system outputs, via the one or more output devices, the indication of the first set of one or more objects at the first relative position from the content in the second representation of the field-of-view of the one or more cameras.

In some embodiments, the request (e.g., 805a, 805d1, and/or 805d2) is a first request (e.g., 805a, 805d1, and/or 805d2). In some embodiments, after (or before and/or while) outputting, via the one or more output devices, the indication of the first set of one or more objects (e.g., 812, 814, and/or 818) to incorporate in the content (and, in some examples, while displaying, via the display component, a representation of the field-of-view of the one or more cameras) (and/or after or before and/or while) (outputting, via the one or more output devices, the indication of the second set of one or more objects to incorporate in the content), the computer system detects a second request (e.g., 805a, 805d1, and/or 805d2), different from the first request (e.g., 805a, 805d1, and/or 805d2), corresponding to content in the field-of-view of the one or more cameras (e.g., 806). In some embodiments, in response to detecting the second request (e.g., 805a, 805d1, and/or 805d2) corresponding to the content in the field-of-view of the one or more cameras (e.g., 806) and in accordance with a determination that the request (e.g., 805a, 805d1, and/or 805d2) indicates that a fourth person (e.g., different from the first person and/or second person) is associated with the content, the computer system outputs, via the one or more output devices, an indication of a seventh set of one or more objects (e.g., 812, 814, and/or 818), different from the indication of the first of one or more objects, to incorporate in the content. In some embodiments, the indication of the seventh set of one or more objects is different from the indication of the first set of one or more objects. In some embodiments, the indication of the seventh set of one or more objects is different from the indication of the second set of one or more objects. In some embodiments, the indication of the seventh set of one or more objects is the same as the indication of the first set of one or more objects. In some embodiments, the indication of the seventh set of one or more objects is the same as the indication of the second set of one or more objects. In some embodiments, outputting the indication of the seventh set of one or more objects to incorporate in the content includes displaying, via the display component, the indication of the seventh set of one or more objects to incorporate in the content. Outputting the indication of the seventh set of one or more objects in response to detecting the second request corresponding to the content in the field-of-view of the one or more cameras and in accordance with the determination that the request indicates that the fourth person is associated with the content enables the computer system to display objects suited to the person in the field-of-view, thereby performing an operation when a set of conditions has been met without requiring further user input, reducing the number of inputs needed to perform an operation, and providing improved visual feedback to the user.

In some embodiments, in response to detecting the second request (e.g., 805a, 805d1, and/or 805d2) corresponding to the content in the field-of-view of the one or more cameras (e.g., 806) and in accordance with a determination that the request (e.g., 805a, 805d1, and/or 805d2) indicates that the fourth person is associated with the content, the computer system ceases to output the indication of first set of one or more objects (e.g., 812, 814, and/or 818) to incorporate in the content (and/or, in some embodiments, the indication of the second set of one or more objects to incorporate the content). Ceasing to output the indication of first set of one or more objects to incorporate in the content in response to detecting the second request corresponding to the content in the field-of-view of the one or more cameras and in accordance with a determination that the request indicates that the fourth person is associated with the content enables the computer system to output objects relevant to the content in the field-of-view as directed by the user, thereby performing an operation when a set of conditions has been met without requiring further user input, reducing the number of inputs needed to perform an operation, and providing improved visual feedback to the user.

In some embodiments, outputting the indication of the seventh set of one or more objects (e.g., 812, 814, and/or 818) to incorporate in the content includes concurrently displaying, via the display component, the indication of the first set of one or more objects (e.g., 812, 814, and/or 818) to incorporate in the content with the indication of the seventh set of one or more objects to incorporate in the content (and in some embodiments the representation of a field-of-view of the one or more cameras). Concurrently displaying, via the display component, the indication of the first set of one or more objects to incorporate in the content with the indication of the seventh set of one or more objects to incorporate in the content enables the computer system to concurrently display objects as directed by the user, thereby performing an operation when a set of conditions has been met without requiring further user input, reducing the number of inputs needed to perform an operation, and providing improved visual feedback to the user.

In some embodiments, in accordance with a determination that the second request (e.g., 805a, 805d1, and/or 805d2) corresponds to a first set of information, the indication of the seventh set of one or more objects (e.g., 812, 814, and/or 818) includes a first object. In some embodiments, in accordance with a determination that the second request (e.g., 805a, 805d1, and/or 805d2) corresponds to a second set of information, different from the first set of information, the indication of the seventh set of one or more objects (e.g., 812, 814, and/or 818) does not include the first object. In some embodiments, the indication of the first set of one or more objects is different from the indication of the seventh set of one or more objects. In some embodiments, outputting, via the one or more output devices, the indication of the seventh set of one or more objects to incorporate in the content includes changing (e.g., adding one or more additional objects and/or removing one or more objects from the first set of one or more objects), the indication of the first set of one or more objects into the indication of the seventh set of one or more objects. In some embodiments, outputting the indication of the seventh set of one or more objects includes the computer system dynamically changing and/or animating the change in the first set of one or more objects to the seventh set of one or more objects. Outputting the seventh set of one or more objects including a first object in accordance with a determination that the second request corresponds to the first set of information and a second object in accordance with a determination that the second request corresponds to the second set of information, enables the computer system to change the objects displayed based on the request received, thereby performing an operation when a set of conditions has been met without requiring further user input, reducing the number of inputs needed to perform an operation, and providing improved visual feedback to the user.

In some embodiments, while outputting the indication of the first set of one or more objects (e.g., 812, 814, and/or 818) to incorporate in the content, the computer system detects a third request (e.g., 805a, 805d1, and/or 805d2) corresponding to the first person associated with the content in the field-of-view of the one or more cameras (e.g., 806). In some embodiments, in response to detecting the third request (e.g., 805a, 805d1, and/or 805d2) corresponding to the first person associated with the content in the field-of-view of the one or more cameras (e.g., 806), the computer system outputs, via the one or more output devices, an indication of a third object that was not previously in the first set of one or more objects (e.g., 812, 814, and/or 818) (e.g., add and/or replace an object to the first set of one or more object). In some embodiments, while outputting the indication of the second set of one or more objects to incorporate in the content, the computer system detects a respective request corresponding to the second person associated with the content in the field-of-view of the one or more cameras. In some embodiments, in response to detecting the third request corresponding to the first person associated with the content in the field-of-view of the one or more cameras, the computer system outputs, via the one or more output devices, an indication of a respective object that was not previously in the second set of one or more objects In some embodiments, in response to detecting the third request corresponding to the first person associated with the content in the field-of-view of the one or more cameras, the computer system changes (e.g., replacing at the same location and/or at a different location of the display component) the indication of the first set of one or more objects to incorporate in the content to the indication of a respective set of one or more objects to incorporate in the content (e.g., different from the first set of one or more objects and/or the second set of one or more objects). Outputting the indication of a third object that was not previously in the first set of one or more objects in response to detecting the third request corresponding to the first person associated with the content in the field-of-view of the one or more cameras enables the computer system to change objects related to the person as directed by the user, thereby reducing the number of inputs needed to perform an operation, and providing improved visual feedback to the user.

In some embodiments, in accordance with a determination that the content in the field-of-view of the one or more cameras (e.g., 806) includes a first style (e.g., appearance, form, and/or design), outputting, via the one or more output devices, an indication of an eighth set of one or more objects (e.g., 812, 814, and/or 818) (e.g., the first set of one or more objects or the second set of one or more objects) to incorporate in a second style. In some embodiments, in accordance with a determination that the content in the field-of-view of the one or more cameras (e.g., 806) does not include the first style, forgoing outputting, via the one or more output devices, the indication of the eighth set of one or more objects (e.g., 812, 814, and/or 818) to incorporate in the second style (and/or outputting the indication of the eighth set of one or more objects in a respective style different from the second style). In some embodiments, the content in the field-of-view of the one or more cameras was drawn by a user, and the first style is in the style of the drawing by the user. In some embodiments, the second style is the same as the first style. In some embodiments, the second style is different from the first style but is generated based on the first type (e.g., is an approximation and/or a representation of the first style). Outputting the indication of the eighth set of one or more objects to incorporate in the second style in accordance with a determination that the content in the field-of-view of the one or more cameras includes a first style and not outputting the indication of the eighth set of one or more objects to incorporate in the second style in accordance with a determination that the content in the field-of-view of the one or more cameras does not include a first style enables the computer system to automatically display objects in the style the content is in, thereby performing an operation when a set of conditions has been met without requiring further user input, reducing the number of inputs needed to perform an operation, and providing improved visual feedback to the user.

In some embodiments, in accordance with a determination that the content in the field-of-view of the one or more cameras (e.g., 806) includes a third style (e.g., appearance, form, and/or design), outputting, via the one or more output devices, an indication of a ninth set of one or more objects (e.g., 812, 814, and/or 818) (e.g., the first set of one or more objects or the second set of one or more objects) to incorporate in a fourth style. In some embodiments, in accordance with a determination that the content in the field-of-view of the one or more cameras (e.g., 806) does not include the third style, outputting, via the one or more output devices, an indication of a tenth set of one or more objects (e.g., 812, 814, and/or 818) (e.g., the first set of one or more objects or the second set of one or more objects) to incorporate in the fourth style. In some embodiments, the fourth style is a system style. Outputting an indication of a ninth set of one or more objects to incorporate in a fourth style in accordance with a determination that the content in the field-of-view of the one or more cameras includes a third style and outputting an indication of a tenth set of one or more objects to incorporate in the fourth style in accordance with a determination that the content in the field-of-view of the one or more cameras does not include the third style enables the computer system to automatically display objects in a system style, thereby performing an operation when a set of conditions has been met without requiring further user input, reducing the number of inputs needed to perform an operation, and providing improved visual feedback to the user.

In some embodiments, outputting the indication of the first set of one or more object to incorporate in the content includes playing back, via the one or more output devices, audio corresponding (e.g., an audible output, playback media, and/or music) to the indication of the first set of one or more objects (e.g., 812, 814, and/or 818) to incorporate in the content. Outputting the indication of a first set of one or more objects including playing back audio corresponding to the indication of the first set of one or more objects to incorporate in the content in accordance with the determination that the request indicates that the first person is associated with the content in response to detecting the request corresponding to content in the field-of-view of the one or more cameras enables the computer system to automatically output audio of the person in the field-of-view, thereby performing an operation when a set of conditions has been met without requiring further user input, reducing the number of inputs needed to perform an operation, and providing improved visual feedback to the user.

In some embodiments, outputting the indication of the first set of one or more object to incorporate in the content includes displaying, via the display component, video corresponding to the first set of one or more objects (e.g., 812, 814, and/or 818) (e.g., recorded video and/or live media). Outputting the indication of a first set of one or more objects including displaying video corresponding to the indication of the first set of one or more objects to incorporate in the content in accordance with the determination that the request indicates that the first person is associated with the content in response to detecting the request corresponding to content in the field-of-view of the one or more cameras enables the computer system to automatically output video of the person in the field-of-view, thereby performing an operation when a set of conditions has been met without requiring further user input, reducing the number of inputs needed to perform an operation, and providing improved visual feedback to the user.

In some embodiments, the request (e.g., 805a, 805d1, and/or 805d2) corresponding to content in the field-of-view of the one or more cameras (e.g., 806) is a fourth request (e.g., 805a, 805d1, and/or 805d2) corresponding to content in the field-of-view of the one or more cameras. In some embodiments, after outputting the indication of the first set of one or more objects (e.g., 812, 814, and/or 818) (or the second set of one or more objects) to incorporate in the content and while displaying, via the display component, a third representation of the field-of-view of the one or more cameras (e.g., 806) (e.g., different from the representation of the field-of-view of the one or more cameras and/or the same as the representation of the field of view of the one or more cameras), the computer system detects a fifth request (e.g., 805a, 805d1, and/or 805d2) corresponding to second content in the field-of-view of the one or more cameras (e.g., 806). In some embodiments, in response to detecting the fifth request (e.g., 805a, 805d1, and/or 805d2) corresponding to the second content in the field-of-view of the one or more cameras (e.g., 806), in accordance with a determination that the second content is a respective type of content (e.g., art (e.g., painting, sculpture, printmaking, ceramics, photography, textile arts, digital art, installation art, performance art, and/or mixed media) or non-art (e.g., a tax return, a grocery list, a technical manual, surgical tools, stock business cards, and/or a concrete block not part of an art installation)), the computer system outputs, via the one or more output devices, an indication of an eleventh set of one or more objects (e.g., 812, 814, and/or 818) to incorporate in the content. In some embodiments, in response to detecting the fifth request corresponding to the second content in the field-of-view of the one or more cameras, in accordance with a determination that the second content is not the respective type of content, the computer system forgoes outputting, via the one or more output devices, the indication of the eleventh set of one or more objects (e.g., 812, 814, and/or 818) to incorporate in the content. In some embodiments, the fifth request corresponding to second content in the field of view of the one or more cameras is different from the fourth request corresponding to content in the field-of-view of the one or more cameras. In some embodiments, the fifth request corresponding to second content in the field of view of the one or more cameras is the same as the fourth request corresponding to content in the field-of-view of the one or more cameras. In some embodiments, the second content is the same as the content in the field-of-view of the one or more cameras. In some embodiments, the second content is different from the content in the field-of-view of the one or more cameras. In some embodiments, the second representation of the field-of-view of the one or more cameras is the same as the representation of the field-of-view of the one or more cameras. Outputting an indication of the eleventh set of one or more objects to incorporate in the content in accordance with a determination that the second content is a respective type of content and not outputting the indication of the eleventh set of one or more objects to incorporate in the content in accordance with a determination that the second content is not the respective type of content enables the computer system to output objects based on the type of content in the field-of-view, thereby performing an operation when a set of conditions has been met without requiring further user input, reducing the number of inputs needed to perform an operation, and providing improved visual feedback to the user.

Note that details of the processes described above with respect to process 1200 (e.g., FIG. 12) are also applicable in an analogous manner to the methods described below/above. For example, process 1300 optionally includes one or more of the characteristics of the various methods described above with reference to process 1200. For example, the computer system can use one or more techniques of process 1300 to establish an internal dialogue based on the context of a request using one or more techniques of process 1200. For brevity, these details are not repeated below.

FIG. 13 is a flow diagram illustrating a method for establishing a dialogue using a computer system in accordance with some embodiments. Process 1300 is performed at a computer system (e.g., 100, 200, and/or 600). Some operations in process 1300 are, optionally, combined, the orders of some operations are, optionally, changed, and some operations are, optionally, omitted.

As described below, process 1300 provides an intuitive way for establishing a dialogue. The method reduces the cognitive burden on a user for establishing a dialogue, thereby creating a more efficient human-machine interface. For battery operated computing devices, enabling a user to establish a dialogue faster and more efficiently conserves power and increases the time between battery charges.

In some embodiments, process 1300 is performed at a computer system (e.g., 600) that is in communication with one or more cameras (e.g., a telephoto, wide angle, and/or ultra-wide angle camera) and a movement component (e.g., an actuator, a motor, an electronic arm, a lift, and/or a lever). In some embodiments, the computer system is in communication with one or more output devices (e.g., a speaker, a haptic output device, a display screen, a projector, and/or a touch-sensitive display) including a display component (e.g., a display screen, a projector, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more input devices (e.g., a touch-sensitive display, a rotatable input mechanism, a camera (e.g., a telephoto, wide angle, and/or ultra-wide-angle camera), and/or a sensor (e.g., a gyroscope and/or a heart rate sensor)). In some embodiments, the computer system is in communication with a movement component (e.g., an actuator, a motor, an electronic arm, a lift, and/or a lever).

While at a first position, the computer system detects (1302) a request (e.g., 805a, 805d1, and/or 805d2) (e.g., via a verbal input (e.g., a verbal input, an audible request, an audible command, and/or an audible statement) and/or a non-verbal input (e.g., a swipe input, a hold-and-drag input, a gaze input, an air gesture, and/or a mouse click)) corresponding to the content (e.g., work product, a drawing, an illustration, art, a schematic, and/or a sculpture), wherein a first portion of the content is in the field-of-view of the one or more cameras (e.g., 806) and a second portion of the content is not in the field-of-view of the one or more cameras.

In response to (1304) detecting the request (e.g., 805a, 805d1, and/or 805d2) corresponding to the content, the computer system establishes (1306) a first internal dialogue (e.g., a set of one or more rules, characteristics, detections, and/or observations that the computer system uses generate a response to one or more commands, questions, and/or statements) (and, in some embodiments, the set of one or more rules, characteristics, detections, and/or observations are learned and/or generated via deep learning and/or one or more machine learning algorithms, and/or using one or more machine learning agents and/or system agents) (and, in some embodiments, an internal dialogue is generated in real-time; in some embodiments, an internal dialogue is modified, and/or in some embodiments, an internal dialogue is generated based on other internal dialogues) based on a context related to the request (e.g., 805a, 805d1, and/or 805d2) and the first portion of the content (and not based on the second portion of the content).

In response to (1304) detecting the request corresponding to the content, the computer system moves (1308), via a movement component, from the first position to a second position, such that the second portion of the content is in the field-of-view of the one or more cameras (e.g., 806).

After (1310) establishing the first internal dialogue and after moving from the first position to the second portion, such that the second portion of the content is in the field-of-view of the one or more cameras (e.g., 806), the computer system determines (1312), based on capturing the second portion of content via the one or more camera, a change in context related to the request (e.g., 805a, 805d1, and/or 805d2).

After (1310) establishing the first internal dialogue and after moving from the first position to the second portion, such that the second portion of the content is in the field-of-view of the one or more cameras, the computer system establishes (1314) a second internal dialogue (e.g., a set of one or more rules, characteristics, detections, and/or observations that the computer system uses generate a response to one or more commands, questions, and/or statements) (and, in some embodiments, the set of one or more rules, characteristics, detections, and/or observations are learned and/or generated via deep learning and/or one or more machine learning algorithms, and/or using one or more machine learning agents and/or system agents) (and, in some embodiments, an internal dialogue is generated in real-time; in some embodiments, an internal dialogue is modified, and/or in some embodiments, an internal dialogue is generated based on other internal dialogues) based on the context related to the request (e.g., 805a, 805d1, and/or 805d2), the first portion of the content, and the second portion of the content (e.g., as described above in FIGS. 8A-8E).

In some embodiments, the computer system (e.g., 600) is in communication with one or more speakers. In some embodiments, detecting the request (e.g., 805a, 805d1, and/or 805d2) corresponding to the content includes receiving, via the one or more speaker, verbal input (e.g., 805a and/or 805d1) (and/or a verbal request) (e.g., a verbal input, an audible request, an audible command, and/or an audible statement).

In some embodiments, the second internal dialogue is an updated version of the first internal dialogue. In some embodiments, the second internal dialogue is the first internal dialogue after the first internal dialogue has been updated, modified, and/or changed.

In some embodiments, the second internal dialogue is not an updated version of the first internal dialogue. In some embodiments, the second internal dialogue is different from the first internal dialogue. In some embodiments, the second internal dialogue is created, generated, and/or stored in after moving from the first position to the second portion.

In some embodiments, in conjunction with establishing the second internal dialogue, the computer system de-establishes (e.g., depreciating, removing, not following, and/or deleting) the first internal dialogue.

In some embodiments, the computer system (e.g., 600) is in communication with one or more output devices. In some embodiments, while the first dialogue is established, the computer system detects a first input (e.g., corresponding to the content and/or a statement that is a different request than the request corresponding to the content) (e.g., a verbal input (e.g., a verbal input, an audible request, an audible command, and/or an audible statement) and/or a non-verbal input (e.g., a swipe input, a hold-and-drag input, a gaze input, an air gesture, and/or a mouse click)). In some embodiments, in response to detecting the first input, the computer system outputs, via the one or more output devices, a first response to the first input (e.g., displaying one or more user interface objects, elements, representations, and/or indications, outputting audio, and/or output haptic output) (e.g., as described above in FIGS. 8A-8E).

In some embodiments, while the second dialogue is established, the computer system detects the first input (e.g., corresponding to the content and/or a statement that is a different request than the request corresponding to the content) (e.g., a verbal input (e.g., a verbal input, an audible request, an audible command, and/or an audible statement) and/or a non-verbal input (e.g., a swipe input, a hold-and-drag input, a gaze input, an air gesture, and/or a mouse click)) (e.g., detect the input again and/or the same input). In some embodiments, in response to detecting the first input, the computer system outputs, via the one or more output devices, a second response to the first input different from the first response to the first input (e.g., displaying one or more user interface objects, elements, representations, and/or indications, outputting audio, and/or output haptic output).

In some embodiments, the first response includes first information (e.g., content, text, symbols, video, and/or images) and does not include second information. In some embodiments, the second response includes the second information and does not include the first information.

In some embodiments, outputting, via the one or more output devices, the first response to the first input includes moving, via the movement component, with a first pattern of movement (e.g., direction and/or having particular movement characteristics (e.g., speed, acceleration, and/or distance)). In some embodiments, outputting, via the one or more output devices, the second response to the second input includes moving, via the movement component, with a second pattern of movement different from the first pattern of movement. In some embodiments, the second pattern of movement does not include the first pattern of movement, and/or vice-versa.

In some embodiments, the first response includes a first set of one or more audio characteristics (e.g., tempo, beat, volume, and/or intensity), and the second response includes a second set of one or more audio characteristics (e.g., tempo, beat, volume, and/or intensity) different from the first set of one or more audio characteristics.

In some embodiments, outputting, via the one or more output devices, the first response to the first input includes displaying, via the display component, a first set of one or more indications (e.g., one or more user interface objects, elements, symbols, text, images, video, and/or representations). In some embodiments, outputting, via the one or more output devices, the second response to the second input includes displaying, via the display component, a second set of one or more indications (e.g., one or more user interface objects, elements, symbols, text, images, video, and/or representations) different from the first set of one or more indications.

In some embodiments, the first response includes a first indication (e.g., text, image, description, and/or video) of the content. In some embodiments, the second response includes a second indication (e.g., text, image, description, and/or video) of the content different from the first indication of the content.

In some embodiments, the first response includes an indication (e.g., what type of work product, what topic, and/or what types of medications (e.g., types of modifications that can be done to the work product) (e.g., work product as described above in relation to process 700-process 1000) corresponds to the work product) that the content is a first type. In some embodiments, the second response includes an indication (e.g., what type of work product, what topic, and/or what types of medications (e.g., types of modifications that can be done to the work product) (e.g., work product as described above in relation to process 700-process 1000) corresponds to the work product) that the content is a second type different from the first type.

In some embodiments, the first response includes an indication that a third portion of the content is a portion of interest (e.g., as described above in relation to process 700-process 1000). In some embodiments, the second response includes an indication that a fourth portion of the content is the portion of interest (and does not include the indication that the third portion of the content is the portion of interest). In some embodiments, the first response does not include the indication that the fourth portion of content is the portion of interest.

In some embodiments, the first internal dialogue corresponds to a first user (e.g., 804) (e.g., person, animal, object, and/or thing). In some embodiments, the second internal dialogue corresponds to a second user (e.g., 804) (e.g., person, animal, object, and/or thing) different from the first user (e.g., as described above in FIGS. 8A-8E) (and does not correspond to the first user). In some embodiments, the first internal dialogue does not correspond to the second user.

In some embodiments, the first internal dialogue corresponds to a first topic (e.g., subject matter, plot, title, content description, and/or overarching theme). In some embodiments, the second internal dialogue corresponds to a second topic (e.g., subject matter, plot, title, content description, and/or overarching theme) different from the first topic (and does not correspond to the first user). In some embodiments, the first internal dialogue does not correspond to the second user.

In some embodiments, after establishing the second internal dialogue, the computer system detects a request (e.g., 805a, 805d1, and/or 805d2) (e.g., via a verbal input (e.g., a verbal input, an audible request, an audible command, and/or an audible statement) and/or a non-verbal input (e.g., a swipe input, a hold-and-drag input, a gaze input, an air gesture, and/or a mouse click)) corresponding to the content that excludes the second portion of the content. In some embodiments, in response to detecting the request (e.g., 805a, 805d1, and/or 805d2) corresponding to the content that excludes the second portion of the content, the computer system re-establishes the first internal dialogue and de-establishing the second internal dialogue. In some embodiments, de-establishing the second internal dialogue includes removing and/or deleting the second internal dialogue. In some embodiments, de-establishing the second internal dialogue includes preserving the second internal dialogue.

In some embodiments, after establishing the second internal dialogue, the computer system moves, via a movement component, from the second position to a third position, such that a fourth portion of the content is in the field-of-view of the one or more cameras (e.g., 806), wherein the fourth portion is different from the first portion and the second portion. In some embodiments, after establishing the second internal dialogue and moving, via a movement component, from the second position to the third position, such that the fourth portion of the content is in the field-of-view of the one or more cameras (e.g., 806), the computer system establishes a third internal dialogue (e.g., based on the context related to the request, the first portion of the content, the second portion of the content, and/or the fourth portion of the content) (e.g., a set of one or more rules, characteristics, detections, and/or observations that the computer system uses generate a response to one or more commands, questions, and/or statements) (and, in some embodiments, the set of one or more rules, characteristics, detections, and/or observations are learned and/or generated via deep learning and/or one or more machine learning algorithms, and/or using one or more machine learning agents and/or system agents) (and, in some embodiments, an internal dialogue is generated in real-time; in some embodiments, an internal dialogue is modified, and/or in some embodiments, an internal dialogue is generated based on other internal dialogues) different from the first internal dialogue and the second internal dialogue (and, in some embodiments, de-establishing the second internal dialogue).

In some embodiments, after establishing the second internal dialogue, the computer system moves, via a movement component, from the second position to a fourth position, such that a fifth portion of the content is in the field-of-view of the one or more cameras (e.g., 806), wherein the fifth portion is different from the first portion and the second portion. In some embodiments, after establishing the second internal dialogue and moving, via a movement component, from the second position to the third position, such that the fifth portion of the content is in the field-of-view of the one or more cameras (e.g., 806), the computer system forgoes de-establishing the second internal dialogue without establishing another internal dialogue (and, in some embodiments, without detecting a change in context).

Note that details of the processes described above with respect to process 1300 (e.g., FIG. 13) are also applicable in an analogous manner to the methods described below/above. For example, process 1200 optionally includes one or more of the characteristics of the various methods described above with reference to process 1300. For example, the computer system can use one or more techniques of process 1200 to output an object to incorporate in content based on a request indicating a second person is associated with content using one or more techniques of process 1300. For brevity, these details are not repeated below.

FIGS. 14A-14E illustrate exemplary user interfaces for outputting navigation content in accordance with some embodiments. The user interfaces in these figures are used to illustrate the processes described below, including the processes in FIGS. 15 and 16.

FIGS. 14A-14E illustrate computer system 1400 (e.g., a tablet) displaying different user interface objects. It should be recognized that computer system 1400 can be other types of computer systems such as a smart phone, a smart watch, a laptop, a communal device, a smart speaker, an accessory, a personal gaming system, a desktop computer, a fitness tracking device, and/or a head-mounted display (HMD) device. In some embodiments, computer system 1400 includes and/or is in communication with one or more input devices and/or sensors (e.g., a camera, a lidar detector, a motion sensor, an infrared sensor, a touch-sensitive surface, a physical input mechanism (such as a button or a slider), and/or a microphone). Such sensors can be used to detect presence of, attention of, statements from, inputs corresponding to, requests from, and/or instructions from a subject in an environment. It should be recognized that, while some embodiments described herein refer to inputs being voice inputs, other types of inputs can be used with techniques described herein, such as touch inputs via a touch-sensitive surface and air gestures detected via a camera. In some embodiments, computer system 1400 includes and/or is in communication with one or more output devices (e.g., a display screen, a projector, a touch-sensitive display, speaker, and/or a movement component). Such output devices can be used to present information and/or cause different visual changes of computer system 1400. In some embodiments, computer system 1400 includes and/or is in communication with one or more movement components (e.g., an actuator, a moveable base, a rotatable component, and/or a rotatable base). Such movement components, as discussed above, can be used to change a position (e.g., location and/or orientation) of computer system 1400 and/or a portion (e.g., including one or more sensors, input components, and/or output components) of computer system 1400. In some embodiments, computer system 1400 includes one or more components and/or features described above in relation to computer system 100 and/or electronic device 200. In some embodiments, computer system 1400 includes one or more agents and/or functions of an agent as described above with respect to FIG. 5. In some embodiments, computer system 1400 is, includes, implements, and/or is in communication with one or more agent systems, as described above with respect to FIG. 5, for performing (and/or causing performance of) one or more operations of an agent. For example, avatar 1452 can be a representation of an agent that interacts with inputs to computer system 1400 (e.g., and provides suggested navigation routes and/or performs one or more operations related to navigation).

FIGS. 14A-14E illustrate a computer system 1400 (e.g., a smartphone, a smartwatch, a television) that is in communication with one or more input devices (e.g., a camera, a depth sensor, and/or a microphone). Computer system 1400 can display, via a display generation component (e.g., a display screen, a projector, and/or a touch-sensitive display), navigation user interfaces. Computer system 1400 can detect inputs (e.g., verbal inputs, air gestures, and/or touch inputs) via input devices (e.g., cameras, microphones, and/or physical controllers) in communication with computer system 1400. In some embodiments, in response to detecting an input, computer system 1400 provides multiple suggested navigation routes, from the same or different sources (e.g., navigation applications, services, databases, and/or interfaces). In the following examples described with respect to FIGS. 14A-14E, computer system 1400 can provide a suggested route with a relevant intermediate destination (e.g., that was not requested explicitly in input). In some embodiments, an intermediate destination is a destination (e.g., location, point of interest, and/or place on a map) along a navigation route that is different than an end destination of the navigation route. In some embodiments, an intermediate destination is suggested based on contextual information, which is discussed in greater detail below with respect to the examples of FIGS. 14A-14E.

FIGS. 14A-14E each include two portions, a left portion and a right portion. The right portions of FIGS. 14A-14E illustrate a top-down schematic view 1480 of a physical environment that includes that includes camera 1406. The top-down schematic views of FIGS. 14A-14E illustrate field of view 1404 of camera 1406 of computer system 1400. Field of view 1404 is visually represented as the area between the dotted lines in schematic view 1480. The top-down schematic view 1480 can also include one or more subjects (e.g., 1402) (e.g., users detected by computer system 1400). The left portions of FIGS. 14A-14E illustrate output of a display in communication with computer system 1400 (e.g., and represent what is currently being displayed by the display, such as navigation user interface 1408 in FIG. 14D).

A brief discussion of concepts related to navigation routes may be helpful for understanding the description and techniques that follow, such as references to intermediate destinations with a navigation application. In some embodiments, in response to detecting an input, computer system 1400 generates (e.g., determines, retrieves, and/or calculates) and/or provides a suggested route to a desired destination. In some embodiments, computer system 1400 generates and/or provides a suggested route with an intermediate destination. For example, an intermediate destination is not the desired end destination but rather is provided as a recommendation for a stop prior to the desired destination. However, a suggested route with an intermediate destination can be useful by offering a relevant navigation option that, in some embodiments, is not explicitly requested via input. Computer system 1400 can display a suggested route with an intermediate destination concurrently with other route options, offering a subject a choice on a route that best suits their current situation. For example, in a situation where a subject wants to get to the desired destination with no stops, a subject can reject a suggested route with an intermediate destination. For example, in a situation where computer system 1400 outputs a suggested route with an intermediate destination, it can be a useful reminder to the user (e.g., that the user needs to pick up a package at the post office, needs to stop for gas in their vehicle, needs to pick up a food order, needs to pick up a friend, and/or was requested in a message conversation to stop at the store).

In some embodiments, an intermediate destination is determined (e.g., created, inferred from, selected based on, identified in, and/or provided) based on contextual information. In some embodiments, contextual information can be from a navigation application and/or from other sources. For example, contextual information can be sourced from and/or provided from messages, calendars (e.g., the owner of computer system 1400 and/or another subject are attendees of a calendar event), system location, addresses, tracked behaviors, subject input, time of day, weather, subject info (e.g., the info of the owner of computer system 1400 and/or the info of another subject), and/or online history to form a relevant intermediate destination for a suggested route.

For example, consider a scenario where computer system 1400 utilizes contextual information derived from subject habits. If a subject stops by a gas station every day before work to get coffee, in response to detecting input of a request for directions to the subject's work, computer system 1400 can provide a suggested route with an intermediate destination (e.g., the gas station where the subject gets coffee) between the current location (e.g., the location of computer system 1400) and the desired destination (e.g., work).

In another example, consider a scenario where computer system 1400 utilizes contextual information from a calendar. If a dinner reservation calendar event involves a subject and a member of the subject's family, in response to detecting input of a request for directions to the restaurant, computer system 1400 can provide a suggested route with an intermediate destination (e.g., the family member's house on the way to the restaurant) between the current location (e.g., the location of computer system 1400) and the desired destination (e.g., the restaurant).

In another example, consider a scenario where computer system 1400 utilizes contextual information from messages. If a subject messages a family member that they are out of dog food, in response to detecting input of a request for directions to home, computer system 1400 can provide a suggested route with an intermediate destination (e.g., a pet store) between the current location (e.g., the location of computer system 1400) and the desired destination (e.g., the home location).

In some embodiments, computer system 1400 provides a suggested route (e.g., one or more suggested routes) in response to input (e.g., one or more of verbal input, air gesture, gaze input, and/or physical input (e.g., touch input and/or contact with a physical control)). In some embodiments, a provided (e.g., displayed and/or otherwise output) suggested route includes an intermediate destination (e.g., one or more intermediate destinations). In some embodiments, computer system 1400 does not provided a suggested route that includes an intermediate destination.

In some embodiments, a navigation user interface can be utilized in connection with a computer system tracking application (e.g., for sharing location with friends and/or family). For example, in response to input, computer system 1400 can output a suggested route that includes a location of another subject as an intermediate destination if the other subject is on the way and/or somehow related to a requested end destination. The other subject's location can be provided by and/or shared via the computer system tracking application. For example, if John is going to meet Jane for lunch, computer system 1400 can detect that Jane is at her house. If computer system 1400 detects an input for directions to lunch in a navigation user interface, computer system 1400 can suggest a route with Jane's house as an intermediate destination on the way to the restaurant for lunch (e.g., for picking Jane up). In some embodiments, computer system 1400 (e.g., via a navigation application and/or a computer system tracking application) can notify another subject (e.g., send a message to an account and/or devices associated with the other subject) that a subject (e.g., the subject utilizing a navigation user interface) is navigating to the location of the other subject. For example, in the previous example, if John accepted the suggested route with Jane's house as an intermediate destination, a computer system belonging to Jane can notify her that John is on his way.

In some embodiments, in response to input, computer system 1400 can suggest an intermediate destination route only if another subject is detected at an intermediate destination. For example, in the previous example, if Jane is not detected to be at her house (e.g., as determined using the computer system tracking application), computer system 1400 will not provide a suggested route that includes Jane's house as an intermediate destination.

FIG. 14A illustrates subject 1402 and computer system 1400. Subject 1402 is able to interact with computer system 1400 (e.g., with an agent via computer system 1400) (e.g., computer system 1400 detects subject 1402 with use of camera 1406 (e.g., computer system 1400 detects subject 1402 within field of view 1404)). At FIG. 14A, computer system 1400 detects input 1405a (e.g., “Can you give me directions to brunch?”).

As illustrated in FIG. 14A, in response to detecting input 1405a, computer system 1400 displays navigation user interface 1408. Navigation user interface 1408 includes map indicator 1476. Map indicator 1476 indicates the surrounding area of the current location of user 1402. Computer system 1400 displays current location indicator 1412, intermediate destination indicator 1414, and destination indicator 1416 within map indicator 1476.

Current location indicator 1412 includes a label (e.g., “You are here”). Current location indicator 1412 visually indicates the current location of computer system 1400. Intermediate destination indicator 1414 indicates an intermediate destination and includes a label (e.g., “Jill's house”). Intermediate destination location indicator 1414 visually indicates an intermediate location. Destination indicator 1416 includes a label (e.g., “The Cafe”). Destination location indicator 1416 visually indicates a desired end destination.

As illustrated in FIG. 14A, in response to detecting input 1405a, computer system 1400 displays multiple different suggested routes within the same user interface. As illustrated in FIG. 14A, computer system 1400 displays route portion indicator 1418, route portion indicator 1420, and route indicator 1422 within map indicator 1476. Route portion indicator 1418 indicates route directions from the current location to the intermediate destination. Route portion indicator 1420 indicates route directions from the intermediate destination to the desired destination. Together, route portion indicators 1418 and 1420 represent a suggested route with an intermediate destination. Route indicator 1422 indicates a direct route to the desired destination.

In some embodiments, computer system 1400 provides a set of characteristics for route portions to an intermediate destination. For example, travel time to the intermediate destination, distance, time of arrival, mode of transport, and/or path information (e.g., hazards, inclines, and/or tolls).

As illustrated in FIG. 14A, computer system 1400 displays intermediate destination route indicator 1424 and direct route indicator 1426. Computer system 1400 displays intermediate destination route indicator 1424 and direct route indicator 1426 within close proximity to (e.g., touching, adjacent to, overlapping, and/or pointing to) (and/or otherwise identifying (e.g., via matching colors, patterns, and/or visual indication)) the routes they correspond to. Intermediate destination route indicator 1424 indicates the travel time of the suggested route that includes route portion indicator 1418 and route portion indicator 1420 (e.g., “Drive to Jill's house, then The Cafe 18 minutes via the maps application”). Direct route indicator 1426 indicates the travel time of the suggested route represented by direct route indicator 1422 (e.g., “Walk 33 minutes via the maps application”).

In some embodiments, in response to detecting input, computer system 1400 outputs navigation (e.g., suggested routes) by audio only (e.g., an audible representation of the suggested routes is provided without displaying a visual representation). In some embodiments, in response to input, computer system 1400 does not provide a suggested route with an intermediate destination. In some embodiments, in response to input, computer system 1400 begins navigation automatically utilizing a suggested route with an intermediate destination. For example, in response to detecting input (e.g., “Take me to the grocery store, then to the post office”), computer system 1400 can initialize (e.g., begin and/or suggest) navigation according to a suggested route with an intermediate destination (e.g., the grocery store) and to a desired end destination (e.g., the post office).

In some embodiments, in response to detecting input for directions to a destination, computer system 1400 provides a route to the destination without an intermediate destination (e.g., represented by route indicator 1422).

In the example illustrated in FIG. 14A, each of the suggested routes comes from the same application, a maps application, which is the application that displays (e.g., causes display of) navigation user interface 1408 of FIG. 14A. In some embodiments, computer system 1400 provides an indication of a source (e.g., application and/or data source) providing a route. For example, if a route is derived from a public transportation application, computer system 1400 can display an indication of the public transportation application. In some embodiments, in response to detecting input for directions to a destination, computer system 1400 provides a route to the destination without an intermediate destination. For example, if a subject provides input detected by computer system 1400 for directions to a shopping mall wherein such directions include an intermediate destination, if the subject provides a subsequent input (e.g., “Actually, I want to go to the shoe store”), computer system 1400 provides a new suggested route without an intermediate destination (e.g., removes the intermediate destination from the currently suggested route and/or suggests a new route without the intermediate destination).

FIG. 14B illustrates subject 1402 and computer system 1400. Subject 1402 is able to interact with computer system 1400 (e.g., computer system 1400 detects subject 1402 with use of camera 1406 (e.g., computer system 1400 detects subject 1402 within field of view 1404)). At FIG. 14B, computer system 1400 detects input 1405b (e.g., “Can you give me directions to The Cafe?”).

As illustrated in FIG. 14B, in response to detecting input 1405b, computer system 1400 displays rideshare user interface 1428 (e.g., a user interface from a third-party application). In the example illustrated in FIG. 14B, the suggested route comes from a rideshare application (e.g., different from the maps application of FIG. 14A), which is the application that displays (e.g., causes display of) rideshare user interface 1428 of FIG. 14B. Rideshare user interface 1428 includes map indicator 1476. Computer system 1400 displays current location indicator 1412, rideshare route indicator 1442, destination indicator 1416, vehicle indicator 1444, vehicle indicator 1446, and vehicle indicator 1448 within map indicator 1476. Computer system location indicator 1412 includes a label (e.g., as described with respect to FIG. 14A). Destination indicator 1416 includes a label (e.g., as described with respect to FIG. 14A). Rideshare route indicator 1442 indicates a suggested route for a rideshare application route. Vehicle indicator 1444, vehicle indicator 1446, and vehicle indicator 1448 all indicate the positions of vehicles available for ridesharing services detected within the surrounding area.

As illustrated in FIG. 14B, computer system 1400 displays user interface label indicator 1430, rideshare option region 1432, rideshare option region 1434, rideshare option region 1436, booking control 1438, and rideshare arrival indicator 1440 within rideshare user interface 1428. Computer system 1400 displays user interface label indicator 1430 (e.g., “Rideshare app”) to indicate the current user interface.

Rideshare region option 1432 includes option control 1432a, rideshare type indicator 1432b, and price indicator 1432c. Option control 1432a, if activated, allows computer system 1400 to confirm a rideshare option. Computer system 1400 displays an indicator and/or control as filled in to indicate that an option control is selected (e.g., option control 1432a is selected in FIG. 14B). Computer system 1400 displays rideshare type indicator 1432b to indicate the type of rideshare a subject can book (e.g., “Ride”). Computer system 1400 displays price indicator 1432c to indicate the price of rideshare option region 1432 (e.g., $4.00).

Rideshare region option 1434 includes option control 1434a, rideshare type indicator 1434b, and price indicator 1434c. Option control 1434a, if activated, allows computer system 1400 to confirm a rideshare option. Computer system 1400 displays rideshare type indicator 1434b to indicate the type of rideshare a subject can book (e.g., “RideXL”). Computer system 1400 displays price indicator 1434c to indicate the price of rideshare option region 1434 (e.g., $6.00).

Rideshare region option 1436 includes option control 1436a, rideshare type indicator 1436b, and price indicator 1436c. Option control 1436a, if activated, allows computer system 1400 to confirm a rideshare option. Computer system 1400 displays rideshare type indicator 1436b to indicate the type of rideshare a subject can book (e.g., “Carpool”). Computer system 1400 displays price indicator 1436c to indicate the price of rideshare option region 1436 (e.g., $3.00). Booking control 1438, if activated, allows computer system 1400 to book (e.g., reserve, coordinate, and/or purchase) a ride. Computer system 1400 displays rideshare arrival indicator 1440 to indicate the arrival time of a rideshare driver.

FIGS. 14A and 14B illustrate two different navigation-related user interfaces, one corresponding to a maps application and one corresponding to a rideshare application, each displayed separately and at different times. However, a user can check multiple different sources of navigation data. Accessing different applications and repeating and/or providing additional inputs to get results can be a waste of device resources. Further, computer system 1400 can provide a single user interface for both detecting input, providing suggested routes, and/or performing navigation-related operations involving multiple applications. In the examples as described with respect to FIGS. 14C-14E, computer system 1400 provides an agent for interacting with a user, provides a unified set of results, and performs navigation tasks such as booking a rideshare.

FIG. 14C illustrates subject 1402 and computer system 1400. Computer system 1400 interacts with subject 1402 (also referred to herein as user 1402) via one or more input devices (e.g., computer system 1400 detects subject 1402 with use of camera 1406 (e.g., computer system 1400 detects subject 1402 within field of view 1404)). As illustrated in FIG. 14C, computer system 1400 displays avatar 1452 (e.g., a user interface object that is a representation of an agent (e.g., a virtual assistant)) In some embodiments, the agent is a system agent (e.g., corresponding to an operating system process and/or application of computer system 1400). In some embodiments, the agent is an application agent (e.g., corresponding to an application installed (e.g., not part of the operation system) on computer system 1400). At FIG. 14C, computer system 1400 detects input 1405c (e.g., “Can you give me directions to brunch?”).

As illustrated in FIG. 14D, in response to detecting input 1405c, computer system 1400 displays navigation user interface 1408. Navigation user interface 1408 includes suggested routes from multiple sources, in particular from the map application illustrated in FIG. 14A and the rideshare application illustrated in FIG. 14B (e.g., computer system 1400 conveniently displays all relevant routes from multiple application sources in one user interface). As illustrated in FIG. 14D, computer system 1400 displays avatar 1452 in a smaller manner (e.g., a smiley face) within navigation user interface 1408 (e.g., such that avatar 1452 can continue to be displayed and continue to interact with a user and not overlay visual content related to navigation). Additionally, in response to input 1405c, computer system 1400 outputs audio output 1478 (e.g., “Here are some suggestions”).

As illustrated in FIG. 14D, navigation user interface 1408 includes map indicator 1476. Computer system 1400 displays current location indicator 1412 (e.g., as described with respect to FIG. 14A), intermediate destination user interface object 1414 (e.g., as described with respect to FIG. 14A), and destination indicator 1416 (e.g., as described with respect to FIG. 14A), route portion indicator 1418 (e.g., as described with respect to FIG. 14A), route portion indicator 1420 (e.g., as described with respect to FIG. 14A), route indicator 1422 (e.g., as described with respect to FIG. 14A), and rideshare route indicator 1442 (e.g., as described with respect to FIG. 14B) within map indicator 1476. Additionally, computer system 1400 displays intermediate destination route indicator 1424 (e.g., as described with respect to FIG. 14A), direct route indicator 1426 (e.g., as described with respect to FIG. 14A), and rideshare route indicator 1454. Rideshare route indicator 1454 indicates information corresponding to rideshare route 1442 such as the travel time expected for rideshare route 1442 (e.g., “RideShare 17 minutes via Rideshare app”) (e.g., and can include the same and/or different information as described above with respect to 1424 and 1426). At FIG. 14D, computer system 1400 detects input 1405d (e.g., “I'll take the rideshare”).

In some examples, in response to a verbal input, computer system 1400 can display a route from a new application (e.g., an application different than the map application seen in FIG. 14A and the Rideshare application seen in FIG. 14B). For example, in the example above, in response to detecting verbal input 1405c, computer system 1400 displays a route from the maps application and a route from a rideshare application. In this example, computer system 1400 can display a route from an internet navigation application within map indicator 1476. In some examples, a new route is sourced from a mapping application and/or a rideshare application. For example, in response to detecting a verbal input, computer system 1400 displays a route from the maps application and a route from a rideshare application.

As illustrated in FIG. 14E, in response to detecting input 1405d, computer system 1400 selects rideshare route indicator 1442. As illustrated in FIG. 14E, in response to selecting rideshare route indicator 1442, computer system 1400 ceases to display navigation user interface 1408 and automatically displays rideshare user interface 1428 (e.g., the same and/or similar to as described with respect to FIG. 14B). In some embodiments, computer system 1400 continues to display navigation user interface 1408 together with and/or instead of rideshare user interface 1428. For example, navigation user interface 1408 can include content (e.g., appearance and/or data) from the rideshare application. For example, rather than navigating away from the maps application, away from an agent interface, and/or launching (e.g., for display) the rideshare application, computer system 1400 continues to present a unified user interface experience as described with respect to FIG. 14C.

As illustrated in FIG. 14E, rideshare user interface 1428 (e.g., or navigation user interface 1408) includes map indicator 1476, user interface label indicator 1430 (e.g., “Rideshare App”), avatar 1452, rideshare confirmation indicator 1456 (e.g., “Thanks for booking! Have a good ride!”) and rideshare arrival indicator 1440 (e.g., “Arrives in 3 minutes”). Rideshare confirmation indicator 1456 indicates that a ride (e.g., a vehicle, and/or a means of transport) has been confirmed. Rideshare arrival indicator 1440 indicates the time until a booked ride arrives at a subject's location (e.g., computer system location indicator 1412). Additionally, in response to detecting input 1405d, computer system 1400 outputs audio output 1405e (e.g., “Okay. Your ride arrives in three minutes”).

As illustrated in FIG. 14E, map indicator 1476 includes current location indicator 1412, destination indicator 1416, rideshare route indicator 1442, vehicle user interface object 1444 (e.g., representing the incoming rideshare that was booked), and rideshare arrival route indicator 1458. Rideshare arrival route indicator 1458 indicates the travel time corresponding with the arrival of vehicle user interface object 1444 to current location indicator 1412. Additionally, computer system 1400 ceases displaying route portion indicator 1418, route portion indicator 1420, intermediate destination indicator 1414, and direct route indicator 1422.

In some embodiments, in response to detecting input for a route selection, computer system 1400 does not display a user interface that the selected route is from. In some embodiments, in response to detecting input for a route selection, computer system 1400 continues to display a navigation user interface of a first application (e.g., currently displayed), even if the route selected is sourced from a different, second application. For example, computer system 1400 can continue displaying navigation user interface 1408 from the maps application even though a rideshare suggested route was selected that was sourced from the rideshare application. In some embodiments, computer system 1400 incorporates (e.g., and/or makes available, such as via interaction with the agent represented by avatar 1452) elements from a different application into the first application user interface. For example, computer system 1400 allows performance of navigation operations of (e.g., while displaying and/or on) (e.g., booking a rideshare) and/or display of visual user interface objects (e.g., vehicle user interface object 1444) from the rideshare application at navigation user interface 1408 of maps application.

In some embodiments, in response to detecting input, computer system 1400 displays a route from the map application without outputting a route from the rideshare application. For example, in response to detecting a request for a route to the airport, computer system 1400 can suggest a route corresponding to a public transit through a mapping application and a route from a rideshare application. For example, in response to detecting a request for a route to a local taco shop, computer system 1400 can only suggest a route corresponding to self-driven route through a map application.

FIG. 15 is a flow diagram illustrating a method for outputting a route to a destination with an intermediate destination using a computer system in accordance with some embodiments. Method 1500 is performed at a computer system (e.g., 100, 200, and/or 1400). The computer system is in communication with one or more input devices and one or more output devices. Some operations in method 1500 are, optionally, combined, the orders of some operations are, optionally, changed, and some operations are, optionally, omitted.

As described below, method 1500 provides an intuitive way for outputting a route to a destination with an intermediate destination. The method reduces the cognitive burden on a user for outputting a route to a destination with an intermediate destination, thereby creating a more efficient human-machine interface. For battery operated computing devices, enabling a user to output a route to a destination with an intermediate destination faster and more efficiently conserves power and increases the time between battery charges.

In some embodiments, method 1500 is performed at a computer system (e.g., 100, 200, and/or 1400) that is in communication with one or more input devices (e.g., 140 and/or 200-14) (e.g., a camera, a depth sensor, and/or a microphone) and one or more output devices (e.g., 140 and/or 200-16) (e.g., a speaker, a haptic output device, a display screen, a projector, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

The computer system detects (1502), via the one or more input devices, input (e.g., 1405a, 1405b, and/or 1405c) (e.g., a tap input and/or a non-tap input (e.g., a verbal input, an audible request, an audible command, an audible statement, a swipe input, a hold-and-drag input, a gaze input, an air gesture, and/or a mouse click)) corresponding to (e.g., that includes, that is, that is configured to represent, and/or that is determined to represent) a request to navigate to a first destination (e.g., 1416) (e.g., a location, such as a geographic location) (e.g., from a current location and/or from another location) (e.g., as described above in FIGS. 14A-14C).

In response to (1504) detecting the input (e.g., 1405a, 1405b, and/or 1405c) corresponding to the request to navigate to the first destination (e.g., 1416), in accordance with a determination that the first destination (e.g., 1416) corresponds to (e.g., is referenced in, is identified in, and/or is a location associated with) contextual information (e.g., 1410) (e.g., that corresponds to the request and/or a user making the request) (e.g., data that includes, refers to, links, and/or identifies different locations (e.g., destinations, such as intermediate destinations to other destinations)), the computer system outputs (1506), via the one or more output devices, a first response (e.g., 1414, 1424, and/or 1478) that includes a first suggested route (e.g., 1418, and/or 1420) to the first destination with a first intermediate destination (e.g., 1414) (e.g., that is located between a beginning of the suggested route and the first destination), wherein the input (e.g., 1405a, 1405b, and/or 1405c) corresponding to the request to navigate to the first destination does not include an indication of (e.g., name of, identifier of, description of, reference to, description of, and/or location of) (e.g., explicit and/or implicit indication of) the first intermediate destination.

In response to (1504) detecting the input (e.g., 1405a, 1405b, and/or 1405c) corresponding to the request to navigate to the first destination (e.g., 1416), in accordance with a determination that the first destination (e.g., 1416) does not correspond to the contextual information (e.g., 1410), the computer system outputs (1508), via the one or more output devices, a second response (e.g., different from the first response) that includes a second suggested route (e.g., 1442) (e.g., different from the first suggested route) to the first destination without the first intermediate destination (e.g., 1414) (e.g., without outputting the first response) (e.g., as described above in FIGS. 14A-14D). In some embodiments, in response to detecting the input corresponding to the request to navigate to the first destination and in accordance with a determination that the first destination corresponds to different contextual information (e.g., 1410), the computer system outputs, via the one or more output devices, another response that includes another suggested route to the first destination with another intermediate destination different from the first intermediate destination. In some embodiments, the input corresponding to the request to navigate to the first destination does not include an indication of (e.g., name of, identifier of, description of, reference to, description of, and/or location of) (e.g., explicit and/or implicit indication of) the other intermediate destination. In some embodiments, the contextual information is obtained through one or more applications accessed by the computer system. In some embodiments, contextual information may be obtained through user profiles, user preferences, user location, and/or user usage history of applications. Outputting a first response that includes a first suggested route to the first destination with a first intermediate destination or outputting a second response that includes a second suggested route to the first destination without the first intermediate destination based on whether a request corresponds to contextual information enables the computer system to intelligently suggest an additional stop along a suggested route, thereby providing improved feedback to the user and/or performing an operation when a set of conditions has been met without requiring further user input.

In some embodiments, the first response (e.g., 1414, 1424, and/or 1478) includes an indication (e.g., a marker, a waypoint, an identifier, and/or an audio output) of the first intermediate destination (e.g., 1414) (e.g., as described above in FIGS. 14A-14D). In some embodiments, the indication of the first intermediate destination is displayed along route to the first destination. In some embodiments, the indication of the first intermediate destination is output as an audio output. In some embodiments, outputting the first response includes (e.g., is comprised of, in whole or in part) outputting, via the one or more output devices, the indication of the first destination. Having the first response include an indication of the first intermediate destination enables the computer system to highlight the suggested stop along the suggested route, thereby providing improved feedback to the user and/or performing an operation when a set of conditions has been met without requiring further user input.

In some embodiments, the one or more output devices includes a first display generation component (e.g., as described with respect to FIGS. 14A-14E) (e.g., a display screen, a projector, and/or a touch-sensitive display). In some embodiments, outputting the first response (e.g., 1414, 1424, and/or 1478) includes displaying, via the first display generation component, a representation (e.g., a visual representation, such as a path in a map) of the first suggested route (e.g., 1418, and/or 1420) to the first destination (e.g., 1416) with the first intermediate destination (e.g., 1414) (e.g., as described above in FIGS. 14A-14E). In some embodiments, outputting the first response includes displaying, via the first display generation component, the first suggestion to the first destination with the first intermediate destination on and/or in a representation of a map. In some embodiments, outputting the second response includes displaying, via the first display generation component, a representation of the second suggested route to the first destination without the first intermediate destination. In some embodiments, a representation of the first suggested route is output, via a speaker of the one or more output devices, audio content. In some embodiments, a representation of the first suggested route is output via a speaker while another representation of the first suggested route is output via the first display generation component. In some embodiments, the first suggested route to the first destination with the first intermediate destination is presented on and/or in a representation of a map. Outputting the first response including displaying the representation of the first suggested route to the first destination with the first intermediate destination enables the computer system to visually show the first suggested route, thereby providing improved visual feedback to the user and/or performing an operation when a set of conditions has been met without requiring further user input.

In some embodiments, the one or more output devices include a second display generation component (e.g., a display screen, a projector, and/or a touch-sensitive display) (e.g., the first display generation component or a different display generation component). In some embodiments, outputting the first response (e.g., 1414, 1424, and/or 1478) includes displaying, via the second display generation component: a first segment (e.g., 1418) of the first suggested route (e.g., 1418, and/or 1420) (e.g., the first segment representing a first portion of the first suggested route that includes a route from a current user location to the first intermediate destination); and a second segment (e.g., 1420) of the first suggested route (e.g., 1418, and/or 1420) different from the first segment (e.g., the second segment representing a second portion (e.g., different from the first portion) of the first suggested route that includes a route from the first intermediate destination to the first destination) (e.g., as described above in FIGS. 14A-14D). In some embodiments, the first suggested route includes another segment of the first suggested route different from the first segment and the second segment. In some embodiments, the first segment does not overlap (e.g., follow the same path as and/or obscure) the second segment. In some embodiments, the first segment overlaps (e.g., partially and/or fully) the second segment. Outputting the first response includes displaying a first segment of the first suggested route and a second segment of the first suggested route enables the computer system to highlight the additional stop along the suggested route, thereby providing improved feedback to the user and/or performing an operation when a set of conditions has been met without requiring further user input.

In some embodiments, outputting the response (e.g., 1414, 1424, and/or 1478) includes displaying, via the second display generation component: a first indication (e.g., 1424 and/or 1478) of a first set of one or more characteristics (e.g., travel time of 18 minutes indicated by 1424 of FIG. 14D) (e.g., environmental conditions (e.g., weather, pollen, and/or pollution) and/or travel information (e.g., travel time to the intermediate destination, distance, time of arrival, mode of transport, tolls, inclines, and/or accidents)) of the first segment (e.g., 1418); and a second indication of a second set of one or more characteristics (e.g., travel time of 18 minutes indicated by 1424 of FIG. 14D) (e.g., environmental conditions (e.g., weather, pollen, and/or pollution) and/or travel information (e.g., travel time to the intermediate destination, distance, time of arrival, mode of transport, tolls, inclines, and/or accidents)) of the second segment (e.g., 1420). In some embodiments, the first indication is different from the second indication (e.g., as described above in FIGS. 14A-14E). In some embodiments, the first indication and the second indication are displayed concurrently. In some embodiments, the first indication and the second indication are not displayed concurrently. In some embodiments, the first indication and the second indication are displayed in response to detecting input (e.g., of and/or corresponding to a user). Displaying a first indication of a first set of one or more characteristics of the first segment and a second indication of a second set of one or more characteristics of the second segment enables the computer system to present additional information known about a suggested route other than a path, thereby providing improved visual feedback to the user and/or performing an operation when a set of conditions has been met without requiring further user input.

In some embodiments, the first segment (e.g., 1418) represents a route (e.g., portion of the suggested route) from a starting location (e.g., 1412) (e.g., of the first suggested route) (e.g., user location and/or location of computer system) to the first intermediate destination (e.g., 1414) (e.g., and not a route from the first intermediate destination to the first destination) (e.g., as described above in FIGS. 14A-14D). In some embodiments, the starting location is determined via a geographic positioning system (e.g., global position system (GPS)). In some embodiments, the starting location is identified, detected, and/or received via and/or from an application of the computer system. In some embodiments, the starting location is determined based on input detected via the one or more input devices. In some embodiments, the input corresponding to the request to navigate to the first destination includes an identification of the starting location. Having the first segment represent a route from a starting location enables the computer system to distinguish multiple sections of the suggested route and/or assist the user in getting from one place to another, thereby providing improved feedback to the user and/or performing an operation when a set of conditions has been met without requiring further user input.

In some embodiments, the second segment (e.g., 1420) represents a route (e.g., portion of the suggested route) from the first intermediate destination (e.g., 1414) to the first destination (e.g., 1416) (e.g., the end of the first suggested route) (e.g., as described above in FIGS. 14A-14D). In some embodiments, the first destination is determined via a geographic positioning system (e.g., global position system (GPS)). In some embodiments, the first destination is identified, detected, and/or received via and/or from an application of the computer system. In some embodiments, the first destination is determined based on input detected via the one or more input devices. In some embodiments, the input corresponding to the request to navigate to the first destination includes an identification of the first destination. Having the second segment represent a route from the first intermediate destination to the first destination enables the computer system to distinguish multiple sections of the suggested route and/or assist the user in getting from one place to another, thereby providing improved feedback to the user and/or performing an operation when a set of conditions has been met without requiring further user input.

In some embodiments, the contextual information (e.g., 1410) includes the first intermediate destination (e.g., 1414) (e.g., an identification of the first intermediate destination) (e.g., the determination that the first destination corresponds to the contextual information includes a determination that the first destination corresponds to the first intermediate destination) (e.g., as described above in FIGS. 14A-14D). In some embodiments, the contextual information does not include the first intermediate destination but rather the contextual information includes information (e.g., a name of a contact and/or a contact entry in an address book) that is used to identify the first intermediate destination (e.g., a saved and/or current location of the contact can be determined and used as the first intermediate destination). In some embodiments, the contextual information provides a link between the request to navigate to the first destination and the first intermediate destination. In some embodiments, the contextual information is included in the input and/or the request to navigate to the first destination. The contextual information including the first intermediate destination enables the computer system to suggest relevant intermediate destinations to a user based on current information known by the computer system, thereby providing improved feedback to the user and/or performing an operation when a set of conditions has been met without requiring further user input.

In some embodiments, the contextual information (e.g., 1410) includes (and/or is) event information (e.g., appointment(s) time, appointment(s) location, appointment(s) participants, and/or appointment(s) agenda) for a first event (e.g., appointment and/or meeting) of a calendar entry (e.g., Brunch with Jill at The Cafe in 1410) (e.g., calendar application, scheduling tool application, date planner application, and/or time management application) (e.g., the determination that the first destination corresponds to the contextual information is based on the event information) (e.g., as described above in FIGS. 14A-14C). In some embodiments, the contextual information is a calendar entry for a time within a predefined time of a current time and/or within a predefined distance from and/or along a path to the first destination. Having the contextual information include event information for a first event of a calendar entry enables the computer system to provide additional stops along the route based on personalized information, thereby providing improved feedback to the user and/or performing an operation when a set of conditions has been met without requiring further user input.

In some embodiments, the contextual information (e.g., 1410) includes (and/or is) information (e.g., residential address of first attendee, work address of first attendee, profile including likes and dislikes of first attendee, and/or schedule of first attendee) corresponding to a first subject (e.g., 1402 and/or Jill in 1410) (e.g., a person, an animal, and/or an object) (e.g., different from a user (1) of the computer system and/or (2) that performed the input corresponding to the request to navigate to the first destination) (e.g., the determination that the first destination corresponds to the contextual information is based on the information corresponding to the first subject). In some embodiments, the first subject corresponds to and/or is included in a second event (e.g., the first event or a different event) of a second calendar entry (e.g., the first calendar entry or a different calendar entry). In some embodiments, the information corresponding to the first subject is an identification of a name or a contact in a calendar entry for a time within a predefined time of a current time and/or within a predefined distance from and/or along a path to the first destination. In some embodiments, the identification of the name or the contact in the calendar entry is used to identify a contact entry in an address book and/or a location identification service to be used to identify a current location corresponding to the first subject (e.g., the current location being the first intermediate destination). For example, the current location can be obtained by requesting such information from a device of the first subject and/or can be included in the contact entry in the address book. Having the contextual information include information corresponding to the first subject enables the computer system to provide additional stops along the route based on personalized information, thereby providing improved feedback to the user and/or performing an operation when a set of conditions has been met without requiring further user input.

In some embodiments, the first subject (e.g., 1402 and/or Jill in 1410) is an attendee of a second event of a second calendar entry (e.g., the determination that the first destination corresponds to the contextual information (e.g., 1410) is based the second event including the first subject as an attendee). In some embodiments, the second event is linked to the first destination as a result of the second event being within a predefined time of a current time and/or within a predefined distance from and/or along a path to the first destination. Using calendar entries to identify intermediate destinations enables the computer system to provide additional stops along the route based on personalized information, thereby providing improved feedback to the user and/or performing an operation when a set of conditions has been met without requiring further user input.

In some embodiments, an event location of (e.g., a location configured for) the second event is the first destination (e.g., 1416) (e.g., the determination that the first destination corresponds to the contextual information (e.g., 1410) is based on the event location). Having the event location of the second event be the first destination enables the computer system to connect and/or link the first destination with attendees of the second event to identify one or more intermediate destinations for navigating to the first destination, each intermediate destination corresponding to an attendee of the attendees, thereby providing improved feedback to the user and/or performing an operation when a set of conditions has been met without requiring further user input.

In some embodiments, the first intermediate destination (e.g., 1414) is a location corresponding to the first subject (e.g., 1402) (e.g., a current location, a home location, a work location, and/or location shared by the first subject) (e.g., the first intermediate destination is an address corresponding to and/or of the first subject) (e.g., the first intermediate destination is identified based on the location corresponding to the first subject) (e.g., as described above in FIGS. 14A-14D). Having the first intermediate destination be a location corresponding to the first subject enables the computer system to provide an additional stop along the suggested route based on personalized information identified via a calendar entry and/or an address book, thereby providing improved feedback to the user and/or performing an operation when a set of conditions has been met without requiring further user input.

In some embodiments, in conjunction with outputting the first response, the computer system outputs, via the one or more output devices, an indication that the first subject (e.g., Jill in 1410) is currently located (e.g., currently determined to be located) at the first intermediate destination (e.g., Jill is home (e.g., at 1414) as described with respect to FIGS. 14A-14E) (e.g., 1414) (e.g., as described above in FIG. 14A). In some embodiments, the first intermediate destination is provided to the computer system by a device (e.g., different from the computer system) of the first subject after the computer system receives permission (e.g., from the first subject) to receive a current location of the first subject. In some embodiments, outputting the indication that the first subject is currently located at the first intermediate destination occurs after outputting the first response. In some embodiments, the indication that the first subject is currently located at the first intermediate destination is output while outputting the first response and/or the first suggested route. Outputting an indication that the first subject is located at the first intermediate destination enables the computer system to provide information about the status of people at the additional stop and/or a reason for adding the additional stop, thereby providing improved feedback to the user and/or performing an operation when a set of conditions has been met without requiring further user input.

In some embodiments, the determination that the first destination (e.g., 1416) corresponds to the contextual information (e.g., 1410) includes a determination that the first subject (e.g., Jill in 1410) is currently at the first intermediate destination (e.g., 1414). In some embodiments, the determination that the first destination does not correspond to the contextual information includes a determination that the first subject is not currently at the first intermediate destination (e.g., as described above at FIGS. 14A and 14D) (e.g., the first subject is determined to currently be at another location different from the first intermediate destination and/or a current location of the first subject is not able to be determined). The determination that the first destination corresponds to the contextual information including a determination that the first subject is currently at the first intermediate destination enables the computer system to provide an additional stop along the route based on whether or not the first subject is present at the additional stop, thereby providing improved feedback to the user and/or performing an operation when a set of conditions has been met without requiring further user input.

In some embodiments, after (and/or while) outputting the first response, the computer system detects, via the one or more input devices, an input (e.g., 1405d) corresponding to a request to navigate according to the first suggested route (e.g., 1418, and/or 1420). In some embodiments, after (and/or in response to) detecting the input (e.g., 1405d) corresponding to the request to navigate according to the first suggested route (e.g., 1418, and/or 1420), the computer system sends, via the one or more output devices, a communication to the first subject (e.g., a message to an account and/or device associated with Jill in 1410) (e.g., to an account and/or computer system of the first subject), wherein the communication includes an indication (e.g., when navigation begins, real time location data, and/or an estimated time of arrival) that the computer system (e.g., 1400) is navigating to the first subject (e.g., as described above in FIG. 14E). Sending the communication to the first subject enables the computer system to provide information related to navigation to other devices, thereby providing improved feedback and/or performing an operation when a set of conditions has been met without requiring further user input.

In some embodiments, the input corresponding to the request to navigate to the first destination (e.g., 1416) includes (and/or is) a verbal input (e.g., as described above in FIGS. 14A-14D). Having the input corresponding to the request to navigate to the first destination include verbal input enables the computer system to receive verbal commands and provide a suggested route, thereby providing improved feedback and/or reducing the number of inputs needed to perform an operation.

In some embodiments, the first response includes a third suggested route (e.g., 1422 and/or 1442) to the first destination (e.g., 1416). In some embodiments, the third suggested route is different from the first suggested route (e.g., 1418, and/or 1420) and the second suggested route (e.g., 1422 and/or 1442) (e.g., as described above in FIGS. 14A and 14D). Having the first response include a third suggested route to the first destination enables the computer system to provide alternative routes to the destination, thereby providing improved feedback to the user and/or reducing the number of inputs needed to perform an operation.

In some embodiments, the third suggested route to the first destination (e.g., 1416) includes a second intermediate destination (e.g., 1414) (e.g., same as the first intermediate destination or different from the first intermediate destination) (e.g., as described above in FIG. 14D). In some embodiments, the input corresponding to the request to navigate to the first destination does not include an indication of the second intermediate destination. Having the third suggested route to the first destination include a second intermediate destination enables the computer system to intelligently suggest additional stops along a suggested route, thereby providing improved feedback to the user and/or performing an operation when a set of conditions has been met without requiring further user input.

In some embodiments, the third suggested route to the first destination (e.g., 1416) does not include an intermediate destination (e.g., 1414) (e.g., the third suggested route is a direct route to the first destination than the first suggested route and the second suggested route without any suggested intermediate stops) (e.g., as described above in FIG. 14E). Having the third suggested route to the first destination without an intermediate destination enables the computer system to provide alternative routes directly to the destination without additional stops, thereby providing improved feedback to the user and/or reducing the number of inputs needed to perform an operation.

In some embodiments, the computer system detects an input (e.g., 1405d) (e.g., a tap input and/or a non-tap input (e.g., a verbal input, an audible request, an audible command, an audible statement, a swipe input, a hold-and-drag input, a gaze input, an air gesture, and/or a mouse click)) corresponding to selection of the first suggested route (e.g., 1418, 1420, 1422, and/or 1442) (and/or the first response) (e.g., while outputting the first response). In some embodiments, in response to detecting the input (e.g., 1405d) corresponding to selection of the first suggested route (e.g., 1442), the computer system initiates navigation according to the first suggested route (e.g., outputs, via the one or more output devices, a first navigation direction and/or instruction corresponding to the first suggested route). In some embodiments, after outputting the first navigation direction and/or instruction, the computer system outputs, via the one or more output devices, a second navigation direction and/or instruction corresponding to the first suggested route (e.g., turn-by-turn directions from a current location). In some embodiments, the second navigation direction and/or instruction is different from the first navigation direction and/or instruction. Detecting an input corresponding to selection of the first suggested route and initiating navigation according to the first suggested route enables the computer system to assist a subject to getting to the first intermediate destination and/or the first destination, thereby providing improved feedback to the user and/or reducing the number of inputs needed to perform an operation.

In some embodiments, the computer system detects (e.g., before and/or after outputting the first response that includes the first suggested route to the first destination with the first intermediate destination), via the one or more input devices, input (e.g., 1405a, 1405b, and/or 1405c) corresponding to a request to navigate to a second destination different from the first destination (e.g., 1416). In some embodiments, in response to detecting the input (e.g., 1405a, 1405b, and/or 1405c) corresponding to the request to navigate to the second destination, the computer system outputs, via the one or more output devices, a fourth suggested route (e.g., 1422 and/or 1442) to the second destination without outputting a suggested route with an intermediate destination (e.g., 1414) (e.g., a destination other than the second destination) (e.g., the first intermediate destination and/or any intermediate destination), wherein the fourth suggested route does not include an intermediate destination (e.g., as described above in FIG. 14B) (e.g., a destination other than the second destination) (e.g., the first intermediate destination and/or any intermediate destination) (e.g., the computer system does not output a suggested route with an intermediate destination in response to detecting the input corresponding to the request to navigate to the second destination). In some embodiments, in response to detecting the input corresponding to the request to navigate to the second destination, outputting, via the one or more output devices, a fourth response that includes the fourth suggested route to the second destination. In some embodiments, a suggested route with an intermediate destination is not output in response to detecting the input corresponding to the request to navigate to the second destination. In some embodiments, contextual information (e.g., 1410) is not available (e.g., at all and/or that corresponds to the second destination). In some embodiments, contextual information is available but does not correspond to the second destination (e.g., and so the fourth suggested route does not include an intermediate destination). Detecting input corresponding to a request to navigate to a second destination and outputting a fourth suggested route to the second destination without an intermediate destination enables the computer system to suggest routes to some destinations without including any suggested route with an intermediate destination, thereby providing improved feedback to the user and/or reducing the number of inputs needed to perform an operation.

Note that details of the processes described above with respect to method 1500 (e.g., FIG. 15) are also applicable in an analogous manner to the methods described below/above. For example, method 1600 optionally includes one or more of the characteristics of the various methods described above with reference to method 1500. For example, outputting a route to a destination with an intermediate destination of method 1500 can include displaying a suggested route of method 1600. For brevity, these details are not repeated below.

FIG. 16 is a flow diagram illustrating a method for displaying a suggested route using a computer system in accordance with some embodiments. Method 1600 is performed at a computer system (e.g., 100, 200, 1400). The computer system is in communication with one or more input devices and a display generation component. Some operations in method 1600 are, optionally, combined, the orders of some operations are, optionally, changed, and some operations are, optionally, omitted.

As described below, method 1600 provides an intuitive way for displaying a suggested route. The method reduces the cognitive burden on a user for displaying a suggested route, thereby creating a more efficient human-machine interface. For battery operated computing devices, enabling a user to display a suggested route faster and more efficiently conserves power and increases the time between battery charges.

In some embodiments, method 1600 is performed at a computer system (e.g., 100, 200, and/or 1400) that is in communication with one or more input devices (e.g., 140 and/or 200-14) (e.g., a camera, a depth sensor, and/or a microphone) and a display generation component (e.g., 140 and/or 200-16) (e.g., a display screen, a projector, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

The computer system detects (1602), via the one or more input devices, input (e.g., 1405a, 1405b, and/or 1405c) (e.g., a tap input and/or a non-tap input (e.g., a verbal input, an audible request, an audible command, an audible statement, a swipe input, a hold-and-drag input, a gaze input, an air gesture, and/or a mouse click)) directed to an agent (e.g., 1452 (e.g., represented by 1452)) (e.g., a system agent (e.g., of an operating system) and/or an agent of an application) and corresponding to (e.g., that is, including, representing, identifying, specifying, selecting, and/or that is configured to be interpreted as) a request to navigate to a destination (e.g., 1416) (e.g., address, building, business, and/or GPS location).

In response to detecting the input (e.g., 1405a, 1405b, and/or 1405c) corresponding to the request to navigate to the destination (e.g., 1416), the computer system displays (1604), via the display generation component, a response (e.g., 1418, 1420, 1424, and/or 1478) that includes concurrently displaying (e.g., in the same user interface and/or on the same user interface object (e.g., map)): (1606) a first suggested route (e.g., 1418, and/or 1420) (e.g., a set of directions, a path, a trail, and/or a course), to the destination (e.g., 1416), corresponding to (e.g., generated by, created by, sourced from, provided by, and/or received from) a first application (e.g., Map App as described with respect to FIGS. 14A-14E) (e.g., navigation application and/or map application); and a (1608) second suggested route (e.g., 1442) (e.g., a set of directions, a path, a trail, and/or a course), to the destination (e.g., 1416), corresponding to (e.g., generated by, created by, sourced from, provided by, and/or received from) a second application (e.g., RideShare App as described with respect to FIGS. 14A-14E) (e.g., navigation application and/or map application) different from the first application (e.g., as described above in FIGS. 14D-14E). In some embodiments, the response is displayed in a user interface of the first application. In some embodiments, the response is displayed in a user interface of the second application. In some embodiments, the response is displayed in a user interface of the agent. Detecting the input corresponding to the request for navigation to a destination and, in response, displaying a response that includes concurrently displaying a first suggested route to the destination corresponding to a first application and a second suggested route to the destination corresponding to a second application different from the first application enables the computer system to provide different routes to a destination using different applications, thereby providing improved visual feedback to the user and/or reducing the number of inputs needed to perform an operation.

In some embodiments, the response includes a first indication (e.g., 1424) (e.g., color(s), size(s), graphic(s), image(s), and/or text(s) representing data and/or information) corresponding to (e.g., of, generated from, obtained from, and/or received from) the first application and a second indication (e.g., 1454) (e.g., color(s), size(s), graphic(s), image(s), and/or text(s) representing data and/or information) corresponding to (e.g., of, generated from, obtained from, and/or received from) the second application. In some embodiments, the first indication is different from the second indication (e.g., as described above in FIG. 14D). Having the response includes a first indication corresponding to the first application and a second indication corresponding to the second application enables the computer system to indicate the origin of different routes, thereby providing improved visual feedback to the user and/or reducing the number of inputs needed to perform an operation.

In some embodiments, the first indication (e.g., 1424) corresponding to the first application is displayed at a first position corresponding to (e.g., alongside, within a threshold proximity to, overlapping, and/or within a predetermined distance of) the first suggested route (e.g., 1418, and/or 1420). In some embodiments, the second indication (e.g., 1454) corresponding to the second application is displayed at a second position corresponding to (e.g., alongside, within a threshold proximity to, overlapping, and/or within a predetermined distance of) the second suggested route (e.g., 1442). In some embodiments, the second position is different from the first position (e.g., as described above in FIG. 14D). In some embodiments, the first position is within a first area corresponding to the first indication (e.g., a dialog box and/or bubble that points to and/or references the first suggested route). In some embodiments, the second position is within a second area corresponding to the second indication (e.g., a dialog box and/or bubble that points to and/or references the second suggested route). Having the first indication corresponding to the first application displayed at a first position corresponding to the first suggested route and the second indication corresponding to the second application displayed at a second position corresponding to the second suggested route enables the computer system to clearly distinguish the origin of the first suggested route and the second suggested route, thereby providing improved visual feedback to the user and/or reducing the number of inputs needed to perform an operation.

In some embodiments, the response includes a user interface element (e.g., a graphical user interface (GUI) area, a GUI object, a user interface window, and/or a representation of a map). In some embodiments, the first suggested route (e.g., 1418, and/or 1420) to the destination (e.g., 1416) and the second suggested route (e.g., 1442) to the destination are displayed within the user interface element (e.g., 1408 and/or 1476) (e.g., the first suggested route and the second suggested route are overlaid and/or part of the same representation of a map in the same user interface window) (e.g., as described above in FIG. 14D). Having the first suggested route to the destination and the second suggested route to the destination displayed within a user interface element enables the computer system to present the first suggested route with the second suggested route to more easily compare the two, thereby providing improved visual feedback to the user and/or reducing the number of inputs needed to perform an operation.

In some embodiments, the first suggested route (e.g., 1418, and/or 1420) includes (e.g., is referenced in, is identified in, and/or is a location associated with) a first intermediate destination (e.g., 1414) (e.g., as described above with respect to process 1500) (e.g., address, building, business, and/or GPS location between starting position and the destination) that was not included in the request (e.g., 1405c) to navigate to the destination (e.g., 1416) (e.g., as described above in FIG. 14D). In some embodiments, the first intermediate destination is a location (e.g., determined by the computer system or another computer system) based on user information (e.g., contextual information (e.g., 1410)). In some embodiments, the first intermediate destination is not explicitly referenced in the input directed to the agent and corresponding to the request to navigate to the destination. In some embodiments, displaying the response includes displaying, via the display generation component, the intermediate destination corresponding to the first suggested route. In some embodiments, the second suggested route includes a second intermediate destination (e.g., the same as or different from the first intermediate destination) that was not included in the request to navigate to the destination. In some embodiments, the second suggested route does not include an intermediate destination. Having the first suggested route include a first intermediate destination enables the computer system to provide relevant additional stops along the first suggested route, thereby providing improved visual feedback to the user and/or reducing the number of inputs needed to perform an operation.

In some embodiments, the input (e.g., 1405a, 1405b, and/or 1405c) is a first input. In some embodiments, after displaying, via the display generation component, the response that includes the first suggested route (e.g., 1418, and/or 1420) including the first intermediate destination (e.g., 1414), the computer system detects, via the one or more input devices, a second input (e.g., 1405a, 1405b, and/or 1405c) directed to the agent (e.g., 1452) and corresponding to the request to navigate to the destination (e.g., 1416), wherein the second input is the same as the first input. In some embodiments, in response to detecting the second input (e.g., 1405a, 1405b, and/or 1405c) corresponding to the request to navigate to the destination (e.g., 1416), the computer system displays, via the display generation component, a response that includes concurrently displaying: in accordance with a determination that the destination (e.g., 1416) corresponds to current contextual information (e.g., 1410) (e.g., as described above with respect to method 1500), the first suggested route (e.g., 1418, and/or 1420) to the destination; in accordance with a determination that the destination (e.g., 1416) does not correspond to the current contextual information, a third suggested route (e.g., 1422) to the destination (e.g., 1416) corresponding to the first application, wherein the third suggested route does not include the first intermediate destination (e.g., 1414); and the second suggested route (e.g., 1442) (e.g., as described above in FIG. 14D). Displaying different suggested routes depending on whether the destination corresponds to current contextual information enables the computer system to intelligently provide relevant intermediate destination for a suggested route based on personalized information, thereby providing improved visual feedback to the user and/or performing an operation when a set of conditions has been met without requiring further user input.

In some embodiments, the input includes (and/or is) a verbal input (e.g., as described above in FIGS. 14A-14D). Having the input include verbal input enables the computer system to provide a suggested route in response to receiving a verbal instruction, thereby providing improved visual feedback to the user and/or reducing the number of inputs needed to perform an operation.

In some embodiments, the input includes (and/or is) a gesture (e.g., air gesture and/or a touch input (e.g., tap and/or swipe) of an input device (e.g., a touch-sensitive surface, a remote, and/or a controller) in communication with the computer system) (e.g., as described above in FIGS. 14A-14D). Having the input include a gesture enables the computer system to provide a suggested route in response to receiving the gesture, thereby providing improved visual feedback to the user and/or reducing the number of inputs needed to perform an operation.

In some embodiments, displaying the request includes concurrently displaying, via the display generation component, a fourth suggested route to the destination (e.g., 1416) with the first suggested route (e.g., 1418, and/or 1420) and the second suggested route (e.g., 1442). In some embodiments, the fourth suggested route is different from the first suggested route and the second suggested route (e.g., as described in FIG. 14D). In some embodiments, the fourth suggested route to the destination is not concurrently displayed with the first suggested route and/or the second suggested route. Having the response include a fourth suggested route to the destination displayed concurrently with the first suggested route and the second suggested route enables the computer system to provide a selection of multiple routes generated from different applications, thereby providing improved visual feedback to the user and/or reducing the number of inputs needed to perform an operation.

In some embodiments, the fourth suggested route corresponds to (e.g., is obtained from and/or is generated by) a third application different from the first application and the second application (e.g., and not the first application or the second application) (e.g., as described in FIG. 14D). Having the fourth suggested route correspond to a third application enables the computer system to provide a selection of multiple routes generated from different applications, thereby providing improved visual feedback to the user and/or reducing the number of inputs needed to perform an operation.

In some embodiments, the fourth suggested route corresponds to (e.g., is obtained from and/or is generated by) the first application (e.g., and not the second application). In some embodiments, the fourth suggested route corresponds to the second application (e.g., and not the first application) (e.g., as described in FIG. 14D). Having the fourth suggested route to the destination correspond to the first application enables the computer system to provide a selection of multiple routes generated from the same application while displaying another route from another application, thereby providing improved visual feedback to the user and/or reducing the number of inputs needed to perform an operation.

In some embodiments, the computer system detects an input (e.g., 1405d) (e.g., a tap input and/or a non-tap input (e.g., a verbal input, an audible request, an audible command, an audible statement, a swipe input, a hold-and-drag input, a gaze input, an air gesture, and/or a mouse click)) corresponding to selection of a respective suggested route (e.g., the first suggested route or the second suggested route). In some embodiments, in response to detecting the input (e.g., 1405d) corresponding to selection of the respective suggested route, the computer system initiates navigation according to the respective suggested route (e.g., outputs, via the one or more output devices, a first navigation direction and/or instruction corresponding to the first suggested route) (e.g., as described in FIG. 14E). In some embodiments, after outputting the first navigation direction and/or instruction, the computer system outputs, via the one or more output devices, a second navigation direction and/or instruction corresponding to the first suggested route (e.g., turn-by-turn directions from a current location). In some embodiments, the second navigation direction and/or instruction is different from the first navigation direction and/or instruction. Detecting an input corresponding to selection of the respective suggested route and initiating navigation according to the respective suggested route enables the computer system to assist a subject to getting to the destination, thereby providing improved feedback to the user and/or reducing the number of inputs needed to perform an operation.

In some embodiments, the respective suggested route is the second suggested route (e.g., 1442). In some embodiments, initiating navigation according to the second suggested route includes displaying, via the display generation component, a user interface of the second application (e.g., Ride Share App as described with respect to FIGS. 14A-14E) (e.g., and not the first application) (and/or launching the second application) (e.g., as described in FIG. 14E). In some embodiments, initiating navigation according to the first suggested route does not include displaying a user interface of the second application. In some embodiments, initiating navigation according the first suggested route includes displaying, via the display generation component, a user interface of the first application (e.g., and not the second application) (and/or launching the first application). In some embodiments, initiating navigation according to the first suggested route does not include displaying a user interface of another application. In some embodiments, initiating navigation according to the first suggested route includes displaying, via the display generation component, a first navigation direction and/or instruction corresponding to the first suggested route without launching and/or displaying a user interface of the first application and/or the second application. In some embodiments, the response is displayed via a third application different from the first application and/or the second application. Initiating navigation according to the second suggested route including displaying the user interface of the second application enables the computer system to present the suggested route in a user interface of an application corresponding to the suggested route, thereby providing improved visual feedback to the user and/or performing an operation when a set of conditions has been met without requiring further user input.

In some embodiments, the respective suggested route is the second suggested route (e.g., 1442). In some embodiments, initiating navigation according to the second suggested route includes displaying, via the display generation component, a user interface of a third application (e.g., and not the second application) different from the second application (and/or the first application) (e.g., without launching the second application). Initiating navigation according to the second suggested route including displaying a user interface of a third application different from the second application enables the computer to present a suggested route through an application that does not correspond to the suggested route (e.g., and not requiring a context switch to display a user interface of the application that corresponds to the suggested route), thereby providing improved visual feedback to the user and/or performing an operation when a set of conditions has been met without requiring further user input.

In some embodiments, the input (e.g., 1405a, 1405b, and/or 1405c) is a third input. In some embodiments, the destination (e.g., 1416) is a first destination. In some embodiments, the response is a first response. In some embodiments, after displaying the response, the computer system detects, via the one or more input devices, a fourth input directed to the agent (e.g., 1452) and corresponding to a request to navigate to a second destination (e.g., the same as or different from the first destination). In some embodiments, the fourth input is the same as or different from the first input. In some embodiments, in response to detecting the fourth input corresponding to the request to navigate to the second destination, the computer system displays, via the display generation component, a second response that: includes a third suggested route (e.g., same as or different from the first suggested route) to the second destination corresponding to the first application; and does not include a suggested route to the second destination corresponding to the second application (e.g., as described above in FIG. 14B). Displaying the second response that includes the third suggested route without including a suggested route corresponding to the second application enables the computer system to selectively use different applications for suggesting routes, thereby providing improved visual feedback to the user and/or reducing the number of inputs needed to perform an operation.

Note that details of the processes described above with respect to method 1600 (e.g., FIG. 16) are also applicable in an analogous manner to the methods described below/above. For example, method 900 optionally includes one or more of the characteristics of the various methods described above with reference to method 1600. For example, displaying a suggested route in method 1600 can include a route with an intermediate destination of method 1500. For brevity, these details are not repeated below.

The description above, has been described with reference to specific examples for the purpose of explanation. Such specific examples can be in the form of textual description above and/or in the accompanying drawings. However, such examples should not be interpreted as being exhaustive or limiting to the disclosure (e.g., limiting to the explicit manners described herein). Many modifications and variations are possible in view of the above teachings by one of ordinary skill in the art without departing from the scope of the present disclosure.

Aspects of the technology described above can include gathering and/or using data from various sources. Such data can include demographic data, telephone numbers, email addresses, location and/or location-related data, home addresses, work addresses, and/or any other identifying information. In some scenarios, such data can include personal information that is usable to uniquely identify a specific person. Such data can be used to improve interactions that a device has with its environment (e.g., interactions with users). The use of such data can require one or more entities handling such data. These entities can be involved in collecting, processing, disclosing, transferring, storing, or other functions that support the technologies described herein. The present disclosure expects that (e.g., does not preclude) that all use of such data complies with well-established privacy policies and/or privacy practices by such entities. As a general matter, such policies and practices should meet or exceed generally recognized industry standards and comply with all applicable data privacy and security-related governmental requirements. In particular, for example, entities should receive informed consent from users to collect and/or use such data, and such collection and/or use should only be for legitimate and reasonable uses. Further, such data should not be shared, disclosed, sold, and/or provided for uses other than legitimate and/or reasonable uses. Various scenarios can arise in which such data is not available, such as when a user selects not to share such data. For example, the user can withhold consent for collection and/or use of such data (e.g., “opt out” of sharing such data and/or not explicitly “opt in” during a registration process). The user can also employ the use of any of various hardware and/or software components that prevent collection and/or use of such data. While the use of such data can benefit a user by improving the operation of the device, the present disclosure contemplates that embodiments of the present technology can be used without such data. For example, operations of the device can use other data (e.g., instead of and/or in place of such data). Other techniques include making inferences based on other data or a minimal amount of such data. The use of such data can be utilized for the benefit of users of the device. For example, such data can be used to improve interactions that the device engages in with the user. Other benefits from the use for such data are also possible and within the scope of the present disclosure.

1. A method, comprising:
at a computer system that is in communication with one or more output devices, a display component, and one or more cameras:
while outputting a representation of a field-of-view of one or more cameras, detecting a request concerning content in the field-of-view of the one or more cameras; and
in response to detecting the request concerning content in the field-of-view of the one or more cameras:
in accordance with a determination that a first portion of content is a portion of interest based on the context of the request outputting an indication that the first portion of content is the portion of interest; and
in accordance with a determination that a second portion of content is the portion of interest based on the context of the request, outputting an indication that the second portion of content is the portion of interest.

2. The method of claim 1, wherein the request is a first request, the method further comprising:
while outputting an indication that the first portion of content is the portion of interest, detecting a second request concerning content in the field-of-view of the one or more cameras; and
in response to detecting the second request concerning content in the field-of-view of the one or more cameras and in accordance with a determination that a third portion of content is the portion of interest based on the context of the second request, outputting the indication that the third portion of content is the portion of interest.

3. The method of claim 1, wherein outputting the indication includes displaying, via the display component, a representation of a face.

4. The method of claim 1, further comprising:
in response to detecting the request concerning content in the field-of-view of the one or more cameras, outputting the indication that the first portion of content is the portion of interest includes displaying, via the display component, a representation of a face that is directed to the portion of interest.

5. The method of claim 1, wherein outputting the indication that the first portion of content is the portion of interest includes displaying, via a display component, a representation of the face that is directed to the portion of interest, the method further comprising:
after outputting the indication that the first portion of content is the portion of interest and in accordance with a determination that a threshold period of time has passed, updating display, via the display component, of the representation of the face that is directed to the portion of interest to be directed away from the portion of interest.

6. The method of claim 1, wherein outputting, via the one or more output devices, the indication that the first portion of content is the portion of interest includes outputting, via the one or more output devices, audio including an indication that the first portion of content is the portion of interest.

7. The method of claim 1, wherein outputting the indication that the first portion of content is the portion of interest includes displaying, via the display component, a user interface object closer to the first portion than the second portion; and wherein outputting the indication that the second portion of content is the portion of interest includes displaying, via the display component, the user interface object closer to the second portion than the first portion.

8. The method of claim 1, wherein:
in accordance with a determination that an empty space is at a first location in the content that is within a threshold distance from the portion of interest, outputting an indication that the first portion of content is the portion of interest includes displaying, via the display component, a second user interface object at the first location; and
in accordance with a determination that the empty space is not at the first location within a threshold distance from the portion of interest, outputting the indication that the first portion of content is the portion of interest does not include displaying, via the display component, the indication at the first location.

9. The method of claim 1, wherein outputting the representation of the field-of-view of the one or more cameras includes providing audio output, the method further comprising:
in accordance with a determination that the audio output includes a first set of one or more characteristics, animating, via the one or more output devices, the indication that the first portion of content is in a first manner; and
in accordance with a determination that the audio output includes a second set of one or more characteristics different from the first set of one or more characteristics, animating, via the one or more output devices, the indication that the first portion of content is the portion of interest in a second manner, different from the first manner.

10. The method of claim 1, wherein the request is a first request, the method further comprising:
while outputting the representation of the field-of-view of one or more cameras, detecting a third request concerning content in the field-of-view of the one or more cameras; and
in response to detecting the third request concerning content in the field-of-view of the one or more cameras:
in accordance with a determination that the first portion of content is the portion of interest based on the context of the third request, visually modifying the first portion of content; and
in accordance with a determination that the second portion of content is the portion of interest based on the context of the third request, visually modifying the second portion of content.

11. The method of claim 10, further comprising:
in accordance with a determination that the portion of interest is displayed with a first set of one or more visual characteristics, visually modifying the portion of interest with the first set of one or more visual characteristics; and
in accordance with a determination that the portion of interest is displayed with a second set of one or more visual characteristics, that is different from the first set of one or more visual characteristics, visually modifying the portion of interest with the second set of one or more visual characteristics.

12. The method of claim 10, wherein outputting the portion of interest includes displaying the portion of interest in a third set of one or more visual characteristics.

13. The method of claim 10, wherein visually modifying the portion of interest includes emphasizing the first portion of content.

14. The method of claim 10, wherein visually modifying the portion of interest includes outputting audio concerning the context of the third request.

15. A non-transitory computer-readable storage medium storing one or more programs configured to be executed by one or more processors of a computer system that is in communication with one or more output devices, a display component, and one or more cameras, the one or more programs including instructions for:
while outputting a representation of a field-of-view of one or more cameras, detecting a request concerning content in the field-of-view of the one or more cameras; and
in response to detecting the request concerning content in the field-of-view of the one or more cameras:
in accordance with a determination that a first portion of content is a portion of interest based on the context of the request outputting an indication that the first portion of content is the portion of interest; and
in accordance with a determination that a second portion of content is the portion of interest based on the context of the request, outputting an indication that the second portion of content is the portion of interest.

16. A computer system that is in communication with one or more output devices, a display component, and one or more cameras, comprising:
one or more processors; and
memory storing one or more programs configured to be executed by the one or more processors, the one or more programs including instructions for:
while outputting a representation of a field-of-view of one or more cameras, detecting a request concerning content in the field-of-view of the one or more cameras; and
in response to detecting the request concerning content in the field-of-view of the one or more cameras:
in accordance with a determination that a first portion of content is a portion of interest based on the context of the request outputting an indication that the first portion of content is the portion of interest; and
in accordance with a determination that a second portion of content is the portion of interest based on the context of the request, outputting an indication that the second portion of content is the portion of interest.
